(19) United States
(12) Patent Application Publication
(10) Pub. No.: US 2026/0072639 A1
(43) Pub. Date: Mar. 12, 2026

(54) USER INTERFACES FOR UPDATING AN INDICATION OF AN ACTIVITY

(71) Applicant: Apple Inc., Cupertino, CA (US)

(72) Inventor: Agatha Y. YU, Oakland, CA (US)

(21) Appl. No.: 19/387,253

(22) Filed: Nov. 12, 2025

Related U.S. Application Data
(63) Continuation of application No. PCT/US2024/048459, filed on Sep. 25, 2024.
(60) Provisional application No. 63/541,800, filed on Sep. 30, 2023.
(60) Provisional application No. 63/541,805, filed on Sep. 30, 2023.
(60) Provisional application No. 63/541,836, filed on Sep. 30, 2023.
(60) Provisional application No. 63/587,113, filed on Sep. 30, 2023.

(51) Int. Cl. G06F 3/16

(52) U.S. Cl. CPC G06F 3/165; G06F 3/167

(57) ABSTRACT

The present disclosure generally relates to monitoring an activity. In some embodiments, the present disclosure is directed to techniques for updating an indication of an activity.

### CROSS-REFERENCE TO RELATED APPLICATIONS

The present application is a continuing application of International Patent Application Serial No. PCT/US2024/048459, entitled “USER INTERFACES FOR UPDATING AN INDICATION OF AN ACTIVITY,” filed Sep. 25, 2024, which claims priority to U.S. Provisional Patent Application Ser. No. 63/541,800, filed Sep. 30, 2023, to U.S. Provisional Patent Application Ser. No. 63/541,805, filed Sep. 30, 2023, to U.S. Provisional Patent Application Ser. No. 63/541,836, filed Sep. 30, 2023, and to U.S. Provisional Patent Application Ser. No. 63/587,113, filed Sep. 30, 2023. The content of these applications are hereby incorporated by reference in their entirety.

### BACKGROUND

Computer systems often issue notifications of activities. Such notifications indicate an activity with limited information. Electronic devices often output content. Such content output can be interrupted in the event of interaction with the electronic device. Electronic devices often include applications with various capabilities that can be useful for performing a desired task. Such capabilities are often provided individually and accessed via separate user interactions. Computer systems often provide suggested content to users. Such suggested content can be provided based on available contextual information.

### SUMMARY

Existing techniques for updating an indication of an activity using electronic devices are generally cumbersome and inefficient. For example, some existing techniques use a complex and time-consuming user interface, which may include multiple key presses or keystrokes. Some existing techniques require more time than necessary, wasting user time and device energy. This latter consideration is particularly important in battery-operated devices.

Accordingly, the present technique provides electronic devices with faster, more efficient methods and interfaces for updating an indication of an activity. Such methods and interfaces optionally complement or replace other methods for updating an indication of an activity. Such methods and interfaces reduce the cognitive burden on a user and produce a more efficient human-machine interface. For battery-operated computing devices, such methods and interfaces conserve power and increase the time between battery charges. Such methods and interfaces may complement or replace other methods for updating an indication of an activity.

In some embodiments, a method that is performed at a computer system that is in communication with a display component and a camera is described. In some embodiments, the method comprises: while capturing, via the camera, one or more images of an environment, detecting that a first activity is being performed in the environment; while detecting that the first activity is being performed: in accordance with a determination that the first activity includes a first set of one or more characteristics, displaying, via the display component, an indication of the first activity; and in accordance with a determination that the first activity includes a second set of one or more characteristics different from the first set of one or more characteristics, forgoing displaying the indication of the first activity; and while displaying the indication of the first activity, detecting a first event corresponding to the first activity being performed in the environment; and in response to detecting the first event corresponding to the first activity being performed in the environment, updating the indication of the first activity.

In some embodiments, a non-transitory computer-readable storage medium storing one or more programs configured to be executed by one or more processors of a computer system that is in communication with a display component and a camera is described. In some embodiments, the one or more programs includes instructions for: while capturing, via the camera, one or more images of an environment, detecting that a first activity is being performed in the environment; while detecting that the first activity is being performed: in accordance with a determination that the first activity includes a first set of one or more characteristics, displaying, via the display component, an indication of the first activity; and in accordance with a determination that the first activity includes a second set of one or more characteristics different from the first set of one or more characteristics, forgoing displaying the indication of the first activity; and while displaying the indication of the first activity, detecting a first event corresponding to the first activity being performed in the environment; and in response to detecting the first event corresponding to the first activity being performed in the environment, updating the indication of the first activity.

In some embodiments, a transitory computer-readable storage medium storing one or more programs configured to be executed by one or more processors of a computer system that is in communication with a display component and a camera is described. In some embodiments, the one or more programs includes instructions for: while capturing, via the camera, one or more images of an environment, detecting that a first activity is being performed in the environment; while detecting that the first activity is being performed: in accordance with a determination that the first activity includes a first set of one or more characteristics, displaying, via the display component, an indication of the first activity; and in accordance with a determination that the first activity includes a second set of one or more characteristics different from the first set of one or more characteristics, forgoing displaying the indication of the first activity; and while displaying the indication of the first activity, detecting a first event corresponding to the first activity being performed in the environment; and in response to detecting the first event corresponding to the first activity being performed in the environment, updating the indication of the first activity.

In some embodiments, a computer system that is in communication with a display component and a camera is described. In some embodiments, the computer system comprises one or more processors and memory storing one or more programs configured to be executed by the one or more processors. In some embodiments, the one or more programs includes instructions for: while capturing, via the camera, one or more images of an environment, detecting that a first activity is being performed in the environment; while detecting that the first activity is being performed: in accordance with a determination that the first activity includes a first set of one or more characteristics, displaying, via the display component, an indication of the first activity; and in accordance with a determination that the first activity includes a second set of one or more characteristics different from the first set of one or more characteristics, forgoing displaying the indication of the first activity; and while displaying the indication of the first activity, detecting a first event corresponding to the first activity being performed in the environment; and in response to detecting the first event corresponding to the first activity being performed in the environment, updating the indication of the first activity.

In some embodiments, a computer system that is in communication with a display component and a camera is described. In some embodiments, the computer system comprises means for performing each of the following steps: while capturing, via the camera, one or more images of an environment, detecting that a first activity is being performed in the environment; while detecting that the first activity is being performed: in accordance with a determination that the first activity includes a first set of one or more characteristics, displaying, via the display component, an indication of the first activity; and in accordance with a determination that the first activity includes a second set of one or more characteristics different from the first set of one or more characteristics, forgoing displaying the indication of the first activity; and while displaying the indication of the first activity, detecting a first event corresponding to the first activity being performed in the environment; and in response to detecting the first event corresponding to the first activity being performed in the environment, updating the indication of the first activity.

In some embodiments, a computer program product is described. In some embodiments, the computer program product comprises one or more programs configured to be executed by one or more processors of a computer system that is in communication with a display component and a camera. In some embodiments, the one or more programs include instructions for: while capturing, via the camera, one or more images of an environment, detecting that a first activity is being performed in the environment; while detecting that the first activity is being performed: in accordance with a determination that the first activity includes a first set of one or more characteristics, displaying, via the display component, an indication of the first activity; and in accordance with a determination that the first activity includes a second set of one or more characteristics different from the first set of one or more characteristics, forgoing displaying the indication of the first activity; and while displaying the indication of the first activity, detecting a first event corresponding to the first activity being performed in the environment; and in response to detecting the first event corresponding to the first activity being performed in the environment, updating the indication of the first activity.

Accordingly, the present technique provides electronic devices with faster, more efficient methods and interfaces for providing interactive user interfaces during content output. Such methods and interfaces optionally complement or replace other methods for providing interactive user interfaces during content output. Such methods and interfaces reduce the cognitive burden on a user and produce a more efficient human-machine interface. For battery-operated computing devices, such methods and interfaces conserve power and increase the time between battery charges. Such methods and interfaces may complement or replace other methods for providing interactive user interfaces during content output.

In some embodiments, a method that is performed at a computer system that is in communication with one or more input devices and one or more output devices is described. In some embodiments, the method comprises: while playing back media content, detecting, via the one or more input devices, a non-contact input that corresponds to the media content; and in response to detecting the non-contact input that corresponds to the media content: in accordance with a determination that playback of the media content is at a first playback position, outputting, via the one or more output devices, first information corresponding to the media content, wherein the first information does not include an indication of the first playback position; and in accordance with a determination that playback of the media content is at a second playback position different from the first playback position, outputting, via the one or more output devices, second information corresponding to the media content, wherein the second information is different from the first information, and wherein the second information does not include an indication of the second playback position.

In some embodiments, a non-transitory computer-readable storage medium storing one or more programs configured to be executed by one or more processors of a computer system that is in communication with one or more input devices and one or more output devices is described. In some embodiments, the one or more programs includes instructions for: while playing back media content, detecting, via the one or more input devices, a non-contact input that corresponds to the media content; and in response to detecting the non-contact input that corresponds to the media content: in accordance with a determination that playback of the media content is at a first playback position, outputting, via the one or more output devices, first information corresponding to the media content, wherein the first information does not include an indication of the first playback position; and in accordance with a determination that playback of the media content is at a second playback position different from the first playback position, outputting, via the one or more output devices, second information corresponding to the media content, wherein the second information is different from the first information, and wherein the second information does not include an indication of the second playback position.

In some embodiments, a transitory computer-readable storage medium storing one or more programs configured to be executed by one or more processors of a computer system that is in communication with one or more input devices and one or more output devices is described. In some embodiments, the one or more programs includes instructions for: while playing back media content, detecting, via the one or more input devices, a non-contact input that corresponds to the media content; and in response to detecting the non-contact input that corresponds to the media content: in accordance with a determination that playback of the media content is at a first playback position, outputting, via the one or more output devices, first information corresponding to the media content, wherein the first information does not include an indication of the first playback position; and in accordance with a determination that playback of the media content is at a second playback position different from the first playback position, outputting, via the one or more output devices, second information corresponding to the media content, wherein the second information is different from the first information, and wherein the second information does not include an indication of the second playback position.

In some embodiments, a computer system that is in communication with one or more input devices and one or more output devices is described. In some embodiments, the computer system that is in communication with one or more input devices and one or more output devices comprises one or more processors and memory storing one or more programs configured to be executed by the one or more processors. In some embodiments, the one or more programs includes instructions for: while playing back media content, detecting, via the one or more input devices, a non-contact input that corresponds to the media content; and in response to detecting the non-contact input that corresponds to the media content: in accordance with a determination that playback of the media content is at a first playback position, outputting, via the one or more output devices, first information corresponding to the media content, wherein the first information does not include an indication of the first playback position; and in accordance with a determination that playback of the media content is at a second playback position different from the first playback position, outputting, via the one or more output devices, second information corresponding to the media content, wherein the second information is different from the first information, and wherein the second information does not include an indication of the second playback position.

In some embodiments, a computer system that is in communication with one or more input devices and one or more output devices is described. In some embodiments, the computer system that is in communication with one or more input devices and one or more output devices comprises means for performing each of the following steps: while playing back media content, detecting, via the one or more input devices, a non-contact input that corresponds to the media content; and in response to detecting the non-contact input that corresponds to the media content: in accordance with a determination that playback of the media content is at a first playback position, outputting, via the one or more output devices, first information corresponding to the media content, wherein the first information does not include an indication of the first playback position; and in accordance with a determination that playback of the media content is at a second playback position different from the first playback position, outputting, via the one or more output devices, second information corresponding to the media content, wherein the second information is different from the first information, and wherein the second information does not include an indication of the second playback position.

In some embodiments, a computer program product is described. In some embodiments, the computer program product comprises one or more programs configured to be executed by one or more processors of a computer system that is in communication with one or more input devices and one or more output devices. In some embodiments, the one or more programs include instructions for: while playing back media content, detecting, via the one or more input devices, a non-contact input that corresponds to the media content; and in response to detecting the non-contact input that corresponds to the media content: in accordance with a determination that playback of the media content is at a first playback position, outputting, via the one or more output devices, first information corresponding to the media content, wherein the first information does not include an indication of the first playback position; and in accordance with a determination that playback of the media content is at a second playback position different from the first playback position, outputting, via the one or more output devices, second information corresponding to the media content, wherein the second information is different from the first information, and wherein the second information does not include an indication of the second playback position.

In some embodiments, a method that is performed at a computer system that is in communication with one or more input devices and one or more output devices is described. In some embodiments, the method comprises: while outputting, via the one or more output devices, first content, detecting, via the one or more input devices, a first input corresponding to a first portion of the first content; and while continuing outputting the first content, in response to detecting the first input, and in accordance with a determination that the first input corresponds to first media content referenced in the first portion of the first content, performing an operation corresponding to the first media content, wherein the first media content is different from the first content.

In some embodiments, a non-transitory computer-readable storage medium storing one or more programs configured to be executed by one or more processors of a computer system that is in communication with one or more input devices and one or more output devices is described. In some embodiments, the one or more programs includes instructions for: while outputting, via the one or more output devices, first content, detecting, via the one or more input devices, a first input corresponding to a first portion of the first content; and while continuing outputting the first content, in response to detecting the first input, and in accordance with a determination that the first input corresponds to first media content referenced in the first portion of the first content, performing an operation corresponding to the first media content, wherein the first media content is different from the first content.

In some embodiments, a transitory computer-readable storage medium storing one or more programs configured to be executed by one or more processors of a computer system that is in communication with one or more input devices and one or more output devices is described. In some embodiments, the one or more programs includes instructions for: while outputting, via the one or more output devices, first content, detecting, via the one or more input devices, a first input corresponding to a first portion of the first content; and while continuing outputting the first content, in response to detecting the first input, and in accordance with a determination that the first input corresponds to first media content referenced in the first portion of the first content, performing an operation corresponding to the first media content, wherein the first media content is different from the first content.

In some embodiments, a computer system that is in communication with one or more input devices and one or more output devices is described. In some embodiments, the computer system that is in communication with one or more input devices and one or more output devices comprises one or more processors and memory storing one or more programs configured to be executed by the one or more processors. In some embodiments, the one or more programs includes instructions for: while outputting, via the one or more output devices, first content, detecting, via the one or more input devices, a first input corresponding to a first portion of the first content; and while continuing outputting the first content, in response to detecting the first input, and in accordance with a determination that the first input corresponds to first media content referenced in the first portion of the first content, performing an operation corresponding to the first media content, wherein the first media content is different from the first content.

In some embodiments, a computer system that is in communication with one or more input devices and one or more output devices is described. In some embodiments, the computer system that is in communication with one or more input devices and one or more output devices comprises means for performing each of the following steps: while outputting, via the one or more output devices, first content, detecting, via the one or more input devices, a first input corresponding to a first portion of the first content; and while continuing outputting the first content, in response to detecting the first input, and in accordance with a determination that the first input corresponds to first media content referenced in the first portion of the first content, performing an operation corresponding to the first media content, wherein the first media content is different from the first content.

In some embodiments, a computer program product is described. In some embodiments, the computer program product comprises one or more programs configured to be executed by one or more processors of a computer system that is in communication with one or more input devices and one or more output devices. In some embodiments, the one or more programs include instructions for: while outputting, via the one or more output devices, first content, detecting, via the one or more input devices, a first input corresponding to a first portion of the first content; and while continuing outputting the first content, in response to detecting the first input, and in accordance with a determination that the first input corresponds to first media content referenced in the first portion of the first content, performing an operation corresponding to the first media content, wherein the first media content is different from the first content.

In some embodiments, a method that is performed at a computer system that is in communication with one or more input devices, an audio output component, and a display component is described. In some embodiments, the method comprises: detecting, via the one or more input devices, a first input corresponding to a first request; in response to detecting the first input corresponding to the first request, outputting, via the audio output device, a first audio portion of a first response; while outputting the first audio portion of the first response, detecting, via the one or more input devices, a second input corresponding to a second request, wherein the second input is different from the first input; and in response to detecting the second input corresponding to the second request and while continuing outputting without interrupting the first audio portion of the first response, displaying, via the display component, a first visual portion of a second response different from the first response.

In some embodiments, a non-transitory computer-readable storage medium storing one or more programs configured to be executed by one or more processors of a computer system that is in communication with one or more input devices, an audio output component, and a display component is described. In some embodiments, the one or more programs includes instructions for: detecting, via the one or more input devices, a first input corresponding to a first request; in response to detecting the first input corresponding to the first request, outputting, via the audio output device, a first audio portion of a first response; while outputting the first audio portion of the first response, detecting, via the one or more input devices, a second input corresponding to a second request, wherein the second input is different from the first input; and in response to detecting the second input corresponding to the second request and while continuing outputting without interrupting the first audio portion of the first response, displaying, via the display component, a first visual portion of a second response different from the first response.

In some embodiments, a transitory computer-readable storage medium storing one or more programs configured to be executed by one or more processors of a computer system that is in communication with one or more input devices, an audio output component, and a display component is described. In some embodiments, the one or more programs includes instructions for: detecting, via the one or more input devices, a first input corresponding to a first request; in response to detecting the first input corresponding to the first request, outputting, via the audio output device, a first audio portion of a first response; while outputting the first audio portion of the first response, detecting, via the one or more input devices, a second input corresponding to a second request, wherein the second input is different from the first input; and in response to detecting the second input corresponding to the second request and while continuing outputting without interrupting the first audio portion of the first response, displaying, via the display component, a first visual portion of a second response different from the first response.

In some embodiments, a computer system that is in communication with one or more input devices, an audio output component, and a display component is described. In some embodiments, the computer system that is in communication with one or more input devices, an audio output component, and a display component comprises one or more processors and memory storing one or more programs configured to be executed by the one or more processors. In some embodiments, the one or more programs includes instructions for: detecting, via the one or more input devices, a first input corresponding to a first request; in response to detecting the first input corresponding to the first request, outputting, via the audio output device, a first audio portion of a first response; while outputting the first audio portion of the first response, detecting, via the one or more input devices, a second input corresponding to a second request, wherein the second input is different from the first input; and in response to detecting the second input corresponding to the second request and while continuing outputting without interrupting the first audio portion of the first response, displaying, via the display component, a first visual portion of a second response different from the first response.

In some embodiments, a computer system that is in communication with one or more input devices, an audio output component, and a display component is described. In some embodiments, the computer system that is in communication with one or more input devices, an audio output component, and a display component comprises means for performing each of the following steps: detecting, via the one or more input devices, a first input corresponding to a first request; in response to detecting the first input corresponding to the first request, outputting, via the audio output device, a first audio portion of a first response; while outputting the first audio portion of the first response, detecting, via the one or more input devices, a second input corresponding to a second request, wherein the second input is different from the first input; and in response to detecting the second input corresponding to the second request and while continuing outputting without interrupting the first audio portion of the first response, displaying, via the display component, a first visual portion of a second response different from the first response.

In some embodiments, a computer program product is described. In some embodiments, the computer program product comprises one or more programs configured to be executed by one or more processors of a computer system that is in communication with one or more input devices, an audio output component, and a display component. In some embodiments, the one or more programs include instructions for: detecting, via the one or more input devices, a first input corresponding to a first request; in response to detecting the first input corresponding to the first request, outputting, via the audio output device, a first audio portion of a first response; while outputting the first audio portion of the first response, detecting, via the one or more input devices, a second input corresponding to a second request, wherein the second input is different from the first input; and in response to detecting the second input corresponding to the second request and while continuing outputting without interrupting the first audio portion of the first response, displaying, via the display component, a first visual portion of a second response different from the first response.

In some embodiments, a method that is performed at a computer system that is in communication with one or more input devices and one or more output devices is described. In some embodiments, the method comprises: detecting, via the one or more input devices, an input corresponding to a request to perform a task, wherein the input is directed to a first application; and in response to detecting the input: in accordance with a determination that the first application is not able to perform the task, outputting, via the one or more output devices, a response that includes: an indication that the first application is not able to perform the task; and content from a second application, wherein the second application is able to perform the task and wherein the second application is different from the first application; and in accordance with a determination that the first application is able to perform the task: forgoing outputting, via the one or more output devices, the response; and performing a set of one or more actions corresponding to the task.

In some embodiments, a non-transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, an input corresponding to a request to perform a task, wherein the input is directed to a first application; and in response to detecting the input: in accordance with a determination that the first application is not able to perform the task, outputting, via the one or more output devices, a response that includes: an indication that the first application is not able to perform the task; and content from a second application, wherein the second application is able to perform the task and wherein the second application is different from the first application; and in accordance with a determination that the first application is able to perform the task: forgoing outputting, via the one or more output devices, the response; and performing a set of one or more actions corresponding to the task.

In some embodiments, a transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, an input corresponding to a request to perform a task, wherein the input is directed to a first application; and in response to detecting the input: in accordance with a determination that the first application is not able to perform the task, outputting, via the one or more output devices, a response that includes: an indication that the first application is not able to perform the task; and content from a second application, wherein the second application is able to perform the task and wherein the second application is different from the first application; and in accordance with a determination that the first application is able to perform the task: forgoing outputting, via the one or more output devices, the response; and performing a set of one or more actions corresponding to the task.

In some embodiments, a computer system that is in communication with one or more input devices and one or more output devices is described. In some embodiments, the computer system that is in communication with one or more input devices and one or more output devices comprises one or more processors and memory storing one or more programs configured to be executed by the one or more processors. In some embodiments, the one or more programs includes instructions for: detecting, via the one or more input devices, an input corresponding to a request to perform a task, wherein the input is directed to a first application; and in response to detecting the input: in accordance with a determination that the first application is not able to perform the task, outputting, via the one or more output devices, a response that includes: an indication that the first application is not able to perform the task; and content from a second application, wherein the second application is able to perform the task and wherein the second application is different from the first application; and in accordance with a determination that the first application is able to perform the task: forgoing outputting, via the one or more output devices, the response; and performing a set of one or more actions corresponding to the task.

In some embodiments, a computer system that is in communication with one or more input devices and one or more output devices is described. In some embodiments, the computer system that is in communication with one or more input devices and one or more output devices comprises means for performing each of the following steps: detecting, via the one or more input devices, an input corresponding to a request to perform a task, wherein the input is directed to a first application; and in response to detecting the input: in accordance with a determination that the first application is not able to perform the task, outputting, via the one or more output devices, a response that includes: an indication that the first application is not able to perform the task; and content from a second application, wherein the second application is able to perform the task and wherein the second application is different from the first application; and in accordance with a determination that the first application is able to perform the task: forgoing outputting, via the one or more output devices, the response; and performing a set of one or more actions corresponding to the task.

In some embodiments, a computer program product is described. In some embodiments, the computer program product comprises one or more programs configured to be executed by one or more processors of a computer system that is in communication with one or more input devices and one or more output devices. In some embodiments, the one or more programs include instructions for: detecting, via the one or more input devices, an input corresponding to a request to perform a task, wherein the input is directed to a first application; and in response to detecting the input: in accordance with a determination that the first application is not able to perform the task, outputting, via the one or more output devices, a response that includes: an indication that the first application is not able to perform the task; and content from a second application, wherein the second application is able to perform the task and wherein the second application is different from the first application; and in accordance with a determination that the first application is able to perform the task: forgoing outputting, via the one or more output devices, the response; and performing a set of one or more actions corresponding to the task.

In some embodiments, a method that is performed at a computer system that is in communication with one or more input devices and one or more output devices is described. In some embodiments, the method comprises: detecting, via the one or more input devices, input corresponding to a request directed to an agent to perform a task; and in response to detecting the input, outputting, via the one or more output devices, a response corresponding to the task, wherein the response includes: first content, corresponding to a first application, that represents a first option for performing the task using the first application; and second content, corresponding to a second application different from the first application, that represents a second option for performing the task using the second application, wherein the second content is different from the first content.

In some embodiments, a non-transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, input corresponding to a request directed to an agent to perform a task; and in response to detecting the input, outputting, via the one or more output devices, a response corresponding to the task, wherein the response includes: first content, corresponding to a first application, that represents a first option for performing the task using the first application; and second content, corresponding to a second application different from the first application, that represents a second option for performing the task using the second application, wherein the second content is different from the first content.

In some embodiments, a transitory computer-readable storage medium storing one or more programs configured to be executed by one or more processors of a computer system that is in communication with one or more input devices and one or more output devices is described. In some embodiments, the one or more programs includes instructions for: detecting, via the one or more input devices, input corresponding to a request directed to an agent to perform a task; and in response to detecting the input, outputting, via the one or more output devices, a response corresponding to the task, wherein the response includes: first content, corresponding to a first application, that represents a first option for performing the task using the first application; and second content, corresponding to a second application different from the first application, that represents a second option for performing the task using the second application, wherein the second content is different from the first content.

In some embodiments, a computer system that is in communication with one or more input devices and one or more output devices is described. In some embodiments, the computer system that is in communication with one or more input devices and one or more output devices comprises one or more processors and memory storing one or more programs configured to be executed by the one or more processors. In some embodiments, the one or more programs includes instructions for: detecting, via the one or more input devices, input corresponding to a request directed to an agent to perform a task; and in response to detecting the input, outputting, via the one or more output devices, a response corresponding to the task, wherein the response includes: first content, corresponding to a first application, that represents a first option for performing the task using the first application; and second content, corresponding to a second application different from the first application, that represents a second option for performing the task using the second application, wherein the second content is different from the first content.

In some embodiments, a computer system that is in communication with one or more input devices and one or more output devices is described. In some embodiments, the computer system that is in communication with one or more input devices and one or more output devices comprises means for performing each of the following steps: detecting, via the one or more input devices, input corresponding to a request directed to an agent to perform a task; and in response to detecting the input, outputting, via the one or more output devices, a response corresponding to the task, wherein the response includes: first content, corresponding to a first application, that represents a first option for performing the task using the first application; and second content, corresponding to a second application different from the first application, that represents a second option for performing the task using the second application, wherein the second content is different from the first content.

In some embodiments, a computer program product is described. In some embodiments, the computer program product comprises one or more programs configured to be executed by one or more processors of a computer system that is in communication with one or more input devices and one or more output devices. In some embodiments, the one or more programs include instructions for: detecting, via the one or more input devices, input corresponding to a request directed to an agent to perform a task; and in response to detecting the input, outputting, via the one or more output devices, a response corresponding to the task, wherein the response includes: first content, corresponding to a first application, that represents a first option for performing the task using the first application; and second content, corresponding to a second application different from the first application, that represents a second option for performing the task using the second application, wherein the second content is different from the first content.

In some embodiments, a method that is performed at a computer system that is in communication with one or more input devices and one or more output devices is described. In some embodiments, the method comprises: detecting an indication that a suggestion of content is to be provided; in response to detecting the indication that the suggestion of content is to be provided, outputting, via the one or more output devices, a suggestion of first content; in conjunction with outputting the suggestion of first content, detecting, via the one or more input devices, input corresponding to the suggestion of first content; and in response to detecting the input corresponding to the suggestion of first content, outputting, via the one or more output devices, an indication of a context for the suggestion of first content, wherein the indication of the context corresponds to a set of one or more communications exchanged between a first user account and a second user account different from the first user account.

In some embodiments, a non-transitory computer-readable storage medium storing one or more programs configured to be executed by one or more processors of a computer system that is in communication with one or more input devices and one or more output devices is described. In some embodiments, the one or more programs includes instructions for: detecting an indication that a suggestion of content is to be provided; in response to detecting the indication that the suggestion of content is to be provided, outputting, via the one or more output devices, a suggestion of first content; in conjunction with outputting the suggestion of first content, detecting, via the one or more input devices, input corresponding to the suggestion of first content; and in response to detecting the input corresponding to the suggestion of first content, outputting, via the one or more output devices, an indication of a context for the suggestion of first content, wherein the indication of the context corresponds to a set of one or more communications exchanged between a first user account and a second user account different from the first user account.

In some embodiments, a transitory computer-readable storage medium storing one or more programs configured to be executed by one or more processors of a computer system that is in communication with one or more input devices and one or more output devices is described. In some embodiments, the one or more programs includes instructions for: detecting an indication that a suggestion of content is to be provided; in response to detecting the indication that the suggestion of content is to be provided, outputting, via the one or more output devices, a suggestion of first content; in conjunction with outputting the suggestion of first content, detecting, via the one or more input devices, input corresponding to the suggestion of first content; and in response to detecting the input corresponding to the suggestion of first content, outputting, via the one or more output devices, an indication of a context for the suggestion of first content, wherein the indication of the context corresponds to a set of one or more communications exchanged between a first user account and a second user account different from the first user account.

In some embodiments, a computer system that is in communication with one or more input devices and one or more output devices is described. In some embodiments, the computer system that is in communication with one or more input devices and one or more output devices comprises one or more processors and memory storing one or more programs configured to be executed by the one or more processors. In some embodiments, the one or more programs includes instructions for: detecting an indication that a suggestion of content is to be provided; in response to detecting the indication that the suggestion of content is to be provided, outputting, via the one or more output devices, a suggestion of first content; in conjunction with outputting the suggestion of first content, detecting, via the one or more input devices, input corresponding to the suggestion of first content; and in response to detecting the input corresponding to the suggestion of first content, outputting, via the one or more output devices, an indication of a context for the suggestion of first content, wherein the indication of the context corresponds to a set of one or more communications exchanged between a first user account and a second user account different from the first user account.

In some embodiments, a computer system that is in communication with one or more input devices and one or more output devices is described. In some embodiments, the computer system that is in communication with one or more input devices and one or more output devices comprises means for performing each of the following steps: detecting an indication that a suggestion of content is to be provided; in response to detecting the indication that the suggestion of content is to be provided, outputting, via the one or more output devices, a suggestion of first content; in conjunction with outputting the suggestion of first content, detecting, via the one or more input devices, input corresponding to the suggestion of first content; and in response to detecting the input corresponding to the suggestion of first content, outputting, via the one or more output devices, an indication of a context for the suggestion of first content, wherein the indication of the context corresponds to a set of one or more communications exchanged between a first user account and a second user account different from the first user account.

In some embodiments, a computer program product is described. In some embodiments, the computer program product comprises one or more programs configured to be executed by one or more processors of a computer system that is in communication with one or more input devices and one or more output devices. In some embodiments, the one or more programs include instructions for: detecting an indication that a suggestion of content is to be provided; in response to detecting the indication that the suggestion of content is to be provided, outputting, via the one or more output devices, a suggestion of first content; in conjunction with outputting the suggestion of first content, detecting, via the one or more input devices, input corresponding to the suggestion of first content; and in response to detecting the input corresponding to the suggestion of first content, outputting, via the one or more output devices, an indication of a context for the suggestion of first content, wherein the indication of the context corresponds to a set of one or more communications exchanged between a first user account and a second user account different from the first user account.

In some embodiments, a method that is performed at a computer system that is in communication with one or more input devices and one or more output devices is described. In some embodiments, the method comprises: detecting input, via the one or more input devices, corresponding to a request, from a first user, to provide a suggestion of media content; and in response to detecting the input corresponding to the request, from the first user, to provide the suggestion of media content: in accordance with a determination that a set of one or more communications exchanged between the first user and a second user satisfy a set of one or more criteria with respect to first media content, outputting, via the one or more output devices, a first suggestion; in accordance with a determination that the set of one or more communications exchanged between the first user and the second user satisfy the set of one or more criteria with respect to second media content, outputting, via the one or more output devices, a second suggestion different from the first suggestion, wherein the second media content is different from the first media content; and in accordance with a determination that the set of one or more communications exchanged between the first user and the second user does not satisfy the set of one or more criteria with respect to media content, outputting, via the one or more output devices, a third suggestion different from the first suggestion and the second suggestion.

In some embodiments, a non-transitory computer-readable storage medium storing one or more programs configured to be executed by one or more processors of a computer system that is in communication with one or more input devices and one or more output devices is described. In some embodiments, the one or more programs includes instructions for: detecting input, via the one or more input devices, corresponding to a request, from a first user, to provide a suggestion of media content; and in response to detecting the input corresponding to the request, from the first user, to provide the suggestion of media content: in accordance with a determination that a set of one or more communications exchanged between the first user and a second user satisfy a set of one or more criteria with respect to first media content, outputting, via the one or more output devices, a first suggestion; in accordance with a determination that the set of one or more communications exchanged between the first user and the second user satisfy the set of one or more criteria with respect to second media content, outputting, via the one or more output devices, a second suggestion different from the first suggestion, wherein the second media content is different from the first media content; and in accordance with a determination that the set of one or more communications exchanged between the first user and the second user does not satisfy the set of one or more criteria with respect to media content, outputting, via the one or more output devices, a third suggestion different from the first suggestion and the second suggestion.

In some embodiments, a transitory computer-readable storage medium storing one or more programs configured to be executed by one or more processors of a computer system that is in communication with one or more input devices and one or more output devices is described. In some embodiments, the one or more programs includes instructions for: detecting input, via the one or more input devices, corresponding to a request, from a first user, to provide a suggestion of media content; and in response to detecting the input corresponding to the request, from the first user, to provide the suggestion of media content: in accordance with a determination that a set of one or more communications exchanged between the first user and a second user satisfy a set of one or more criteria with respect to first media content, outputting, via the one or more output devices, a first suggestion; in accordance with a determination that the set of one or more communications exchanged between the first user and the second user satisfy the set of one or more criteria with respect to second media content, outputting, via the one or more output devices, a second suggestion different from the first suggestion, wherein the second media content is different from the first media content; and in accordance with a determination that the set of one or more communications exchanged between the first user and the second user does not satisfy the set of one or more criteria with respect to media content, outputting, via the one or more output devices, a third suggestion different from the first suggestion and the second suggestion.

In some embodiments, a computer system that is in communication with one or more input devices and one or more output devices is described. In some embodiments, the computer system that is in communication with one or more input devices and one or more output devices comprises one or more processors and memory storing one or more programs configured to be executed by the one or more processors. In some embodiments, the one or more programs includes instructions for: detecting input, via the one or more input devices, corresponding to a request, from a first user, to provide a suggestion of media content; and in response to detecting the input corresponding to the request, from the first user, to provide the suggestion of media content: in accordance with a determination that a set of one or more communications exchanged between the first user and a second user satisfy a set of one or more criteria with respect to first media content, outputting, via the one or more output devices, a first suggestion; in accordance with a determination that the set of one or more communications exchanged between the first user and the second user satisfy the set of one or more criteria with respect to second media content, outputting, via the one or more output devices, a second suggestion different from the first suggestion, wherein the second media content is different from the first media content; and in accordance with a determination that the set of one or more communications exchanged between the first user and the second user does not satisfy the set of one or more criteria with respect to media content, outputting, via the one or more output devices, a third suggestion different from the first suggestion and the second suggestion.

In some embodiments, a computer system that is in communication with one or more input devices and one or more output devices is described. In some embodiments, the computer system that is in communication with one or more input devices and one or more output devices comprises means for performing each of the following steps: detecting input, via the one or more input devices, corresponding to a request, from a first user, to provide a suggestion of media content; and in response to detecting the input corresponding to the request, from the first user, to provide the suggestion of media content: in accordance with a determination that a set of one or more communications exchanged between the first user and a second user satisfy a set of one or more criteria with respect to first media content, outputting, via the one or more output devices, a first suggestion; in accordance with a determination that the set of one or more communications exchanged between the first user and the second user satisfy the set of one or more criteria with respect to second media content, outputting, via the one or more output devices, a second suggestion different from the first suggestion, wherein the second media content is different from the first media content; and in accordance with a determination that the set of one or more communications exchanged between the first user and the second user does not satisfy the set of one or more criteria with respect to media content, outputting, via the one or more output devices, a third suggestion different from the first suggestion and the second suggestion.

In some embodiments, a computer program product is described. In some embodiments, the computer program product comprises one or more programs configured to be executed by one or more processors of a computer system that is in communication with one or more input devices and one or more output devices. In some embodiments, the one or more programs include instructions for: detecting input, via the one or more input devices, corresponding to a request, from a first user, to provide a suggestion of media content; and in response to detecting the input corresponding to the request, from the first user, to provide the suggestion of media content: in accordance with a determination that a set of one or more communications exchanged between the first user and a second user satisfy a set of one or more criteria with respect to first media content, outputting, via the one or more output devices, a first suggestion; in accordance with a determination that the set of one or more communications exchanged between the first user and the second user satisfy the set of one or more criteria with respect to second media content, outputting, via the one or more output devices, a second suggestion different from the first suggestion, wherein the second media content is different from the first media content; and in accordance with a determination that the set of one or more communications exchanged between the first user and the second user does not satisfy the set of one or more criteria with respect to media content, outputting, via the one or more output devices, a third suggestion different from the first suggestion and the second suggestion.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating a computer system in accordance with some embodiments.

FIGS. 2A-2C are diagrams illustrating exemplary components and user interfaces of electronic device in accordance with some embodiments.

FIG. 3 is a block diagram illustrating exemplary components of a device in accordance with some embodiments.

FIG. 4 is a functional diagram of an exemplary actuator device in accordance with some embodiments.

FIG. 5 is a functional diagram of an exemplary agent system in accordance with some embodiments.

FIGS. 6A-6E illustrate exemplary user interfaces for updating an indication of an activity in accordance with some embodiments.

FIG. 7 is a flow diagram illustrating processes for updating an indication of an activity in accordance with some embodiments.

FIGS. 8A-8E illustrate exemplary user interfaces for providing interactive user interfaces during content output in accordance with some embodiments.

FIG. 9 is a flow diagram illustrating processes for providing playback location dependent information in accordance with some embodiments.

FIG. 10 is a flow diagram illustrating processes for performing an operation without interrupting content playback in accordance with some embodiments.

FIG. 11 is a flow diagram illustrating processes for responding to a request without interrupting content output in accordance with some embodiments.

FIGS. 12A-12B illustrate exemplary user interfaces for providing an application to perform a requested task in accordance with some embodiments.

FIG. 13 is a flow diagram illustrating processes for providing an application to perform a requested task in accordance with some embodiments.

FIGS. 14A-14C illustrate exemplary user interfaces for providing multiple applications to perform a requested task in accordance with some embodiments.

FIG. 15 is a flow diagram illustrating processes for providing multiple applications to perform a requested task in accordance with some embodiments.

FIGS. 16A-16C illustrate exemplary user interfaces for providing suggested content in accordance with some embodiments.

FIG. 17 is a flow diagram illustrating processes for providing suggested content in accordance with some embodiments.

FIG. 18 is a flow diagram illustrating processes for providing suggested content based on communications exchanged between users in accordance with some embodiments.

### DETAILED DESCRIPTION

The description to follow sets forth exemplary methods, components, parameters, and the like. While specific examples are set out below, it should be recognized that such examples should not be understood as limiting the scope of the present disclosure to the explicit descriptions of the examples set forth herein but instead should be understood as providing illustrative examples.

Each of the identified modules and applications herein corresponds to a set of executable instructions for performing one or more functions described above and the methods described in this application (e.g., the computer-implemented methods and other information processing methods described herein). These modules (e.g., sets of instructions) optionally need not be implemented as separate software programs (such as computer programs (e.g., including instructions)), procedures, or modules, and thus various subsets of these modules are, optionally, combined or otherwise rearranged in various embodiments. For example, a video player module is, optionally, combined with a music player module into a single module. In some embodiments, memory optionally stores a subset of the modules and data structures identified above. Furthermore, memory optionally stores additional modules and data structures not described above.

One or more steps of the methods described herein can rely on (be contingent on) one or more conditions being satisfied. In some embodiments, a method is performed by iterating a process multiple times. In some embodiments, contingent steps can be satisfied on different iterations of the same process and still be within the scope of the methods described herein. For example, for a given method that includes two steps that are contingent on different conditions, one of ordinary skill in the art would understand that the given method is considered performed even when a process is repeated multiple times until the contingent steps are satisfied. In some embodiments, multiple iterations of a process are not required to in order to practice claims as presented herein. For example, electronic device, system, or computer readable medium claims can be performed without iteratively repeating a process. In some embodiments, the electronic device, system, or computer readable medium claims include instructions for performing one or more steps that are contingent upon one or more conditions being satisfied. Because such instructions are stored in one or more processors and/or at one or more memory locations, the electronic device, system, or computer readable medium claims can include logic that determines whether the one or more conditions have been satisfied without needing to repeat steps of a process.

Although elements are described below using numerical descriptors, such as “a first” and/or “a second,” these elements do not correspond to order or distinct representations and should not be limited to the stated numerical term. In some embodiments, these terms simply used as prefix to distinguish a reference to one element from a reference to another element. For example, a “first” device and a “second” device can be two separate references to the same device. In contrast, for example, a “first” device and a “second” device can be a reference to two different devices (e.g., not the same device and/or not the same type of device). For example, a first computer system and a second computer system do not correspond to a first and a second in time, and merely are used to distinguish between two computer systems. As such, the first computer system can be termed a second computer system, and the second computer system can be termed a first computer system without departing from the scope of the various described embodiments.

For description of various elements and examples, the use of certain terminology is used to provide productive descriptions of the subject matter below and should not be read as limiting. As used to describe various examples herein, the singular forms of “a,” “an,” and “the” should not be interpreted as precluding or excluding the plural forms as well, unless the context clearly indicates otherwise. As well, “and/or” is used to encompasses any and all possible combinations of one or more associated listed items. For example, “x and/or y” should be interpreted as including “x,” or “y,” as well as “x and y” as possible permutations. Further, the use of the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

When describing choices and/or logical possibilities, the term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

The processes described below enhance the operability of the devices and make the user-device more efficient (e.g., by helping the user to provide proper inputs and reducing user mistakes when operating/interacting with the device) through various techniques, including by providing improved feedback (e.g., visual, haptic, audible, and/or tactile feedback) to the user, reducing the number of inputs needed to perform an operation, providing additional control options without cluttering the user interface with additional displayed controls, performing an operation when a set of conditions has been met without requiring further input (e.g., input by a user), and/or additional techniques, such as increasing the security and/or privacy of the computer system and reducing burn-in of one or more portions of a user interface of a display. These techniques also reduce power usage and improve battery life of the device by enabling the user to use the device more quickly and efficiently.

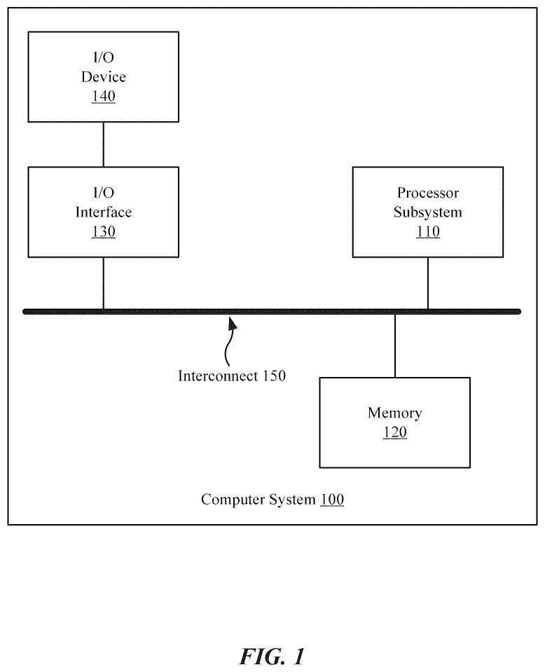

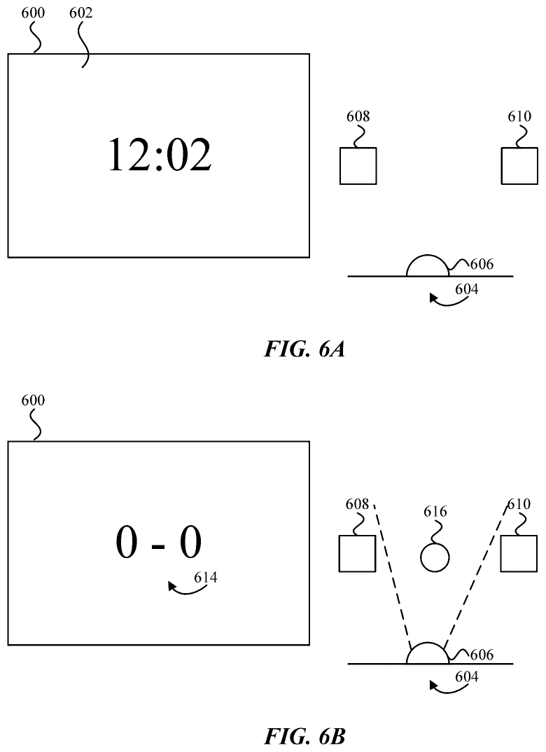

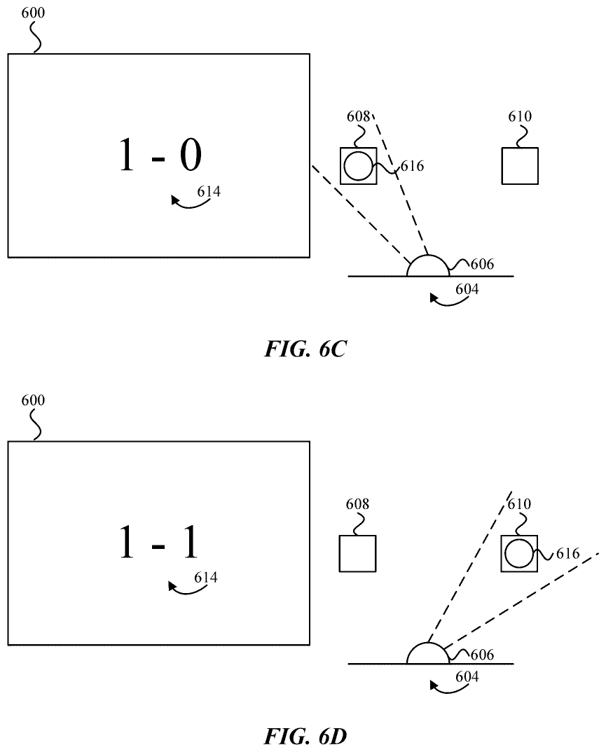

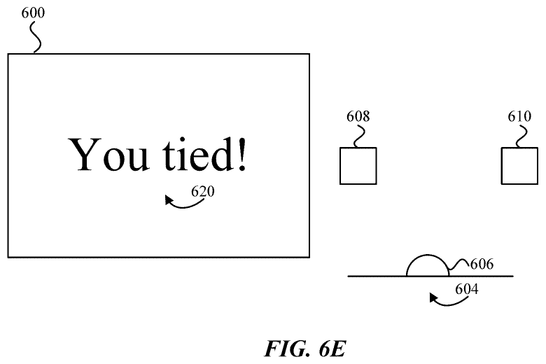

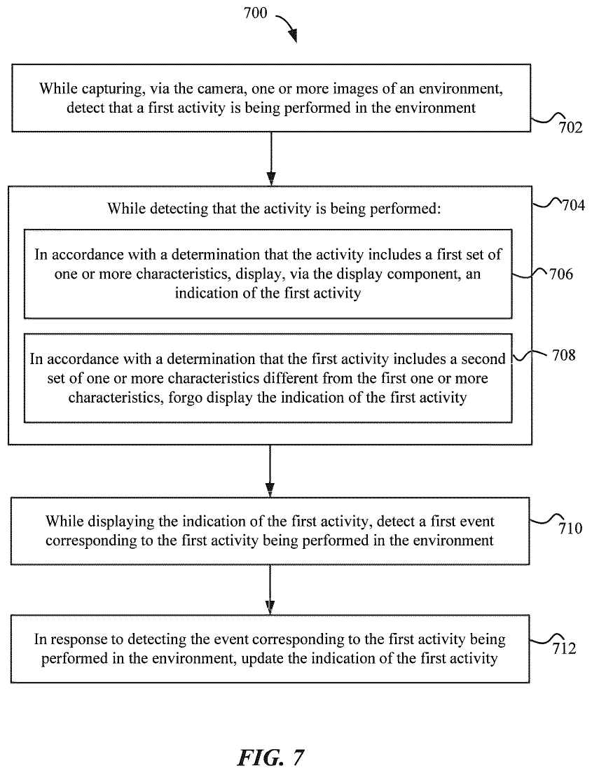

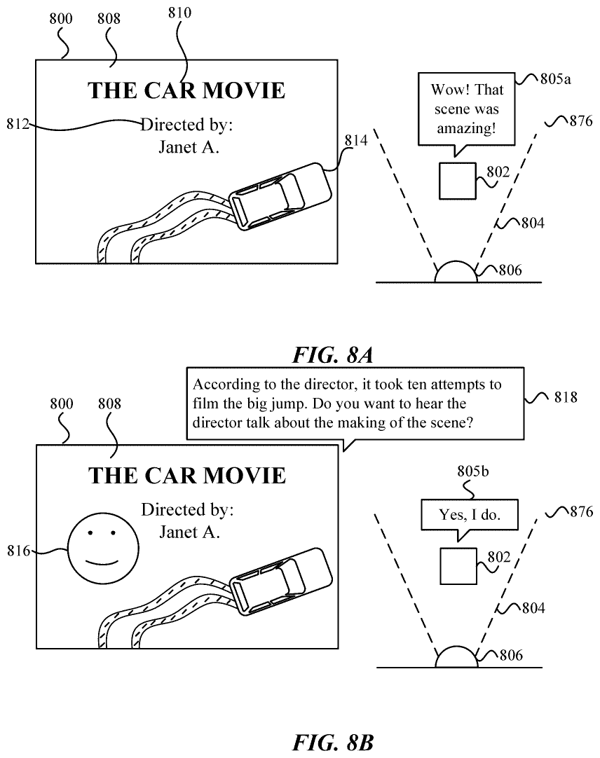

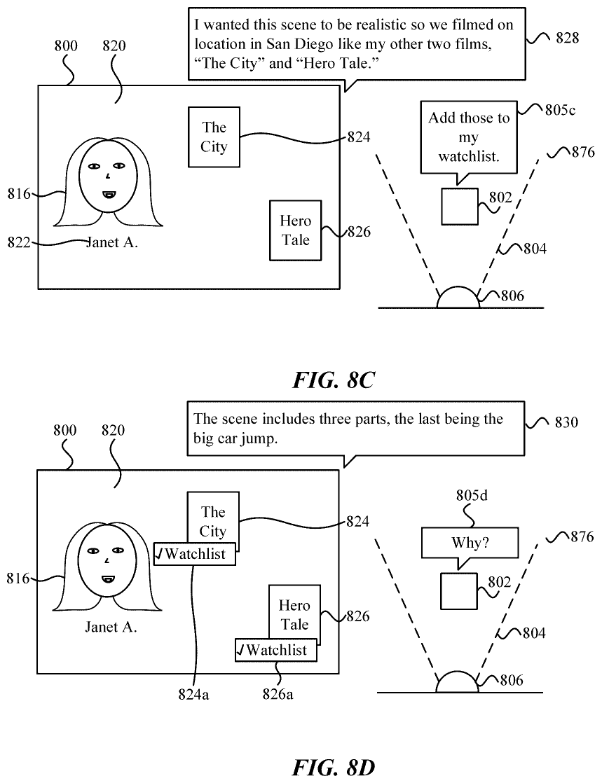

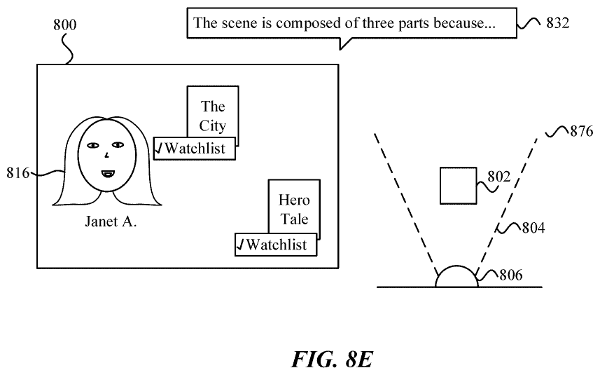

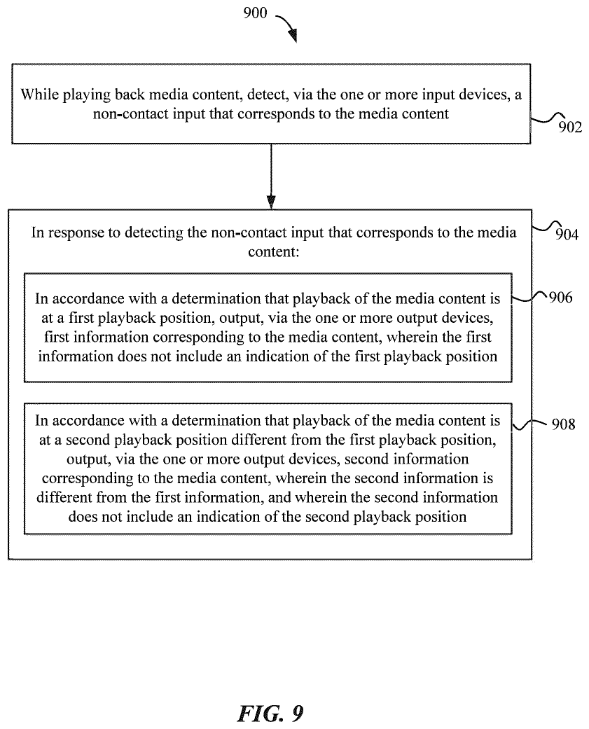

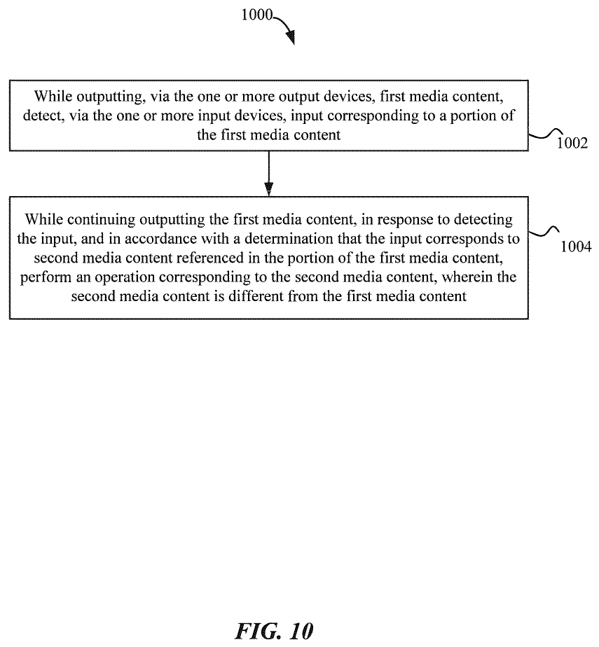

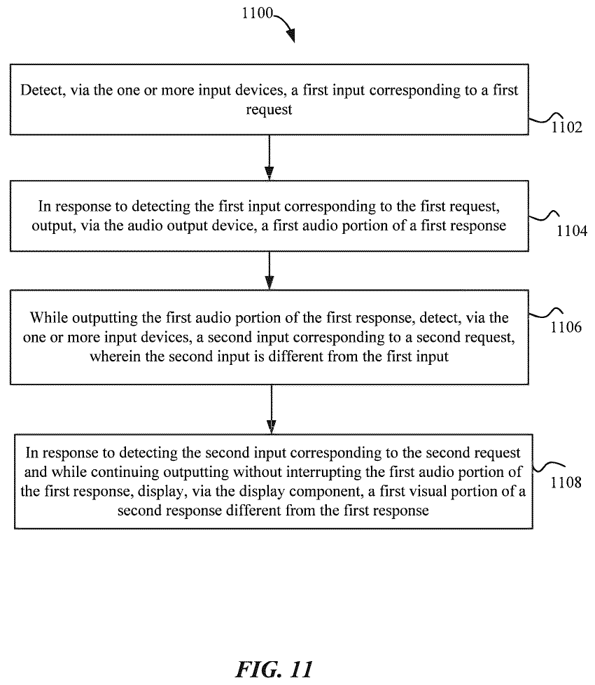

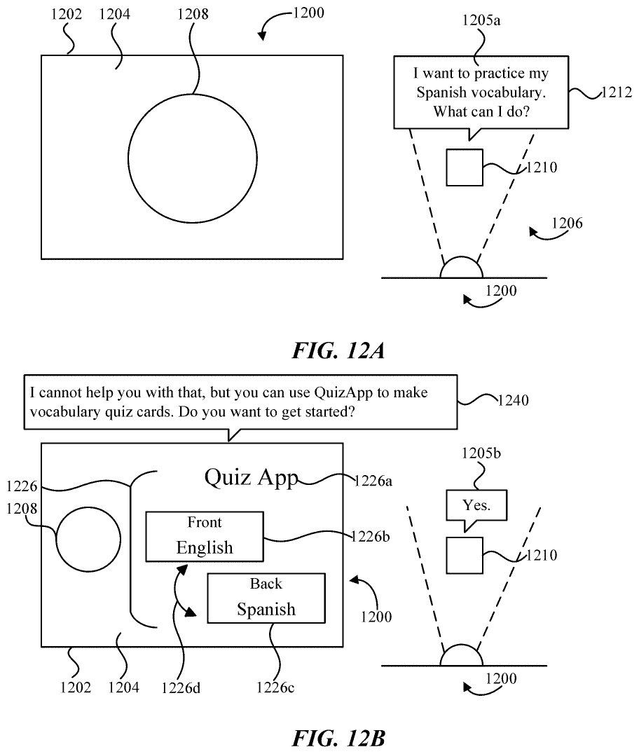

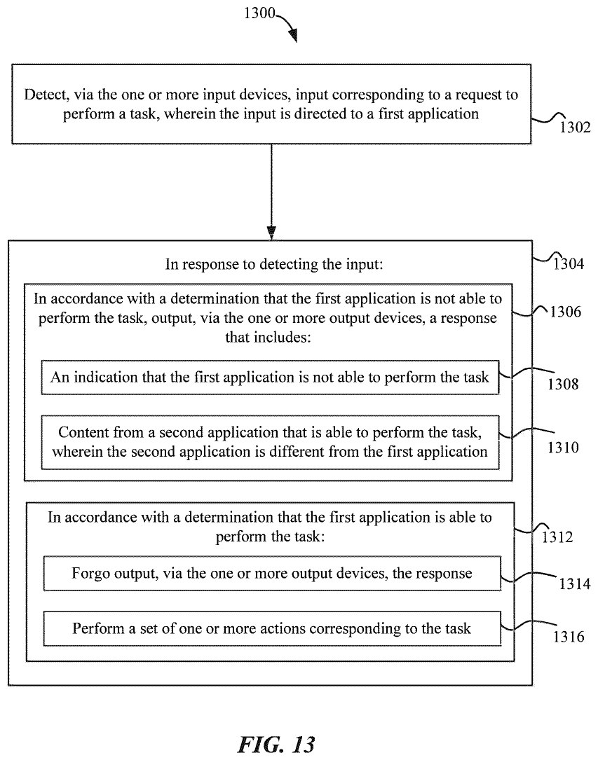

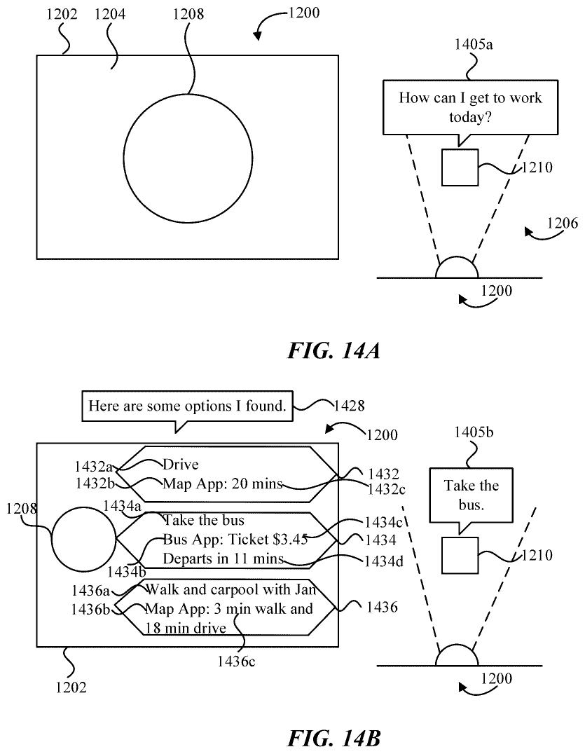

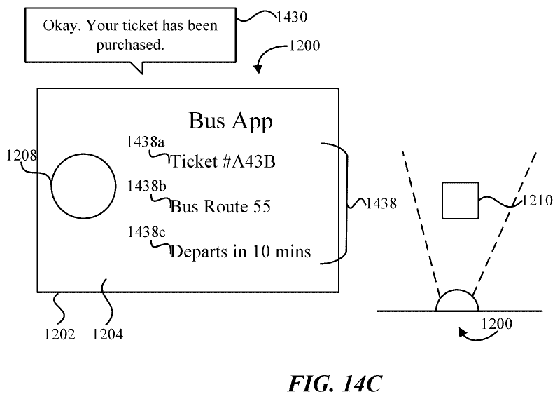

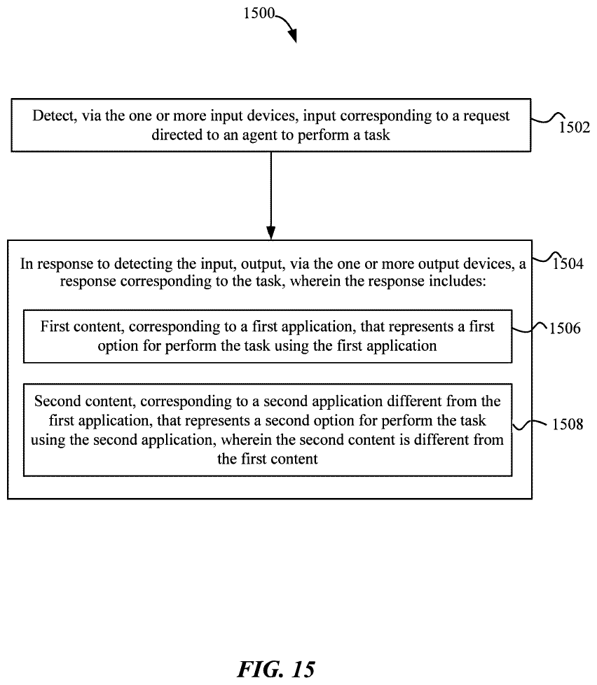

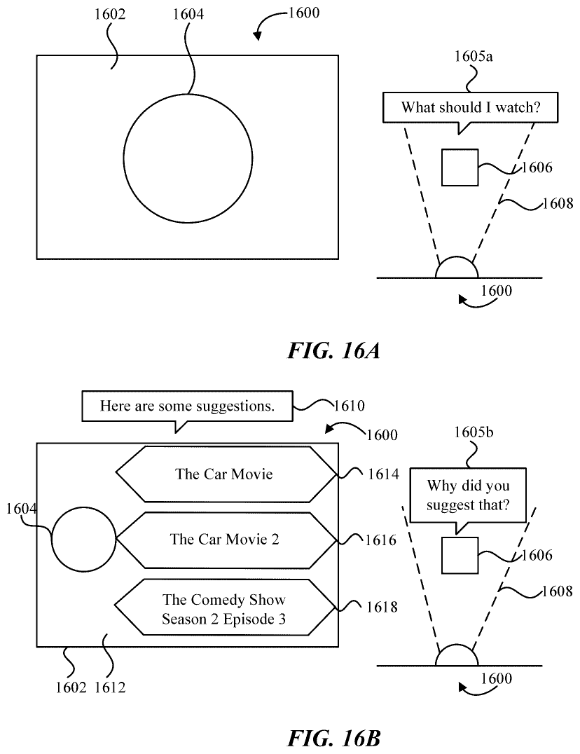

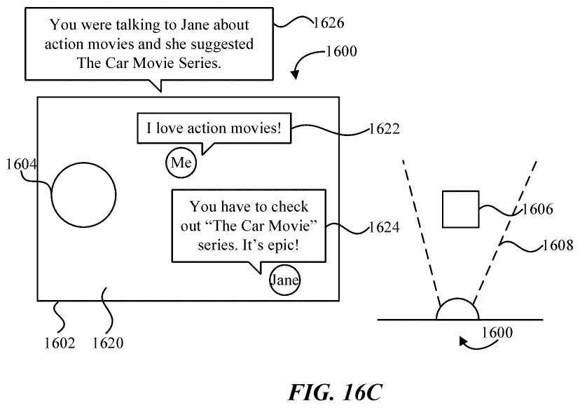

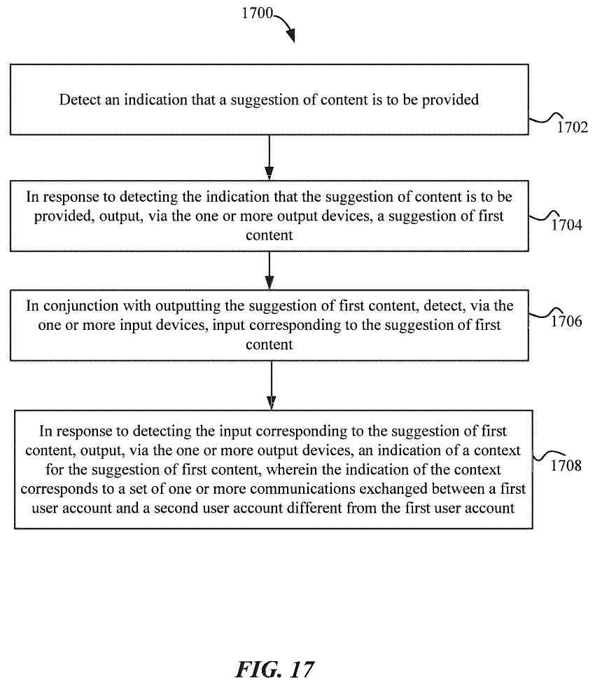

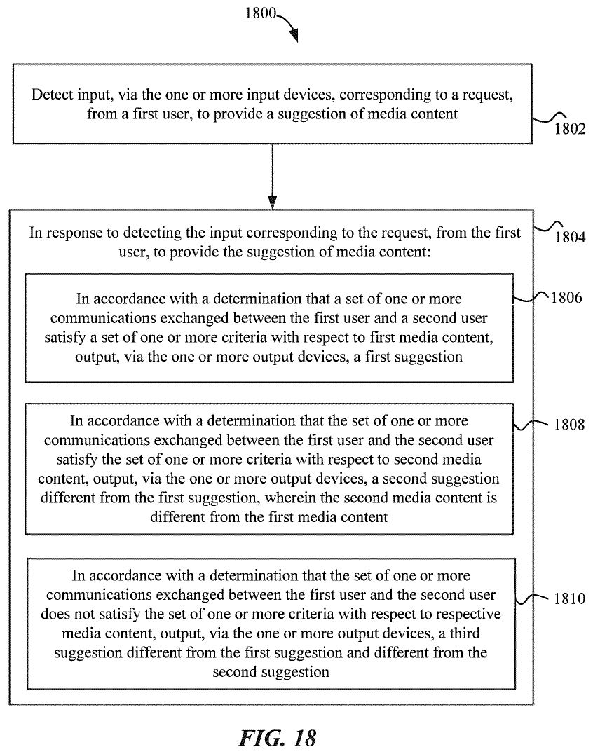

Below, FIGS. 1, 2A-2C, and 3-5 provide a description of exemplary devices for performing the techniques for updating an indication of an activity. FIGS. 6A-6E illustrate exemplary user interfaces for updating an indication of an activity in accordance with some embodiments. FIG. 7 is a flow diagram illustrating processes for updating an indication of an activity in accordance with some embodiments. The user interfaces in FIGS. 6A-6E are used to illustrate the processes described below, including the processes in FIG. 7. FIGS. 8A-8E illustrate exemplary user interfaces for managing event notifications. FIG. 9 is a flow diagram illustrating processes for providing playback location dependent information in accordance with some embodiments. FIG. 10 is a flow diagram illustrating processes for performing an operation without interrupting content playback in accordance with some embodiments. FIG. 11 is a flow diagram illustrating processes for responding to a request without interrupting content output in accordance with some embodiments. The user interfaces in FIGS. 8A-8E are used to illustrate the processes described below, including the processes in FIGS. 9, 10, and 11. FIGS. 12A-12B illustrate exemplary user interfaces for providing an application to perform a requested task in accordance with some embodiments. FIG. 13 is a flow diagram illustrating processes for providing an application to perform a requested task in accordance with some embodiments. The user interfaces in FIGS. 12A-12B are used to illustrate the processes described below, including the processes in FIGS. 13 and/or 15. FIGS. 14A-14C illustrate exemplary user interfaces for providing multiple applications to perform a requested task in accordance with some embodiments. FIG. 15 is a flow diagram illustrating processes for providing multiple applications to perform a requested task in accordance with some embodiments. The user interfaces in FIGS. 14A-14C are used to illustrate the processes described below, including the processes in FIGS. 13 and/or 15. FIGS. 16A-16C illustrate exemplary user interfaces for providing suggested content in accordance with some embodiments. FIG. 17 is a flow diagram illustrating processes for providing suggested content in accordance with some embodiments. FIG. 18 is a flow diagram illustrating processes for providing suggested content based on communications exchanged between users in accordance with some embodiments. The user interfaces in FIGS. 16A-16C are used to illustrate the processes described below, including the processes in FIGS. 17 and 18.

FIG. 1 depicts a block diagram of computer system 100 (e.g., electronic device and/or electronic system) including a set of electronic components in communication with (e.g., connected to) (e.g., wired or wirelessly) to each other. It should be understood that computer system 100 is merely one example of a computer system that can be used to perform functionality described below and that one or more other computer systems can be used to perform the functionality described below. Additionally, while FIG. 1 depicts a computer architecture of computer system 100, other computer architectures (e.g., including more components, similar components, and/or fewer components) of a computer system can be used to perform functionality described herein.

In some embodiments, computer system 100 can correspond to (e.g., be and/or include) a system on a chip, a server system, a personal computer system, a smart phone, a smart watch, a wearable device, a tablet, a laptop computer, a fitness tracking device, a head-mounted display (HMD) device, a desktop computer, a communal device (e.g., smart speaker, connected thermostat, and/or additional home based computer systems), an accessory (e.g., switch, light, speaker, air conditioner, heater, window cover, fan, lock, media playback device, television, and so forth), a controller, a hub, and/or a sensor.

In some embodiments, a sensor includes one or more hardware components capable of detecting (e.g., sensing, generating, and/or processing) information about a physical environment in proximity to the sensor. For example, a sensor can be configured to detect information surrounding the sensor, detect information in one or more directions casting away from the sensor, and/or detect information based on contact of the sensor with an element of the physical environment. In some embodiments, a hardware component of a sensor includes a sensing component (e.g., a temperature and/or image sensor), a transmitting component (e.g., a radio and/or laser transmitter), and/or a receiving component (e.g., a laser and/or radio receiver). In some embodiments, a sensor includes an angle sensor, a breakage sensor, a flow sensor, a force sensor, a gas sensor, a humidity or moisture sensor, a glass breakage sensor, a chemical sensor, a contact sensor, a non-contact sensor, an image sensor (e.g., a RGB camera and/or an infrared sensor), a particle sensor, a photoelectric sensor (e.g., ambient light and/or solar), a position sensor (e.g., a global positioning system), a precipitation sensor, a pressure sensor, a proximity sensor, a radiation sensor, an inertial measurement unit, a leak sensor, a level sensor, a metal sensor, a microphone, a motion sensor, a range or depth sensor (e.g., RADAR, LiDAR), a speed sensor, a temperature sensor, a time-of-flight sensor, a torque sensor, and an ultrasonic sensor, a vacancy sensor, a presence sensor, a voltage and/or current sensor, a conductivity sensor, a resistivity sensor, a capacitive sensor, and/or a water sensor. While only a single computer system is depicted in FIG. 1, functionality described below can be implemented with two or more computer systems operating together. Additionally, in some embodiments, computer system 100 includes one or more sensors as described above, and information about the physical environment is captured by combining data from one sensor with data from one or more additional sensors (e.g., that are part of the computer and/or one or more additional computer systems).

As illustrated in FIG. 1, computer system 100 consists of processor subsystem 110, memory 120, and I/O interface 130. Memory 120 corresponds to system memory in communication with processor subsystem 110. The electronic components making up computer system 100 are electrically connected through interconnect 150, which allows communication between the components of computer system 100. For example, interconnect 150 can be a system bus, one or more memory locations, and/or additional electrical channels for connective multiple components of computer system 100. Also, I/O interface 130 is connected to, via a wired and/or wireless connection, I/O device 140. In some embodiments, computer system 100 includes a component made up of I/O interface 130 and I/O device 140 such that the functionality of the individual components is included in the component. Additionally, it should be understood that computer system 100 can include one or more I/O interfaces, communicating with one or more I/O devices. In some embodiments, computer system 100 consists of multiple processor subsystem 100s, each electrically connected through interconnect 150.

In some embodiments, processor subsystem 110 includes one or more processors or individual processing units capable of executing instructions (e.g., program, system, and/or interrupt) to perform functionality described herein. For example, operating system level and/or application level instructions executed by processor subsystem 110. In some embodiments, processor subsystem 110 includes one or more components (e.g., implemented as hardware, software, and/or a combination thereof) capable of supporting, interpreting, and/or performing machine learning instructions and/or operations. For example, computer system 100 can perform operations according to a machine learning model locally. Alternatively, or in addition, computer system 100 can communicate with (e.g., performing calculations on and/or executing instructions corresponding to) a remote interactive knowledge base (e.g., a processing resource that implements a machine learning model, artificial intelligence model, and/or large language model) to perform operations that can be otherwise outside a set of capabilities of computer system 100. For example, computer system 100 can determine a set of inputs (e.g., instructions, data, and/or parameters) to the interactive knowledge base for performing desired machine learning operations.

Memory 120 in communication with processor subsystem 110 can be implemented by a variety of different physical, non-transitory memory media. In some embodiments, computer system 100 includes multiple memory components and/or multiple types of memory components, each connected to processor subsystem 110 directly and/or via interconnect 150. For example, memory 120 can be implemented using a removable flash drive, storage array, a storage area network (e.g., SAN), flash memory, hard disk storage, optical drive storage, floppy disk storage, removable disk storage, random access memory (e.g., SDRAM, DDR SDRAM, RAM-SRAM, EDO RAM, and/or RAMBUS RAM), and/or read only memory (e.g., PROM and/or EEPROM). Additionally, in some embodiments, processor subsystem 110 and/or interconnect 150 is connected to a memory controller that is electrically connected to memory 120.

In some embodiments, instructions can be executed by processor subsystem 110. In this example, memory 120 can include a computer readable medium (e.g., non-transitory or transitory computer readable medium) usable to store (e.g., configured to store, assigned to store, and/or that stores) instructions to be executable by processor subsystem 110. In some embodiments each instruction stored by memory 120 and executed by processor subsystem 110 corresponds to an operation for completing the functionality described herein. For example, memory 120 can store program instructions to implement the functionality associated with the processes described below including processes 700, 900, 1000, 1100, 1300, 1500, 1700, and/or 1800 (FIGS. 7, 9, 10, 11, 13, 15, 17, and/or 18).

As mentioned above, I/O interface 130 can be one or more types of interfaces enabling computer system 100 to communicate with other devices. In some embodiments, I/O interface 130 includes a bridge chip (e.g., Southbridge) from a front-side bus to one or more back-side buses. In some embodiments, I/O interface 130 enables communication with one or more I/O devices, illustrated as I/O device 140, via one or more corresponding buses or other interfaces. For example, an I/O device can include one or more: a physical user-interface devices (e.g., a physical keyboard, a mouse, and/or a joystick), storage devices (e.g., as described above with respect to memory 120), network interface devices (e.g., to a local or wide-area network), sensor devices (e.g., as described above with respect to sensors), and/or auditory and/or visual output devices (e.g., screen, speaker, light, and/or projector). In some embodiments, the visual output device is referred to as a display component. For example, the display component can be configured to provide visual output, such as displaying images on a physically viewable medium via an LED display or image projection. As used herein, “displaying” content includes causing to display the content (e.g., video data rendered and/or decoded by a display controller) by transmitting, via a wired or wireless connection, data (e.g., image data and/or video data) to an integrated or external display component to visually produce the content.

In some embodiments, computer system 100 includes a component that integrates I/O device 140 with other components (e.g., a component that includes I/O interface 130 and I/O device 140). In some embodiments, I/O device 140 is separate from other components of computer system 100 (e.g., is a discrete component). In some embodiments, I/O device 140 includes a network interface device that permits computer system 100 to connect to (e.g., communicate with) a network or other computer systems, in a wired or wireless manner. In some embodiments, a network interface device can include Wi-Fi, Bluetooth, NFC, USB, Thunderbolt, Ethernet, and so forth. For example, computer system 100 can utilize an NFC connection to facilitate a bank, credit, financial, token (e.g., fungible or non-fungible token), and/or cryptocurrency transaction between computer system 100 and another computer system within proximity.

In some embodiments, I/O device 140 includes components for detecting a user (a person, an animal, another computer system different from the computer system, and/or an object) and/or an input (e.g., a tap input and/or a non-tap input (e.g., a verbal input, an audible request, an audible command, an audible statement, a swipe input, a hold-and-drag input, a gaze input, an air gesture, and/or a mouse click)) from a detected user. In some embodiments, I/O device 140 enables computer system 100 to identify users associated with and/or without an account within an environment. For example, computer system 100 can detect a known user (e.g., a user that corresponds to an account) and access information about the user using the known user's account. In some embodiments, as part of computer system 100 detecting a user, computer system 100 detects that the user's account is associated with (e.g., is included in and/or identified with respect to) a group of users. For example, computer system 100 can access information associated with a family of accounts in response to detecting a member of the family that is defined as a group of accounts. In some embodiments, as account corresponding to a user can be connected with additional accounts and/or additional computer systems. For example, computer system 100 can detect such additional computer systems and/or detect such computer systems for detecting the user. In some embodiments, computer system 100 detects unknown users and enables guest accounts for the unknown users to utilize computer system 100.

In some embodiments, I/O device 140 includes one or more cameras. In some embodiments, a camera includes an image sensor (e.g., one or more optical sensors and/or one or more depth camera sensors) that provides computer system 100 with the ability to detect a user and/or a user's gestures (e.g., hand gestures and/or air gestures) as input. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body). In some embodiments, the one or more cameras enable computer system 100 to transmit pictorial and/or video information to an application. For example, image data captured by a camera can enable computer system 100 to complete a video phone call by transmitting video data to an application for performing the video phone call.

In some embodiments, I/O device 140 includes one or more microphones. For example, a microphone can be used by 100 to obtain data and/or information from a user without a contact input. In some embodiments, a microphone enables computer system 100 to detect verbal and/or speech input from a user. In some embodiments, computer system 100 utilizes speech input to enable personal assistant functionality. For example, a user eliciting a request to computer system 100 to perform an action and/or obtain information for the user. In some embodiments, computer system 100 utilizes speech input (e.g., along with one or more other input and/or output techniques) to request and/or detect information from a user without requiring the user to make physical contact with computer system 100.

In some embodiments, I/O device 140 includes physical input mediums for a user to interact directly with computer system 100. In some embodiments, a physical input medium includes one or more physical buttons (e.g., tactile depressible button and/or touch sensitive non-depressible component) on computer system 100 and/or connected to computer system 100, a mouse and keyboard input method (e.g., connected to computer system 100 together and/or separately with one or more I/O interfaces), and/or a touch sensitive display component.

In some embodiments, I/O device 140 includes one or more components for outputting information (e.g., a display component, an audio generation component, a speaker, a haptic output device, a display screen, a projector, and/or a touch-sensitive display). In some embodiments, computer system 100 uses I/O device 140 to convey information and/or a state of computer system 100. In some embodiments, I/O device 140 includes a tactile output component. For example, a tactile output component can be a haptic generation component that enables computer system 100 to convey information to a user in contact with (e.g., holding, touching, and/or nearby) computer system 100. In some embodiments, I/O device 140 includes one or more components for outputting visual outputs (e.g., video, image, animation, 3D rendering, augmented reality overlay, motion graphics, data visualization, digital art, etc.). For example, displaying content from one or more applications and/or system applications, and/or displaying a widget (e.g., a control that displays real-time information and/or data) corresponding to one or more applications.

In some embodiments, I/O device 140 includes one or more components for outputting audio (e.g., smart speakers, home theater system, soundbars, headphones, earphones, earbuds, speakers, television speakers, augmented reality headset speakers, audio jacks, optical audio output, Bluetooth audio outputs, HDMI audio outputs, audio sensors, etc.). In some embodiments, computer system 100 is able to output audio through the one or more speakers. For example, computer system 100 outputting audio-based content and/or information to a user. In some embodiments, the one or more speakers enable spatial audio (e.g., an audio output corresponding to an environment (e.g., computer system 100 detecting materials and/or objects within the environment and/or computer system 100 altering the audio pattern, intensity, and/or waveform to compensate for varying characteristics of an environment)).

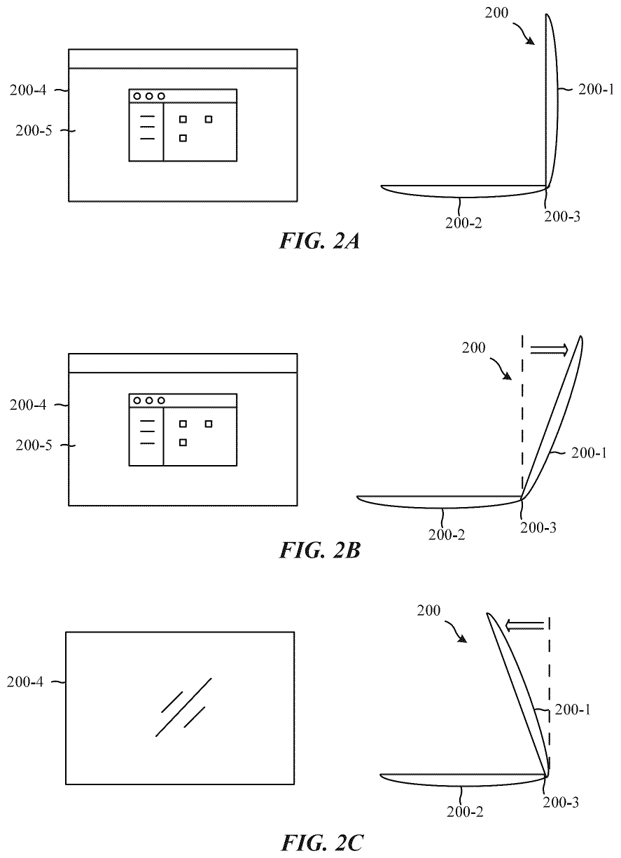

FIGS. 2-5 illustrate exemplary components and user interfaces of device 200 in accordance with some embodiments. Device 200 (sometimes referred to herein as device 200) can include one or more features of computer system 100. In the examples described with respect to FIGS. 2-5, device 200 is a laptop computer. In some embodiments, device 200 is not limited to being a laptop computer and one of ordinary skill in the art should recognize that device 200 can be one or more other devices (e.g., as described herein and/or that include one or more of the components and/or functions described herein with respect to device 200). For example, device 200 can be a communal device (such as a smart display, a smart speaker, and/or a television) and/or a personal device (such as a smart phone, a smart watch, a tablet, a desktop computer, a fitness tracking device, and/or a head mounted display device). In some embodiments, a communal device is configured to provide functionality to multiple users (e.g., at the same time and/or at different times). In such embodiments, the communal device can be administered and/or set up by a single user. In some embodiments, a personal device is configured to provide functionality to a single user (e.g., at a time, such as when the single user is logged into the personal device).

FIGS. 2A-2C illustrate device 200 in three different physical positions. As illustrated in FIG. 2A, device 200 is a laptop computer (also referred to herein as a “laptop”) that includes base portion 200-2 (e.g., that rests on a surface, such as a desk, horizontally as shown in FIG. 2A) and display portion 200-1 that is connected to base portion 200-2 at connection 200-3 (e.g., one or more connection points, a motorized arm, a hinge, and/or a joint) that enables display portion 200-1 to pivot and/or change orientation with respect to base portion 200-2. For example, device 200 can pivot at connection 200-3 to rotate display portion 200-1 and/or device 200 to one or more positions corresponding to an “OFF” internal state (e.g., as further described below in relation to FIG. 2C). In some embodiments, a position corresponding to an “OFF” internal state is a position in which device 200 is in a predetermined pose. For example, a predetermined pose can include display portion 200-1 positioned parallel to base portion 200-2 or display portion 200-1 forming a predetermined angle (e.g., 60-degree angle) with respect to base portion 200-2. In some embodiments, in the “OFF” internal state, an area in which content is displayed by device 200 is positioned in a manner that corresponds to (e.g., represents, is associated with, and/or is configured to accompany) the “OFF” internal state (e.g., facing down, not visible, and/or obscuring the area in which content is displayed). In some embodiments, in the “OFF” internal state, an area in which content is displayed by device 200 is not positioned in a manner that corresponds to (e.g., represents, is associated with, and/or is configured to accompany) the “OFF” internal state (e.g., instead is positioned in a manner that corresponds to an “ON” internal state). For example, when not in the “OFF” internal state, device 200 can be positioned within a range of different open positions (e.g., in which display portion 200-1 is not parallel to base portion 200-2 and the area in which content is displayed by device 200 is visible and/or not obscured). It should be recognized that display portion 200-1 being parallel to base portion 200-2 is an example of a position corresponding to an “OFF” internal state (e.g., a closed position) of device 200. In some embodiments, another configuration could set another orientation of display portion 200-1 with respect to base portion 200-2 as the closed position of device 200, such as illustrated in FIG. 2C.

FIG. 2A illustrates display screen 200-4 (representing the area in which content is displayed by device 200) on the left and device 200 in a corresponding pose on the right. As illustrated in FIG. 2A, device 200 is in a first position (e.g., display portion 200-1 is perpendicular to base portion 200-2 forming a 90-degree angle). In FIG. 2A, display screen 200-4 represents what is currently being displayed (e.g., via a display component) by device 200 while open in the first position. In FIG. 2A, display screen 200-4 illustrates an internal state in which device 200 is “ON” (e.g., operational, powered on, awake, a higher powered and/or more resource intensive state than the “OFF” state, and/or activated). In some embodiments, device 200 displays (e.g., via display screen 200-4) one or more user interfaces (e.g., user interface objects, windows, application user interfaces, system user interfaces, controls, and/or other visual content). In some embodiments, device 200 displays (e.g., via display screen 200-4) the one or more user interfaces while in the “ON” internal state. For example, in FIG. 2A, device 200 is in the “ON” internal state and display screen 200-4 displays a desktop user interface 200-5 that includes an application window. In some embodiments, a user interface includes (and/or is) one or more user interface objects (e.g., windows, icons, and/or other graphical objects). For example, a user interface (e.g., 200-5) can include one or more graphical objects different than, and/or the same as, an application window.

FIG. 2B illustrates display screen 200-4 on the left and device 200 in a corresponding pose on the right. As illustrated in FIG. 2B, device 200 is in a second position (e.g., display portion 200-1 is angled (e.g., via connection 200-3) with respect to base portion 200-2 forming at a 120-degree angle (e.g., a larger angle than in FIG. 2A)). In FIG. 2B, display screen 200-4 represents what is being displayed by device 200 while in the second position. Display screen 200-4 illustrates an internal state in which device 200 is “ON” (e.g., the same internal state as the top diagram of FIG. 2A). In FIG. 2B, device 200 displays (e.g., via display screen 200-4) desktop user interface 200-5 (e.g., and is the same as displayed in FIG. 2A). In some embodiments, device 200 displays a different user interface (e.g., other than desktop user interface 200-5). For example, although FIG. 2B illustrates device 200 displaying the same desktop user interface 200-5 as in FIG. 2A while in a different position than in FIG. 2A, device 200 can display a different user interface. In some embodiments, device 200 displays a user interface that corresponds to (e.g., is based on, due to, caused by, related to, and/or configured to accompany) a physical state (e.g., position, location, and/or orientation), including content that is specific to a particular angle or specific to a current context.

FIG. 2C illustrates display screen 200-4 on the left and device 200 in a corresponding pose on the right. As illustrated in FIG. 2C, device 200 is in a third position (e.g., display portion 200-1 is angled (e.g., via connection 200-3) with respect to base portion 200-2 forming at a 60-degree angle (e.g., a smaller angle than in FIG. 2A and FIG. 2B)). In FIG. 2C, display screen 200-4 represents what is being displayed by device 200 while in the third position. In FIG. 2C, display screen 200-4 illustrates an internal state in which device 200 is “OFF” (e.g., not operational, not powered on, not awake, not activated, powered off, asleep, hibernating, inactive, and/or deactivated). In some embodiments, device 200 does not display (e.g., via display screen 200-4) (e.g., forgoes displaying) the one or more user interfaces while in the “OFF” internal state (e.g., does not display any visual content). In some embodiments, device 200 displays (e.g., via display screen 200-4) one or more user interfaces while in the “OFF” internal state (e.g., the same and/or different from one or more user interfaces displayed while in the “ON” internal state) (e.g., a user interface specific to the “OFF” state and/or a manner of displaying a user interface that is not specific to the “OFF” internal state). In FIG. 2C, display screen 200-4 is blank because nothing is being displayed on the display of device 200 (e.g., display screen 200-4 is off and/or not displaying a user interface) (e.g., desktop user interface 200-5 is not displayed on display screen 200-4).

In some embodiments, device 200 includes one or more components (also referred to herein as “movement components”) that enable device 200 to perform (e.g., cause and/or control) movement (and/or be moved). For example, performing movement can include moving a portion of device 200 (e.g., less than or all components of the device move), moving all of device 200 (e.g., the entire device (including all of its components) moves, such as by changing location), and/or moving one or more other devices and/or components (e.g., that are in communication with device 200 and/or movement components of device 200). For example, device 200 can automatically move (e.g., pivot), cause, and/or control movement of display portion 200-1 relative to base portion 200-2, such as to any of the positions illustrated in FIGS. 2A-2C. In some embodiments, device 200 performs movement based on an internal state of device 200. Performing movement based on an internal state can enable new (e.g., otherwise unavailable) interactions by device 200. For example, such new interactions of device 200 can be configured using special features, functions, modes, and/or programs that take advantage of the ability of device 200 to perform movement. Examples of such interaction include using movement to communicate (e.g., to a user) an internal state (e.g., on, off, sleeping, and/or hibernating) of the device, to assist with user input (e.g., reduce distance to a user), and/or to augment interaction behavior of the device (e.g., moving in particular ways, during an interaction with a user, that convey information such as importance and/or direction of attention). In some embodiments, the movement performed corresponds to (e.g., is caused by, is in response to, and/or is determined and/or performed based on) one or more of: detected input, detected context (e.g., environmental context and/or user context), and/or an internal state of device 200 (e.g., an internal state and/or a set of multiple internal states). For example, device 200 can perform a movement of the display portion such that device 200 moves from being in the first position illustrated in FIG. 2A to being in the second position illustrated in FIG. 2B. In this example, device 200 can detect that a user has repositioned with respect to device 200 (e.g., the user stood up), and in response, device 200 can perform the movement to the second position so that the display is at an optimized viewing angle based on the repositioned height and/or angle of the user's eyes with respect to the display of device 200. As another example, device 200 can perform a movement such that device 200 moves from being in the first position illustrated in FIG. 2A to being in the third position illustrated in FIG. 2C. In this example, device 200 can perform the movement to the third position in response to detecting an internal state with reduced activity (e.g., the “OFF” internal state as described above). In this way, the movement of device 200 to one or more positions can indicate an internal state of device 200.

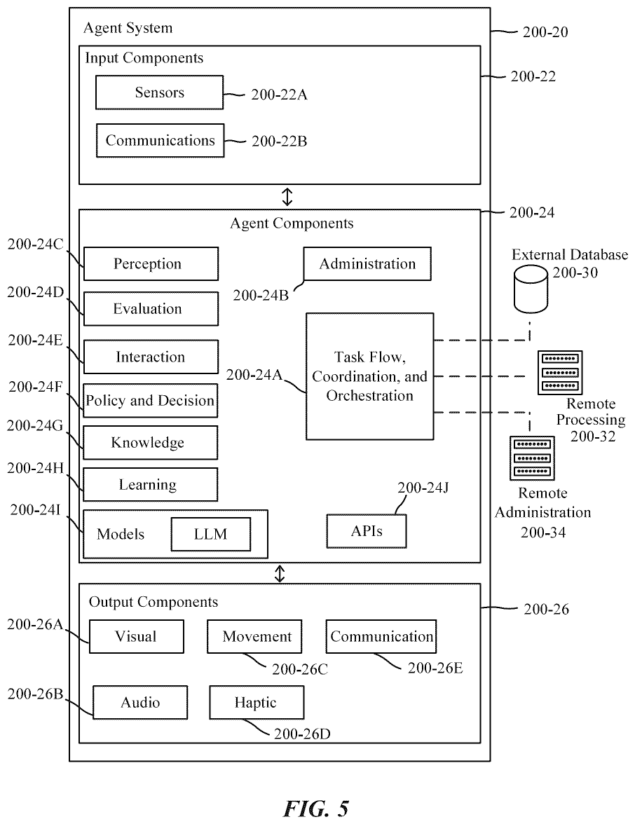

FIGS. 2A-2C illustrate device 200 having a display portion that is able to move with one degree of freedom via connection 200-3 (e.g., a hinge) connecting display portion 200-1 to base portion 200-2. In some embodiments, device 200 includes one or more components that have one or more degrees of freedom. For example, a movement component (e.g., an output component that causes and/or allows movement) (e.g., 200-26C of FIG. 5) of device 200 can include multiple degrees of freedom (e.g., six degrees of freedom including three components of translation and three components of rotation). For example, device 200 can be implemented to be able to move the display portion in a telescoping forward or backward motion (e.g., display portion 200-1 moves forward while base portion 200-2 remains stationary in space relative to the base portion (e.g., to reduce and/or extend viewing distance for a user)). As yet another example, device 200 can be implemented to be able to move the display portion to rotate about an axis that is perpendicular to the hinge such that the display portion can turn to position the display to follow a user as they walk around device 200. While the examples shown in FIGS. 2A-2C illustrate a hinge, other movement components can be included in device 200, such as an actuator (e.g., a pneumatic actuator, hydraulic actuator and/or an electric actuator), a movable base, a rotatable component, and/or a rotatable base. In some embodiments, one or more movement components can cause device 200 to move in different ways, such as to rotate (e.g., 0-360 degrees), to move laterally (e.g., right, left, down, up, and/or any combination thereof), and/or to tilt (e.g., 0-360 degrees).

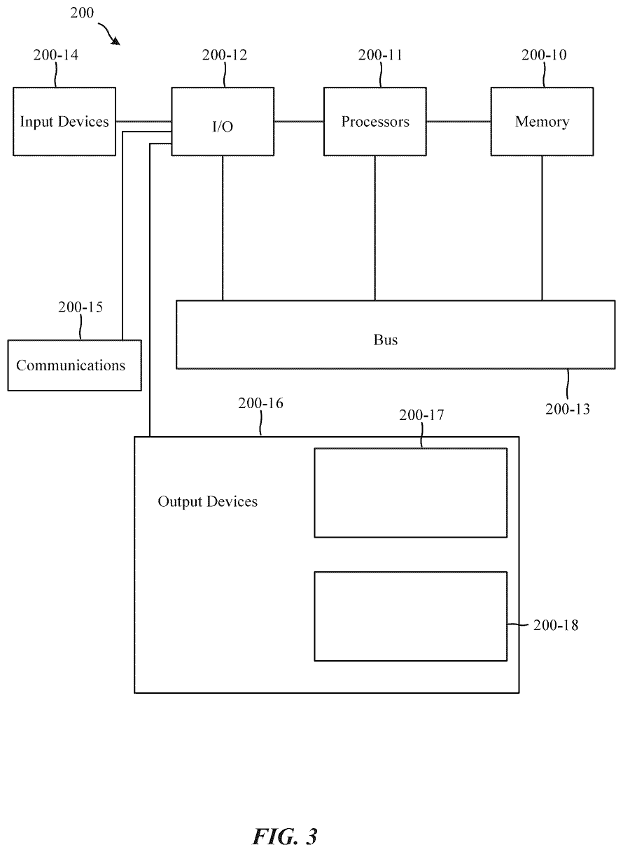

FIG. 3 illustrates exemplary block diagram of device 200. In some embodiments, device 200 includes some or all of the components described with respect to FIGS. 1A, 1B, 3, and 5B. As illustrated in FIG. 3, device 200 has bus 200-13 that operatively couples I/O section 200-12 (also referred to as an I/O subsection and/or an I/O interface) with processors 200-11 and memory 200-10. As illustrated in FIG. 3, I/O section 200-12 is connected to output devices 200-16 (also referred to herein as “output components”). In some embodiments, output devices 200-16 include one or more visual output devices (e.g., a display component, such as a display, a display screen, a projector, and/or a touch-sensitive display), one or more haptic output devices (e.g., a device that causes vibration and/or other tactile output), one or more audio output devices (e.g., a speaker), and/or one or more movement components (e.g., an actuator, a motor, a mechanical linkage, devices that cause and/or allow movement, and/or one or more movement components as described above). As illustrated in FIG. 3, output devices 200-16 include two exemplary movement components (e.g., movement controller 200-17 and actuator 200-18). Actuator 200-18 can be any component that performs physical movement (e.g., of a portion and/or of the entirety) of a device (e.g., device 200 and/or a device coupled to and/or in contact with device 200). Movement controller 200-17 can be any component (e.g., a control device) that controls (e.g., provides control signals to) actuator 200-18. For example, movement controller 200-17 can provide control signals that cause actuator 200-18 to actuate (e.g., cause physical movement). In some embodiments, movement controller 200-17 includes one or more logic component (e.g., a processor), one or more feedback component (e.g., sensor), and/or one or more control components (e.g., for applying control signals, such as a relay, a switch, and/or a control line). In some embodiments, movement controller 200-17 and actuator 200-18 are embodied in the same device and/or component as each other (e.g., a dedicated onboard movement controller 200-17 that is affixed to actuator 200-18). In some embodiments, movement controller 200-17 and actuator 200-18 are embodied in different devices and/or components from each other (e.g., one or more processors 200-11 can function as the movement controller 200-17 of actuator 200-18). In some embodiments, movement controller 200-17 and/or actuator 200-18 are embodied in a device (or one or more devices) other than device 200 (e.g., device 200 is coupled to (e.g., temporarily and/or removably) another device and can instruct movement controller 200-17 and/or control actuator 200-18 of the other device). Actuator 200-18 can function to cause one or more types of mechanical movement (e.g., linear and/or rotational) in one or more manners (e.g., using electric, magnetic, hydraulic, and/or pneumatic power). Examples of actuator 200-18 can include electromechanical actuators, linear actuators, and/or rotary actuators.

As illustrated in FIG. 3, I/O section 200-12 is connected to input devices 200-14. In some embodiments, input devices 200-14 include one or more visual input devices (e.g., a camera and/or a light sensor), one or more physical input devices (e.g., a button, a slider, a switch, a touch-sensitive surface, and/or a rotatable input mechanism), one or more audio input devices (e.g., a microphone), and/or other input devices (e.g., accelerometer, a pressure sensor (e.g., contact intensity sensor), a ranging sensor, a temperature sensor, a GPS sensor, an accelerometer, a directional sensor (e.g., compass), a gyroscope, a motion sensor, and/or a biometric sensor). In addition, I/O section 200-12 can be connected with communication unit 200-15 for receiving application and operating system data, using Wi-Fi, Bluetooth, near field communication (NFC), cellular, and/or other wireless (and/or wired) communication techniques.

Memory 200-10 of personal device 200 can include one or more non-transitory computer-readable storage mediums, for storing computer-executable instructions, which, when executed by one or more computer processors 200-11, for example, cause the computer processors to perform the techniques described below, including processes 700, 900, 1000, 1100, 1300, 1500, 1700, and/or 1800 (FIGS. 7, 9, 10, 11, 13, 15, 17, and/or 18). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, and Blu-ray technologies, as well as persistent solid-state memory such as flash and solid-state drives. Device 200 is not limited to the components and configuration of FIG. 3, but can include other and/or additional components in a multitude of possible configurations, all of which are intended to be within the scope of this disclosure.

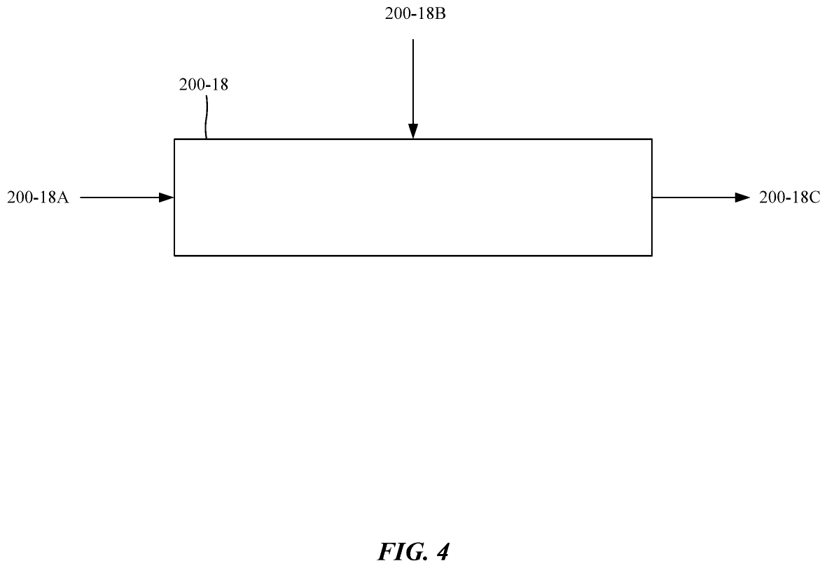

FIG. 4 illustrates a functional diagram of actuator 200-18B in accordance with some embodiments. As described above, actuator 200-18B can be any component that performs physical movement. In some embodiments, actuator 200-18B operates using input that includes control signal 200-18A and/or energy source 200-18B. For example, actuator 200-18 can be a rotary actuator that converts electric energy into rotational movement. This rotational movement can cause the movement of the display portion of device 200 described above with respect to FIGS. 2A-2C (e.g., a counterclockwise rotational movement of the actuator causes device 200 to move to a position having a larger angle (e.g., the second position illustrated in FIG. 2B) and a clockwise (e.g., opposite) rotational movement of the actuator causes device 200 to move to a position having a smaller angle (e.g., the third position illustrated in FIG. 2C)). Control signal 200-18A can indicate one or more start and/or stop instructions, a movement and/or actuation direction, a movement and/or actuation speed, an amount of time to move and/or actuate, a goal position (e.g., pose and/or location) for movement and/or actuation, and/or one or more other characteristics of movement and/or actuation. In some embodiments, the control signal and the energy source are the same signal and/or input. In some embodiments, one or more additional components (e.g., mechanical and/or electric) are coupled (e.g., removably or permanently) to actuator 200-18B for affecting movement and/or actuation (e.g., mechanical linkage such as a lead screw, gears, and/or other component for changing (e.g., converting) a characteristic of movement and/or actuation). In some embodiments, actuator 200-18B includes one or more feedback components (e.g., position sensor, encoder, overcurrent sensor, and/or force sensor) that form part of a feedback loop for modifying and/or ceasing movement and/or actuation (e.g., slowing actuation as a goal position is reached and/or ceasing actuation if physical resistance to actuation is detected via a sensor). In some embodiments, the one or more feedback components are included (e.g., partially and/or wholly) in a movement controller (e.g., movement controller 200-13) operatively coupled to the actuator.

Attention is now turned to functionality (e.g., features and/or capabilities) of one or more devices (e.g., computer system 100 and/or device 200). One such functionality is implementing an “agent,” which can alternatively be referred to as a software agent, an intelligent agent, an interactive agent, a virtual assistant, an intelligent virtual assistant, an interactive virtual assistant, a personal assistant, an intelligent personal assistant, an interactive personal assistant, an intelligent interactive personal assistant, and/or an artificial intelligence (AI) assistant. In some embodiments, an agent refers to a set of one or more functions implemented in hardware and/or software (e.g., locally and/or remotely) on an agent system (e.g., a single device and/or multiple devices). In some embodiments, an agent performs operations to perceive an environment, acquire knowledge, retrieve knowledge, learn skills, interact with users, and/or perform tasks. The agent can, for example, perform these (and/or other) operations in response to user input and/or automatically (e.g., at an appropriate time determined based on a perceived context). A non-exhaustive list of exemplary operations that an agent can be used for and/or with includes: tracking a user's eyes, face, and/or body (e.g., to move with the user and/or identify an intent and/or activity of the user); detecting, recognizing, and/or classifying a user in the environment; detecting and/or responding to input (e.g., verbal input, air gestures, and/or physical input, such as touch input and/or force inputs to physical hardware components (e.g., button, knobs, and/or sliders)); detecting context (e.g., user context, operating context, and/or environmental context); moving (e.g., changing pose, position, orientation, and/or location); performing one or more operations in response to input, context, and/or stimulus (e.g., an object or event (e.g., external and/or internal to a device) that causes one or more responsive operations by a device); providing intelligent interaction capabilities (e.g., due to in part to one or more machine learning (“ML”) models such as a large language model (“LLM”)) for responding and/or causing operations to be performed; and/or performing tasks (e.g., a set of operations for achieving a particular goal) (e.g., automatically and/or intelligently). In some embodiments, an agent performs operations in response to non-contact inputs (e.g., air gestures and/or natural language commands). The preceding list is meant to be illustrative of operations that can be performed using an agent but is not meant to be an exhaustive list. Other operations fall within the intended scope of the capabilities of an agent. Additionally, for the purposes of this disclosure, an agent does not need to include all of the functionality mentioned herein but can include less functionality or more functionality (e.g., an agent can be implemented on an agent system that does not have movement functionality but that otherwise includes an intelligent personal assistant that can interact with a user).

In some embodiments, a user is (e.g., represents, includes, and/or is included in) one or more of a subject, person, object, and/or animal in an environment (e.g., a physical and/or virtual environment) (e.g., of the device). In some embodiments, a user is (e.g., represents, includes, and/or is included in) an entity that is perceived (e.g., detected by the device, one or more other devices, and/or one or more components thereof). In some embodiments, an entity is something that is distinguished from surrounding entities (e.g., pieces of environments and/or other users) and/or that is considered as a discrete logical construct via one or more components (e.g., perception components and/or other components). In some embodiments, a user is physical and/or virtual. For example, a physical user can represent a user standing in front of, and being perceived by, the device. As another example, a virtual user can represent an avatar in a virtual scene perceived by the device (e.g., the avatar is detected in a media stream received by the device and/or captured by a camera of the device). Although presented above as examples of a “user,” the terms and/or concepts referred to as “person,” “object,” and/or “animal” can be interchanged with “user” throughout this disclosure, unless explicitly indicated otherwise. For example, use the term “subject” can likewise be understood to also refer to “user,” unless explicitly indicated otherwise.

As an example, and referring back to FIGS. 2A-2C, an agent implemented at least partially on device 200 can perform operations that cause display portion 200-1 of device 200 to move with respect to base portion 200-2. For example, the agent detects (e.g., perceives and determines the occurrence of) a context that includes the user standing up (e.g., based on facial detection and tracking); and, in response, the agent causes device 200 to open and/or device 200 opens display portion 200-1 to the larger angle. As another example, the agent can detect verbal input that corresponds to (e.g., is interpreted as and/or that refers to an operation that includes) a request to move the display (e.g., “Please move my display,” or “Please enter sleep mode.”); and, in response, the agent causes device 200 to move and/or device 200 moves display portion 200-1.

FIG. 5 illustrates a functional diagram of an exemplary agent system 200-20A. As illustrated in FIG. 5, agent system 200-20A has a dotted box boundary that encloses input components 200-22, agent components 200-24, and output components 200-26. In some embodiments, agent system 200-20A includes fewer, more, and/or different components than illustrated in FIG. 5. In some embodiments, agent system 200-20 is implemented on a single device (e.g., computer system 100 and/or device 200). In some embodiments, agent system 200-20 is implemented on multiple devices. In some embodiments, one or more components of agent system 200-20 illustrated in and/or described with respect to FIG. 5 are external to but operatively coupled to agent system 200-20 (e.g., an accessory, an external device, an external sensor, an external actuator, an external display component, an external speaker, and/or an external database). In some embodiments, one or more components of agent system 200-20 are local to one or more other components of agent system 200-20. In some embodiments, one or more components of agent system 200-20 are remote from one or more other components of agent system 200-20.

In some embodiments, input components 200-22 includes components for performing sensing and/or communications functions of agent system 200-20. As illustrated in FIG. 5, input components 200-22 includes one or more sensors 200-22A. One or more sensors 200-22A can include any component that functions to detect data corresponding to a physical environment. Examples of one or more sensors 200-22A can include: a camera, a light sensor, a microphone, an accelerometer, a position sensor, a pressure sensor, a temperature sensor, olfactory sensor, and/or a contact sensor. This list is not intended to be exhaustive, and one or more sensors 200-22A can include other sensors not explicitly identified herein that detect, generate, and/or otherwise provide data that can be used (e.g., processed, stored, and/or transformed) for detecting data corresponding to a physical environment. As illustrated in FIG. 5, input components 200-22 includes one or more communications components 200-22B. One or more communications components 200-22B can include any component that functions to send and/or receive communications (e.g., an antenna, a modem, a network interface component, an encoder, a decoder, and/or a communication protocol stack) internal and/or external to agent system 200-20. Communications components 200-22B can be between different devices and/or between components of the same device. The communications can include control signals and/or data (e.g., messages, instructions, files, application data, and/or media streams). In some embodiments, input components 200-22 includes fewer, more, and/or different components than those illustrated in FIG. 5. In some embodiments, input components 200-22 is implemented in hardware and/or software.

In some embodiments, agent components 200-24 includes components that manage and/or carry out functions of an agent of agent system 200-20. As illustrated in FIG. 5, agent components 200-24 includes the following functional components: task flow, coordination, and/or orchestration component 200-24A, administration component 200-24B, perception component 200-24C, evaluation component 200-24D, interaction component 200-24E, policy and decision component 200-24F, knowledge component 200-24G, learning component 200-24H, models component 200-24I, and APIs component 200-24J. Each of these components is described briefly below. Notably, this list of agent components 200-24 is not intended to be exhaustive, and agent components 200-24 can include other functional components not explicitly identified herein that can be used (e.g., processed, stored, and/or transformed) for performing any function of an agent, such as those described herein. In some embodiments, agent components 200-24 includes fewer, more, and/or different components than those illustrated in FIG. 5. In some embodiments, agent components 200-24 is implemented in hardware and/or software.

In some embodiments, task flow, coordination, and/or orchestration component 200-24A performs operations that enable an agent to handle coordination between various components. For example, operations can include handling a data processing task flow to move from perception component 200-24C (e.g., that detects speech input) to models component 200-24I (e.g., for processing the detected speech input using a large language model to determine content and/or intent of the speech input). In some embodiments, task flow, coordination, and/or orchestration component 200-24A performs operations that enable an agent to handle coordination between one or more external components (e.g., resources). For example, FIG. 5 illustrates examples of external components, such as external database 200-30. In some embodiments, administration component 200-24B includes functionality performed by an operating system of a device implementing agent system 200-20. In some embodiments, administration component 200-24B includes functionality performed by one or more applications of a device implementing agent system 200-20.

In some embodiments, administration component 200-24B performs operations that enable an agent system to handle administrative tasks like managing system and/or component updates, managing user accounts, managing system settings, and/or managing component settings. In some embodiments, administration component 200-24B includes functionality performed by an operating system of a device implementing agent system 200-20. In some embodiments, administration component 200-24B includes functionality performed by one or more applications of a device implementing agent system 200-20.

In some embodiments, perception component 200-24C performs operations that enable an agent to perceive environmental input. For example, operations can include detecting that a context and/or environmental condition has occurred, detecting the presence of a user (e.g., subject, person, object, and/or animal in an environment), detecting an input that includes speech, detecting an input that includes an air gesture, detecting facial expressions, detecting characteristics (e.g., visible and/or non-visible) of a user, and/or detecting verbal and/or physical cues. In some embodiments, perception component 200-24C includes functionality performed by an operating system of a device implementing agent system 200-20. In some embodiments, perception component 200-24C includes functionality performed by one or more applications of a device implementing agent system 200-20.

In some embodiments, evaluation component 200-24D performs operations that enable an agent to process evaluate data (e.g., to determine a context such as a user context, an environmental context, and/or an operating context). For example, operations can include evaluating data gathered from perception component 200-24C, knowledge component 200-24G, external database 200-30, and/or remote processing resource 200-32. In some embodiments, evaluation component 200-24D includes functionality performed by an operating system of a device implementing agent system 200-20. In some embodiments, evaluation component 200-24D includes functionality performed by one or more applications of a device implementing agent system 200-20.

Reference is made herein to environmental context (also referred to herein as a “context of an environment” and/or “a context corresponding to an environment”). In some embodiments, an environmental context is a context based on one or more characteristics of the environment (e.g., users, locations, time, weather, and/or lighting). For example, an environmental context can include that it is raining outside, that it is daytime, and/or that a device is currently located in a park. In some embodiments, a device (e.g., using an agent) determines an environmental context (e.g., to be currently true, occurring, and/or applicable) using one or more of detecting input (e.g., via one or more input components) and/or receiving data (e.g., from one or more other devices and/or components in communication with the device).

Reference is made herein to user context (also referred to herein as a “context of a user” and/or “a context corresponding to a user”) (and/or a user context). In some embodiments, a user context is a context based on one or more characteristics of the user (and/or a user). For example, a user context can include the user's appearance and/or clothing, personality, actions, behavior, movement, location, and/or pose. In some embodiments, a device (e.g., using an agent) determines a user context (e.g., to be currently true, occurring, and/or applicable) using one or more of detecting input (e.g., via one or more input components) and/or receiving data (e.g., from one or more other devices and/or components in communication with the device). In some embodiments, a device determines user context based on historical context and/or learned characteristics of the user, where one or more characteristics of the user are learned and/or stored over a period of time by the device.

Reference is made herein to operational context (also referred to herein as a “context of operation” and/or an “operating context”). In some embodiments, an operational context is a context based on one or more characteristics of the operation of a device (e.g., the device determining and/or accessing the operational context and/or one or more other devices). For example, an operational context can include the internal state of the device (and/or of one or more components of the device), an internal dialogue of the device (e.g., the device's understanding of a context), operations being performed by the device, applications and/processes that are executing (e.g., running and/or open) on the device. In some embodiments, a device (e.g., using an agent) determines an operational context (e.g., to be currently true, occurring, and/or applicable) using one or more of detecting input (e.g., via one or more input components) and/or receiving data (e.g., from one or more other devices and/or components in communication with the device). In some embodiments, a device (e.g., using an agent) determines an operational context (e.g., to be currently true, occurring, and/or applicable) using one or more internal states (e.g., accessed, retrieved, and/or queried by a process of the device).

In some embodiments, interaction component 200-24E performs operations that enable an agent to manage and/or perform interactions with users. For example, operations can include determining an appropriate interaction model for a particular context and/or in response to a particular input. In some embodiments, interaction component 200-24E includes functionality performed by an operating system of a device implementing agent system 200-20. In some embodiments, interaction component 200-24E includes functionality performed by one or more applications of a device implementing agent system 200-20.

In some embodiments, policy and decision component 200-24F performs operations that enable an agent to take actions in view of available data. For example, operations can include determining which operations to perform and/or which functional components to utilize in response to a detected context. In some embodiments, policy and decision component 200-24F includes functionality performed by an operating system of a device implementing agent system 200-20. In some embodiments, policy and decision component 200-24F includes functionality performed by one or more applications of a device implementing agent system 200-20.

In some embodiments, knowledge component 200-24G performs operations that enable an agent to access and use stored knowledge. For example, operations can include indexing, storing, and/or retrieving data from a data store, a database, and/or other resource. In some embodiments, knowledge component 200-24G includes functionality performed by an operating system of a device implementing agent system 200-20. In some embodiments, knowledge component 200-24G includes functionality performed by one or more applications of a device implementing agent system 200-20.

In some embodiments, learning component 200-24H performs operations that enable an agent to learn through experiences. For example, operations can include observing and/or keeping track of data that includes preferences, routines, user characteristics, and/or environmental characteristics in a manner in which such data can be used to inform future operation by the agent and/or a component thereof (e.g., such as when performing tasks and/or interactions with users). In some embodiments, learning component 200-24H includes functionality performed by an operating system of a device implementing agent system 200-20. In some embodiments, learning component 200-24H includes functionality performed by one or more applications of a device implementing agent system 200-20.

In some embodiments, models component 200-24I performs operations that enable an agent to apply ML models (e.g., such as a large language model (LLM)) to process data. For example, operations can include storing ML models, executing ML models, training and/or re-training ML models, and/or otherwise managing aspects of implementing ML models. In some embodiments, models component 200-24I includes functionality performed by an operating system of a device implementing agent system 200-20. In some embodiments, models component 200-24I includes functionality performed by one or more applications of a device implementing agent system 200-20.

In some embodiments, agent system 200-20 responds to natural language input. For example, agent system 200-20 responds to a natural language input that is in the form of a statement, a question, a command, and/or a request. In some embodiments, agent system 200-20 outputs text and/or speech output that is provided in a natural language or mimicking a natural language style. For example, agent system 200-20 can process the natural language question “How hot is it outside?” with a speech response that indicates the current temperature outside at the user's location (e.g., “It is 18 degrees outside.”). In some embodiments, agent system 200-20 responds to natural language input by providing information (e.g., weather, travel, and/or calendar information) and/or performing a task (e.g., opening a document, searching a database, and/or opening an application).

In some embodiments, agent system 200-20 includes and/or relies on one or more data models to process input (e.g., natural language input, gesture input, visual input, and/or other data input) and/or provide output (e.g., output of information via natural language output, visual output, audio output, and/or textual output). Such data models can include and/or be trained using user data (e.g., based on particular interactions and/or data from the user being interacted with) and/or global data (e.g., general data based on interactions and/or data from many users). For example, user data (e.g., preferences, previous use of language and/or phrases, calendar entries, a contact list, and/or activity data) can be used to better infer user intent and/or provide responses that are more likely to address a user's request. In some embodiments, data models used by agent system 200-20 include, are used by, and/or are implemented using one or more machine learning components (e.g., hardware and/or software) (e.g., one or more neural networks). Such machine learning components can be used to process verbal input to determine words and/or phrases therein, one or more contexts that correspond to the words, a user intent corresponding to the words, one or more confidence scores, and/or a set of one or more actions to take in response to the verbal input. Analogous operations can be performed to process other types of inputs, such as visual input, data input, and/or textual input. Such data models can include machine learning and/or data processing models, including, but not limited to, natural language processing models, language models, speech recognition models, object recognition models, visual processing models, ontologies, task flow models, and/or intent recognition models (e.g., used to determine user intent).

In some embodiments, Application Programming Interfaces (APIs) component 200-24J performs operations that enable an agent to interface with services, devices, and/or components. For example, operations can include relaying data (e.g., requests, responses, and/or other messages) between data interfaces (e.g., between software programs, between a system process and application process, between system processes, between application processes, between communication protocols, between a client and a server, between file systems, and/or between components on different sides of a trust boundary). In some embodiments, the data interfaces served by APIs component 200-24J are local (e.g., to the device, such as two application processes exchanging data) and/or remote (e.g., from the device, such as interfacing with a web service via a remote server). In some embodiments, APIs component 200-24J includes functionality performed by an operating system of a device implementing agent system 200-20. In some embodiments, APIs component 200-24J includes functionality performed by one or more applications of a device implementing agent system 200-20.

In some embodiments, output components 200-26 includes components for performing output functions of agent system 200-20. The exemplary output components illustrated in FIG. 5 are described briefly below. In some embodiments, output components 200-26 include fewer components, more, and/or different components than those illustrated in FIG. 5. In some embodiments, input components are implemented in hardware and/or software.

As illustrated in FIG. 5, output components 200-26 includes one or more visual output components 200-26A. One or more visual output components 200-26A can include any component that functions to output (e.g., generate, create, and/or display), and/or cause output of, a visual output (e.g., an output that is visually perceptible, such as graphical user interface, playback of visual media content, and/or lighting). Examples of one or more visual output components 200-26A can include: a display component, a projector, a head mounted display (HMD), a light-emitting diode (“LED”), and/or a component that creates visually perceptible effects (e.g., movement). This list is not intended to be exhaustive, and one or more visual output components 200-26A can include other visual output components not explicitly identified herein that detect, generate, and/or otherwise provide data that can be used (e.g., processed, stored, and/or transformed) for outputting visual output.

As illustrated in FIG. 5, output components 200-26 include one or more audio output components 200-26B. One or more audio output components 200-26B can include any component that functions to output (e.g., generate and/or create), and/or cause output of, an audio output (e.g., an output that is audibly perceptible, such as a sound, music, speech, and/or audio media content). Examples of one or more audio output components 200-26B can include: a speaker, an audio amplifier, a tone generator, and/or a component that creates audibly perceptible effects (e.g., movement such as vibrations). This list is not intended to be exhaustive, and one or more audio output components 200-26B can include other audio output components not explicitly identified herein that detect, generate, and/or otherwise provide data that can be used (e.g., processed, stored, and/or transformed) for outputting audio output.

As illustrated in FIG. 5, output components 200-26 include one or more movement output components 200-26C (also referred to herein as a “movement component”). One or more movement output components 200-26C can include any component that functions to output (e.g., generate and/or create), and/or cause output of, a movement output (e.g., an output that includes physical movement of the device and/or another device/component). Examples of one or more movement output components 200-26C can include: a movement controller, an actuator, a mechanical linkage, an electromechanical device, and/or a component that creates physical movement. This list is not intended to be exhaustive, and one or more movement output components 200-26C can include other movement output components not explicitly identified herein that detect, generate, and/or otherwise provide data that can be used (e.g., processed, stored, and/or transformed) for outputting movement output. As illustrated in FIG. 5, output components 200-26 include one or more haptic output components 200-26D. One or more haptic output components 200-26D can include any component that functions to output (e.g., generate, create, and/or display), and/or cause output of, a haptic output (e.g., an output that is physically perceptible using tactile sensation, such as a vibration, pressure, texture, and/or shape). Examples of one or more haptic output components 200-26D can include: a speaker, a component that generates vibrations, a component that generates texture changes, a component that generates pressure changes, and/or a component that creates perceivable tactile effects. This list is not intended to be exhaustive, and one or more haptic output components 200-26D can include other haptic output components not explicitly identified herein that detect, generate, and/or otherwise provide data that can be used (e.g., processed, stored, and/or transformed) for outputting haptic output.

As illustrated in FIG. 5, output components 200-26 include one or more communications components 200-26E. One or more communications components 200-26E can include any component that functions to send and/or receive communications (e.g., an antenna, a modem, a network interface component, an encoder, a decoder, and/or a communication protocol stack) internal and/or external to agent system 200-20. In some embodiments, the communications can be between different devices and/or between components of the same device. In some embodiments, the communications can include control signals and/or data (e.g., messages, instructions, files, application data, and/or media streams). In some embodiments, one or more communications components 200-26E includes one or more features of one or more communications components 200-22B (e.g., as described above). In some embodiments, one or more communications components 200-26E are the same as one or more communications components 200-22B (e.g., one or more components that handle communication inputs and outputs and thus be considered as either and/or both an input component and an output component).

Throughout this disclosure, reference can be made to movement output (e.g., referred to in various forms such as: movement, device movement, output of movement, device motion, output of motion, and/or motion output). In some embodiments, outputting (e.g., causing output of) movement refers to movement of an electronic device (e.g., a portion or component thereof relative to another portion and/or of the whole electronic device). For example, referring back to FIG. 2B, movement output can refer to device 200 actuating movement component 200-3 to move display portion 200-1 to the position illustrated in FIG. 2B (e.g., from the position in FIG. 2A). In some embodiments, movement output is not (e.g., does not include and/or does not only include) haptic output (e.g., haptic movement output). In some embodiments, movement output is not (e.g., does not include and/or does not only include) vibration output. In some embodiments, movement output is not (e.g., does not include and/or does not only include) oscillating movement (e.g., movement of an actuator that merely causes vibration by moving a component repeatedly along a path that is internal to the device). In some embodiments, movement output includes (e.g., requires and/or results in) changing a location and/or pose of at least a portion of (and/or the entirety of) a component or the electronic device. In some embodiments, movement output includes output that moves at least a portion of (and/or the entirety of) a component or the electronic device from a first location and/or first pose to a second location and/or second pose. For example, with respect to FIGS. 2A-2C, display portion 200-1 is shown in a different location (e.g., in space) and pose (e.g., relative to base portion 200-2) in each of FIGS. 2A, 2B, and 2C. In some embodiments, movement output includes output that moves at least a portion (and/or the entirety of) a component or the electronic device to a third location and/or third pose (e.g., from the first location and/or first pose and/or from the second location and/or the second pose). In some embodiments, the third location and/or the third pose is the same as the first location and/or first pose and/or as the second location and/or the second pose. For example, movement output can include device 200 in FIG. 2A beginning from the first position illustrated in FIG. 2A, moving to the second position illustrated in FIG. 2B, and moving to return to the first position illustrated in FIG. 2A. For example, movement output can include device 200 in FIG. 2A beginning from the first position illustrated in FIG. 2A, moving to the second position illustrated in FIG. 2B, and continuing movement to come to rest at the third position illustrated in FIG. 2C.

Throughout this disclosure, an electronic device can be illustrated in (and/or described as being in) different locations and/or poses at different times. For example, in FIG. 2A illustrates device 200 in the first position, FIG. 2B illustrates device 200 in the second position, and FIG. 2A illustrates device 200 in the third position. In some embodiments, the electronic device moves itself between such locations and/or poses (e.g., using movement output). For example, device 200 moves from the first position to the second position under its own power (e.g., using a power source and one or more actuators to cause movement). In particular, any example herein that illustrates and/or describes an electronic device being at different locations and/or poses (e.g., at different times) should be understood to cover a scenario in which the device moved itself between such locations and/or poses (e.g., unless otherwise clearly indicated).

Throughout this disclosure, reference can be made to “performing output,” “causing output,” and/or “outputting” (e.g., by one or more output generation devices and/or by one or more output generation components) (and/or similar such phrases). In some embodiments, outputting (e.g., or the aforementioned variants) includes (and/or is) outputting movement (e.g., movement output as described above).

Throughout this disclosure, reference can be made to “displaying,” “causing display of,” and/or “outputting visual content” (e.g., by one or more display components) (and/or similar such phrases). In some embodiments, displaying (e.g., or the aforementioned variants) includes displaying visual content in connection with outputting movement (e.g., movement output as described above).

Throughout this disclosure, reference can be made to “outputting audio,” “causing output of audio,” and/or “providing audio output” (e.g., by one or more audio generation components and/or by one or more audio output devices) (and/or similar such phrases). In some embodiments, outputting audio (e.g., or the aforementioned variants) includes outputting audio content in connection with outputting movement (e.g., movement output as described above).

Throughout this disclosure, reference can be made to movement of an avatar (e.g., or other representation of a user, an agent and/or a character that is displayed) (e.g., by one or more display components) (and/or similar such phrases). In some embodiments, moving an avatar (e.g., or the aforementioned variants) includes displaying movement of visual content in connection with outputting movement (e.g., movement output as described above). For example, displaying an avatar nodding in agreement can include movement of the electronic device in a similar manner as the avatar movement (e.g., mimicking nodding). In some embodiments, moving an avatar (e.g., or the aforementioned variants) includes outputting movement (e.g., movement output as described above) without displaying movement of visual content. For example, a device can perform movement output that mimics nodding without moving a displayed avatar (e.g., the avatar does not move relative to the display). As illustrated in FIG. 5, agent system 200-20 can optionally interface with external components such as external database 200-30, remote processing component 200-32, and/or remote administration component 200-34. In some embodiments, external database 200-30 represents one or more functions that provide data storage resources accessible to agent system 200-20. In some embodiments, access to the data of external database 200-30 is provided directly to agent system 200-20 (e.g., the agent system manages the database) and/or indirectly to agent system 200-20 (e.g., a database is managed by a different system, but data stored therein can be provided and/or stored for use by agent system 200-20). In some embodiments, external database 200-30 is dedicated to (e.g., only for use by) agent system 200-20, is not dedicated to agent system 200-20 (e.g., is a database of a web service accessible to different agent systems), and/or is a combination of both dedicated and non-dedicated database resources. In some embodiments, remote processing component 200-32 represents one or more components that function as a data processing resource that is accessible to agent system 200-20. In some embodiments, access to remote processing component 200-32 is provided directly to agent system 200-20 (e.g., the agent system manages the processing resources) and/or indirectly to agent system 200-20 (e.g., a processing resource managed by a different system, but that can provide data processing for the benefit of agent system 200-20). In some embodiments, remote processing component 200-32 is dedicated to (e.g., only for use by) agent system 200-20, is not dedicated to agent system 200-20 (e.g., is a processing resource of a web service accessible to different agent systems), and/or is a combination of both dedicated and non-dedicated processing resources. Examples of data processing include processing image data (e.g., for feature extraction and/or object detection), processing audio data (e.g., for processing natural language speech input via a large language model), and/or training a machine learning algorithm and/or model. In some embodiments, remote administration component 200-34 represents functions that include and/or are related to administrative functions. For example, such administrative functions can include providing component updates to agent system 200-30 (e.g., software and/or firmware updates), managing accounts (e.g., permissions, access control, and/or preferences associated therewith), synchronizing between different agent systems and/or components thereof (e.g., such that an agent accessible via multiple devices of a user can provide a consistent user experience between such devices), managing cooperation with other services and/or agent systems, error reporting, managing backup resources to maintain agent system reliability and/or agent availability, and/or other functions required by agent system 200-20 to perform operations, such as those described herein.

The various components of agent system 200-20 described above with respect to FIG. 5 represent functional blocks that represent functionality. This functionality can be implemented on the same and/or different hardware (e.g., physical components) and/or by the same and/or different software. For example, the functional blocks can be implemented using one or more physical components, devices (e.g., computer system 100 and/or device 200), and/or software programs. In other words, each functional block does not necessarily represent a single, discrete physical component, device, and/or software program, but can be implemented using one or more of these. Further, agent system 200-20 can include multiple implementations of functionality represented by a respective functional block. For example, agent system 200-20 can include multiple different model components representing ML models that are used in different contexts, can include multiple different API components representing different APIs that are used for different services, and/or can include multiple different visual output components that are used for outputting different types of visual output.

Attention is now turned to discussion of concepts that can arise with respect to operation of an agent.

As discussed throughout, an agent can be capable of interacting with a user. In some embodiments, this capability includes the ability to process explicit requests, commands, and/or statements. In some embodiments, explicit requests, commands, and/or statements include and/or are interpreted as instructions directed to accomplishing a task (e.g., display X, complete task Y, and/or perform operation Z). In some embodiments, an agent includes the ability to process implicit requests, commands, and/or statements. In some embodiments, an implicit request, command, and/or statement does not include an explicit request, command, and/or statement. For example, “I like going to Europe,” can be interpreted as an implicit request, command, and/or statement which, in response to detecting, device 200 displays an itinerary in response to the statement. As another example, “This picture is for my grandmother,” can be interpreted as an implicit request, command, and/or statement which, in response to detecting, device 200 displays suggestions for modifying the picture). As another example, “I'm so tired,” can be interpreted as an implicit request, command, and/or statement which, in response to detecting, device 200 causes a sleep meditation application to begin a meditation session. As yet another example, “I miss my grandad” can be interpreted as an implicit request, command, and/or statement when, in response to detecting, device 200 can initiate a live communication session (e.g., telephone call, video call, and/or text messaging session) with grandad. In some embodiments, an implicit request is more likely to be processed according to one or more current environmental context, operational context, and/or user context, while an explicit request is less likely to be processed according to one or more current environmental context, operational context, and/or user context. For example, the phrase, “call my grandad,” can be an explicit request, and in response to detecting the request, device 200 will initiate a live communication session with grandad, irrespective of one or more current environmental context, operational context, and/or user context. However, the phrase, “I miss my grandad,” can be an implicit request, and in response to detecting the request, device 200 can display a list of gifts to buy for grandad if a user has been recently talking about buying gifts or could call grandad in another context that does not include the user recently discussing buying gifts. In some embodiments, a request can include one or more explicit requests and one or more implicit requests. In some embodiments, an implicit request is responded to independently from an explicit request; and in other embodiments, a response to an implicit request is dependent on an explicit request.

Reference can be made herein to a response by an agent that is output by a device. In some embodiments, a response includes an audio portion (e.g., audio output, audible output, sound, and/or speech) (also referred to herein as a “verbal response,” an “audio response,” and/or an “audible response) and/or a visual portion (e.g., display and/or movement of a representation and/or avatar). In some embodiments, a response includes a movement portion (e.g., movement of the device). In some embodiments, a response includes a haptic portion (e.g., touch and/or vibration).

Reference can be made herein to an internal dialogue, internal context, and/or an operational context, which can refer to a dynamic context or dynamic decision-making process of the device, an internal state of device 200, and/or internal data the device is partially basing its decision on. In some embodiments, an internal dialogue includes a set of one or more rules, characteristics, detections, and/or observations that the computer system uses to generate a response to one or more commands, questions, and/or statements). In some embodiments, the set of one or more rules, characteristics, detections, and/or observations are learned and/or generated via deep learning and/or one or more machine learning algorithms, and/or using one or more machine learning and/or system agents. In some embodiments, an internal dialogue is generated in real-time. In some embodiments, an internal dialogue is locally stored and/or stored via the cloud. In some embodiments, an internal dialogue can be modified, updated, and/or deleted. In some embodiments, an internal dialogue is generated based on other internal dialogues.

Reference can be made herein to personality and/or behavior (or a representation of personality/behavior) (e.g., of an agent, user, and/or character). In some embodiments, personality and/or behavior refers to a set of one or more characteristics that the device detects, has knowledge of, conforms to, applies, and/or tracks. In some embodiments, the personality or behavior is used as basis to perform operations. For example, an agent can detect a user's personality and respond in a manner based on the personality (e.g., output different responses in response to different user personalities). As another example, the agent can output a response having characteristics that correspond to one or more characteristics that correspond to the personality and/or behavior (e.g., output a response in different ways that depend on personality of the agent). In some embodiments, such characteristics represent and/or mimic personality of a user, such as how the user acts and/or speaks. In some embodiments, such characteristics approximate a user's personality.

In some embodiments, an agent is a system agent. In some embodiments, a system agent is an agent that corresponds to a process that originates from and/or is controlled by an operating system of the device (e.g., the device implementing the agent). In some embodiments, an agent is an application agent. In some embodiments, an application agent is an agent that corresponds to a process that originates from and/or is controlled by an application of (e.g., installed on and/or executed by) the device (e.g., the device implementing the agent).

Reference can be made herein to a representation (e.g., an avatar and/or avatar representation) of an agent (e.g., and/or of a user (person, object, and/or an animal) and/or a user interface object (e.g., an animated character)). In some embodiments, a representation of an agent refers to a set of output characteristics (e.g., visual and/or audio) of the agent (and/or the user and/or the user interface object). For example, a representation of an agent can include (and/or correspond to) a set of one or more visual characteristics (e.g., facial features of an animated face) and/or one or more audio characteristics (e.g., language and voice characteristics of audio output). In some embodiments, a representation (e.g., of an agent) is used to represent output by the agent. For example, a device implementing an interactive agent outputs audio in a voice of the agent and displays an animated face of the agent moving in a manner to simulate the agent speaking the audio output. In this way, a user can feel like they are having a normal conversation with the agent. In some embodiments, a representation of an agent is (or is not) inclusive of personality and/or behavior characteristics (e.g., as described above). For example, a representation of an agent can include (and/or correspond to) a set of visual characteristics (e.g., facial features of an animated face) and also a set of personality characteristics. In some embodiments, a representation of an agent includes a set of user characteristics that correspond to visual representation of a user (e.g., representations of a user's appearance, voice, and/or personality are used as an avatar that appears to move and/or speak). In some embodiments, a representation is a representation of a face (e.g., a user interface object that is output having features that simulate a face and/or facial expressions of a person (e.g., for conveying information to a viewer)).

In some embodiments, a character (e.g., of an agent and/or avatar) refers to a particular set of characteristics of a representation. For example, an avatar can take on (e.g., use, apply, interact with, and/or output according to) characteristics of a fictional and/or non-fictional character (e.g., from a movie, a show, a book, a series, and/or popular culture).

In some embodiments, a voice (e.g., of an agent and/or avatar) refers to a set of one or more characteristics corresponding to sound output that resembles (e.g., represents, mimics, and/or recreates) vocal utterance (e.g., attributable and/or simulated as being output by an agent and/or avatar). For example, device 200 can output a sentence that sounds different depending on a voice used. In some embodiments, a particular character and/or avatar can be configured to use a particular voice (e.g., have a corresponding voice). In some embodiments, the particular voice can mimic a user's voice.

In some embodiments, an appearance (e.g., of an agent and/or avatar) refers to a set of one or more characteristics corresponding to visual output that represents an avatar (and/or an agent). For example, device 200 can output an avatar that has a set of facial features forming an appearance that resembles a particular character from a movie.

In some embodiments, an expression of an avatar refers to a set of one or more characteristics corresponding to a particular visual appearance of a user, an avatar, and/or an agent. For example, device 200 can output an avatar that has a set of facial features arranged in a particular way to give the appearance of a facial expression (e.g., which can be used as a form of non-verbal communication to a user) (e.g., a frown is an expression of sadness, a smile is an expression of happiness, and/or wide open eyes is an expression of surprise). As another example, device 200 can output an avatar that has a set of body features (e.g., arms and/or legs) arranged in a particular way to give the appearance of a body expression (e.g., which can be used as a form of non-verbal communication to a user) (e.g., a hand gesture is an expression of approval, covering eyes is an expression of fear, and/or shrugging shoulders is an expression of lack of knowledge). In some embodiments, an expression includes movement (e.g., a head nod is an expression of agreement and/or disagreement) of the avatar. In some embodiments, device 200 can move, via the movement component, to indicate an expression with or without the avatar moving. In some embodiments, an agent performs one or more operations that depend on a user's expression (e.g., detects if a person is sad and responds with a kind statement or question). In some embodiments, expressions (e.g., whether and/or how they are used and/or how they are output) depends on personality. For example, a first personality can use a particular expression more than a second personality. As another example, an expression (e.g., frown, smile, and/or how wide eyes are opened) for the first personality can appear different from the expression (and/or a similar and/or equivalent expression) for a second personality (e.g., the first personality smiles in a manner that reveals teeth, but the second personality smiles without revealing teeth).

In some embodiments, an agent (e.g., an avatar of the agent and/or an agent system (e.g., hardware and/or software) implementing the agent) mimics characteristics of another user, agent, and/or character (e.g., in personality, behavior, expressions, and/or voice). In some embodiments, mimicking includes mirroring a user (e.g., copying use of a phrase and/or movement detected from a user interacting with the agent). In some embodiments, mimicking characteristics of a user includes attempting to reproduce the characteristics of the user (e.g., in the exact same manner and/or in manner that resembles the characteristics but is not an exact reproduction of the characteristics). For example, an agent mimicking voice and/or expressions does not require the agent have the exact same voice and/or expressions as the user being mimicked (e.g., but rather simply resembles the user's voice and/or expressions).

In some embodiments, a component and/or device uses (e.g., performs operations, makes decisions, and/or determines context based on) learned characteristics (e.g., characteristics of a context, user, and/or environment that the device has learned over time (e.g., via detection, prior experience, and/or feedback (e.g., from one or more users)). For example, characteristics learned over time can include a user's routine. In such example, if a particular user asks an agent for a summary of any new messages for the user at the same time every day, the agent can learn to perform operations automatically based on the learned characteristics of the routine (e.g., what data is needed, when the data is needed, and/or for which user). In some embodiments, use of learned characteristics enables an agent (and/or device) to improve understanding of (and/or responses to) a context, user, and/or environment, and/or to understand a context, user, and/or environment that otherwise was not (and/or would not be) understood (e.g., not responded to or responded to incorrectly). In some embodiments, learned characteristics are formed (e.g., by and/or for an agent) using reinforcement learning. In some embodiments, learned characteristics correspond to one or more levels of confidence, certainty, and/or reward (e.g., that are shaped by one or more reward functions). In some embodiments, learned characteristics (and/or how they are used to affect output of an agent and/or device) can change over time (e.g., levels confidence, certainty, and/or reward change over time). For example, output of a device before learning a set of learned characteristics can be different from output of the device after learning the set of learned characteristics. In some embodiments, a component and/or device uses learned knowledge. For example, similar to described above with respect to learned characteristics, learned knowledge can refer to information used to update (e.g., enhance, add to, and/or augment) a knowledge base of a device (e.g., for use by an agent implemented thereon). In some embodiments, multiple sets of learned characteristics for a user can be stored and/or used. In some embodiments, different sets of learned characteristics for different users can be stored and/or used.

Reference can be made herein to interaction with an agent (and/or a device). In some embodiments, an interaction refers to a set of one or more inputs and/or outputs of a device implementing the agent and one or more users. For example, an interaction can be an input by a user (e.g., “Please turn on the lights”) and a corresponding output (e.g., causing the lights to turn on and/or a response by the device of “Okay”). In some embodiments, interaction can include multiple inputs/outputs by one or more of the parties to the interaction (e.g., device and/or users). For example, an interaction can include a first input by a user (e.g., “Please turn on the lights”) and a corresponding first output (e.g., “Which lights?”), and also include a second input by the user (e.g., “Kitchen lights”) and a second output from the device (e.g., “Okay”). In some embodiments, which inputs and/or outputs are considered together as an interaction is based on a logical and/or contextual grouping (e.g., interactions within the previous thirty (30) seconds and/or interactions relating to turning on the lights). As one of skill will appreciate, an interaction can be considered in a manner that depends on the implementation (e.g., determining when an interaction is complete can involve determining if the user still present (e.g., speaking at all) and/or if the user still talking about the lights or has moved onto a different topic). In some embodiments, an interaction is a current interaction (e.g., ongoing, presently occurring, and/or active). In some embodiments, an interaction is a previous interaction. The examples above describe a device having a conversation with a user. In some embodiments, a conversation is between two or more users (e.g., users in an environment). For example, a device can detect a conversation between to users (e.g., the users are directing speech and responses to each other, rather than to the device).

In some embodiments an agent (and/or device) determines and/or performs an operation based on an intent corresponding to a user. For example, a device detects user input and outputs a response that depends on an intent of the user input. For example, a device detects user input that includes a pointing gesture detected together with verbal instruction to “turn on that light,” and in response, the device turns on the light that is determined to correspond to the intent of the input (e.g., the light toward which the pointing gesture directed). In some embodiments, intent is determined (e.g., by the device that detects input and/or by one or more other devices) using one or more of: one or more inputs, knowledge (e.g., learned knowledge about a user based on a history of observed behavior, personality, and interactions), learned characteristics, and/or context. In some embodiments, intent is determined from one or more types of input (e.g., verbal input, visual input via a camera, and/or contextual input).

Attention is now directed towards embodiments of user interfaces (“UI”) and associated processes that are implemented on an electronic device, such as computer system 100 and/or device 200.

FIGS. 6A-6E illustrate exemplary user interfaces for updating an indication of an activity in accordance with some embodiments. The user interfaces in these figures are used to illustrate the processes described below, including the processes in FIG. 7.

FIGS. 6A-6E illustrate computer system 600. In some embodiments, computer system 600 is a smart phone, a smart watch, a smart display, a tablet, a laptop, a fitness tracking device, and/or a head-mounted display device that is in communication with one or more input devices (e.g., a camera, a depth sensor, and/or a microphone). Computer system 600 displays, via a display component (e.g., a display screen, a projector, and/or a touch-sensitive display), the score of a detected competition. In some embodiments, computer system 600 includes one or more components and/or features described above in relation to electronic devices 100, 200, and/or 600.

FIGS. 6A-6E include computer system 600 on the left and a schematic on the right. The schematic is included as a visual aid to illustrate the relative positioning and detection of a competition by computer system 600. In the examples described with respect to FIGS. 6A-6E, computer system 600 detects a competition within the field-of-view of a camera belonging to computer system 600. The schematic includes goal 608, goal 610, and representation of computer system location 606 in environment 604. Representation of computer system location 606 acts as a representation of the location of computer system 600. As illustrated in FIG. 6A, computer system 600 is displaying time user interface 602. Time user interface 602 displays the current time (e.g., “12:20”).

In some embodiments, computer system 600 automatically detects whether a competition is occurring and displays an indication of the competition. For example, at FIG. 6B, computer system 600 detects that people are playing soccer in the field-of-view of one or more cameras of computer system 600. In response to detecting people playing soccer, computer system 600 displays score indicator 614 (e.g., “0-0”) and ceases to display time user interface 602 (and/or overlays score indicator 614 on time user interface 602). In some embodiments, computer system 600 displays an indication of the competition after detecting that another type of competition, such as American football, baseball, chess, fencing, and/or pickle ball, is being played. In some embodiments, a competition is a sport, a game, a contest, an event, and/or a single player competition and/or a multi-player competition. In the examples described herein, computer system 600 can detect whether a particular type of competition is occurring, detect a transition between one competition and another competition occurring in environment 604, and switch between updating visual indications based on the rules of one competition to updating visual indications based on the rules of the other competition after detecting the transition between one competition and the other competitions occurring in environment 604. In some embodiments, computer system 600 detects that multiple competitions are occurring in environment 604 and updates separate visual indications corresponding to each competition differently (e.g., according to the rule of each respective competition).

In some embodiments, computer system 600 automatically detects whether a particular competition is occurring based on one or more detected characteristics of the competition. For example, at FIG. 6B, computer system 600 detects that people are playing soccer based on one or more characteristics of the people and/or the environment, such as the movement of ball 616, the existence of goal 608, the existence of goal 610, and/or the movement of the people. In some embodiments, computer system 600 can detect one or more other characteristics to determine whether a different type of competition is occurring, such as the type of equipment that the players are using (e.g., hockey sticks and/or tennis rackets), how the players on a team are positioned (e.g., most team members on one side of the net versus across the field), and/or how many players are on a team.

In some embodiments. computer system 600 optionally displays a live preview. As illustrated in FIG. 6B, computer system 600 does not display a live preview concurrently with score indicator 614. However, in some embodiments, computer system 600 displays a live preview concurrently with score indicator 614. In some embodiments, a live preview is a live feed from a camera and/or one or more images captured in the field-of-view of the camera.

In some embodiments, computer system 600 displays different indicators corresponding to the specific competition. In some embodiments, at FIG. 6B, an indicator can include a red card and/or yellow card that has been awarded to a player playing in the soccer competition. In some embodiments, the different indicators include indicators corresponding to penalties, player statistics, and/or broken rules. In some embodiments, when computer system 600 detects that basketball is being played, computer system 600 can display an indicator corresponding to foul count, free throw percentages for one or more players, and/or ejections. In some embodiments, computer system 600 displays one or more of the different indicators concurrently with and/or in place of score indicator 614. Notably, computer system 600 will not display indicators that are specific for one competition for another competition. For example, computer system 600 will not display free throw percentages for soccer.

In some embodiments, while displaying a score, computer system 600 detects a new competition and automatically displays an indicator for the new competition in real time. For example, in a scenario where computer system 600 detects soccer being played as illustrated in FIG. 6B, if the players start playing rugby, computer system 600 would determine that rugby is now being played instead of soccer (e.g., based on one or more characteristics corresponding to the competition of rugby). In some embodiments, computer system 600 automatically ceases to display an indicator for an old competition when detecting that a new competition has started being played. For example, in response to determining that the people have transitioned from playing soccer (e.g., as illustrated in FIG. 6B) to rugby, computer system 600 will cease to display score indicator 614 and display another score indicator for rugby. In some embodiments, displaying the rugby score indicator involves resetting score indicator 614. In some embodiments, other indicators (e.g., as described above) for soccer, including the name of the type of competition (e.g., “Soccer,” “Rugby,” and/or “Football”), cease to be displayed or be replaced with other indicators for rugby. In some embodiments, computer system 600 automatically detects the number of teams corresponding to the new competition and displays an indication corresponding to the number of teams. For example, as illustrated in FIG. 6B, computer system 600 displays an indication that two teams are playing soccer. However, in some embodiments, if the players started running, computer system 600 would make a determination that a race has started and, in response, would display an indicator of the number of participants and/or number of teams that are participating in the race. In some embodiments, computer system 600 displays a different score indicator for the runners (e.g., where each runner has a score and/or time) than score indicator 614.

In some embodiments, computer system 600 can update a score indicator when computer system 600 detects that a score has occurred for a particular competition. For example, as illustrated in FIG. 6C, computer system 600 detects that ball 616 has entered goal 608 (e.g., as seen in the schematic), and in response to detecting that ball 616 has entered goal 608 (e.g., computer system 600 determines that a score has occurred), computer system 600 updates score indicator 614 to reflect that the score is 1-0. In embodiments where computer system 600 detects that lacrosse is being played, computer system 600 would update score indicator 614 to reflect that the score is 2-0 if the ball was shot behind the line (e.g., computer system 600 determines that a score has occurred). In some embodiments, computer system 600 updates score indicator 614, irrespective of the ball being in a goal, such as when a person crosses a finish line and/or a person enters the endzone with the ball. In some embodiments, computer system 600 moves to follow the ball and/or a player in the competition.

In some embodiments, computer system 600 can output an indication of score in different ways. For example, is illustrated in FIG. 6C, score indicator 614 is a visual indicator. In some embodiments, computer system 600 can provide audio output of score. For example, “The score is one to zero.” In some embodiments, computer system 600 can provide haptic output of the score, such that computer system 600 vibrates and/or pulses an amount of times and/or length of time to indicate that the score is one to zero. In some embodiments, computer system 600 can move to indicate that the score is one to zero, such as moving in the upward direction one time and not moving in the downward direction any time (e.g., upward movement reflecting score for the first team versus downward movement reflecting score for second team).

In some embodiments, computer system 600 updates score indicator 614 relative to when the computer system detects that a score has occurred. As illustrated in FIG. 6C, computer system 600 displays an updated indicator of a score after a score is detected. Computer system 600 will not update a score indicator when no score is detected. In some embodiments, computer system 600 updates a score indicator before a score occurs (e.g., for a probable scoring event). In some embodiments, computer system 600 will not update a score indicator before a score occurs.

At FIG. 6D, computer system 600 detects that ball 616 has entered goal 610 (e.g., as seen in the schematic). In response to detecting that ball 616 has entered goal 610 (e.g., computer system 600 determines that a score has occurred), computer system 600 updates score indicator 614 (e.g., “1-1”).

In some embodiments, computer system 600 can display an indication of results of a detected competition in response to detecting that the competition has concluded (e.g., based on one or more characteristics corresponding to the competition, such as time, score, and/or ruling). As illustrated in FIG. 6E, computer system 600 displays results indicator 620 (e.g., “You tied”) in response to detecting that the soccer competition has concluded. In some embodiments, computer system 600 will not display a results indicator if the detected competition has not concluded. In some embodiments, computer system 600 displays results indicator 620 with results that show a distinct winner and a loser (e.g., as opposed to a tie).

In some embodiments, computer system 600 can send the results of a concluded competition to another device. For example, at FIG. 6E, computer system 600 sends an indication that the teams have tied because the game ended with a score of 1-1 (e.g., as indicated by results indicator 620 in FIG. 6E). In some embodiments, one or more other indications can be sent, such as the most valuable player, the player with the most points, a team's total win and/or loss record, and/or a summary of the statistics obtained during the game and/or during a season that included the game. In some embodiments, the one or more indications can cause the other devices to perform an operation, such as displaying a notification of the results of the game along with other indications, such as those described above.

FIG. 7 is a flow diagram illustrating a process (e.g., method 700) for updating an indication of an activity in accordance with some embodiments. Some operations in process 700 are, optionally, combined, the orders of some operations are, optionally, changed, and some operations are, optionally, omitted.

As described below, process 700 provides an intuitive way for updating an indication of an activity. Process 700 reduces the cognitive burden on a user for updating an indication of an activity, thereby creating a more efficient human-machine interface. For battery-operated computing devices, enabling a user to update an indication of an activity faster and more efficiently conserves power and increases the time between battery charges.

In some embodiments, process 700 is performed at a computer system (e.g., 100, 200, and/or 600) that is in communication with a display component and a camera (e.g., a telephoto, wide angle, and/or ultra-wide-angle camera). In some embodiments, the computer system is a watch, a phone, a tablet, a processor, a head-mounted display (HMID) device, a communal device, a media device, a speaker, a television, and/or a personal computing device.

While capturing, via the camera, one or more images of an environment (e.g., 604) (e.g., a physical environment, a virtual environment, and/or a mixed-reality environment), the computer system detects (702) that a first activity (e.g., a game, a live activity, a sport, football, baseball, and/or soccer) is being performed in the environment (e.g., as described above in FIG. 6B).

While (704) detecting that the first activity is being performed (e.g., as described above in FIG. 6B), in accordance with a determination that the first activity includes a first set of one or more characteristics, the computer system displays (706), via the display component, an indication (e.g., a score, a name of the activity, a title, a name of a player participating in the activity, and/or the name of a team participating in the activity) of the first activity (e.g., 614 and/or 620) (e.g., as described above in FIGS. 6B-6E).

While (704) detecting that the first activity is being performed, in accordance with a determination that the first activity includes a second set of one or more characteristics different from the first set of one or more characteristics, the computer system forgoes (708) displaying the indication of the first activity (e.g., as described above in FIG. 6A).

While displaying the indication of the first activity (e.g., 614 and/or 620), the computer system detects (710) a first event (e.g., scoring a goal, shooting a basketball, kicking a soccer ball, moving, and/or talking) corresponding to the first activity being performed (e.g., played and/or captured) in the environment (e.g., 604) (e.g., as described above in FIGS. 6B-6E).

In response to detecting the first event corresponding to the first activity being performed in the environment (e.g., 604), the computer system updates (712) the indication of the first activity (e.g., 614 and/or 620) (e.g., changing the score and/or moving an indication to indicate that the first event occurred (e.g., from a first team to a second team) (e.g., a possession indication, a scoring indication, an advantage indication, and/or a number of fouls indication)) (e.g., as described above in FIGS. 6B-6E). Displaying an indication of the first activity or not displaying the indication of the first activity based on prescribed conditions being met enables the computer system to intelligently determine which activity is being performed and provide a user with appropriate visual feedback corresponding to the activity, thereby providing improved visual feedback to the user and/or performing an operation when a set of conditions has been met without requiring further user input.

In some embodiments, while displaying the indication of the first activity (e.g., 614 and/or 620), the computer system detects that a second activity (e.g., a game, a live activity, a sport, football, baseball, and/or soccer), different from the first activity, is being performed in the environment (e.g., 604) (e.g., as described above in FIGS. 6B-6E). In some embodiments, while detecting that the second activity is being performed in the environment (e.g., 604) and in accordance with a determination that the second activity includes a third set of one or more characteristics (e.g., different from the first set of one or more characteristics and/or different from the second set of one or more characteristics), the computer system displays, via the display component, an indication of the second activity (e.g., 614 and/or 620) (e.g., a description of the second activity in the form of text and/or images) in a different manner than the indication of the first activity (e.g., 614 and/or 620) (e.g., the indication of the second activity displayed at a different location, at a different orientation, with different graphics, different colors, different fonts, and/or a different animation than the indication of the first activity) (e.g., as described above in FIGS. 6B-6E). In some embodiments, before displaying the indication of the second activity, the computer system ceases to display the indication of the first activity. In some embodiments, detecting that the second activity is being performed in the environment includes detecting that the first activity has not been performed (e.g., and detected) for at least a predetermined period of time. In some embodiments, detecting the second activity includes detecting the first activity is no longer detected. In some embodiments, while detecting that the second activity is being performed in the environment and in accordance with a determination that the second activity does not include the third set of one or more characteristics, the computer system does not display, via the display component, the indication of the second activity in a different manner. In some embodiments, while detecting that the second activity is being performed in the environment and in accordance with a determination that the second activity does not include the third set of one or more characteristics, the computer system does not display, via the display component, the indication of the second activity in a different manner than the indication of the first activity. In some embodiments, the indication of the second activity is different from the indication of the first activity when the first set of one or more characteristics is different from the third set of the one or more characteristics. In some embodiments, if the first set of one or more characteristics were the same as the third set of one or more characteristics, the indication of the second activity would be the same as the indication of the first activity. Detecting that a second activity is being performed and in accordance with a determination that the second activity includes a third set of one or more characteristics, displaying an indication of the second activity in a different manner than the indication of the first activity enables the computer system to provide an updated visual content corresponding to a new activity initiated by a user, thereby providing improved visual feedback to the user and/or performing an operation when a set of conditions has been met without requiring further user input.

In some embodiments, displaying the indication of the second activity (e.g., 614 and/or 620) does not include displaying one or more images of the environment (e.g., 604) (e.g., the one or more images of the environment captured via the camera) (e.g., a live preview and/or live feed captured by the camera and/or the one or more images of the environment depicting the second activity being performed in the environment) of the second activity being performed in the environment (e.g., as described above in FIGS. 6B-6E). Displaying the indication of the second activity without displaying one or more images of the environment of the second activity being performed in the environment when prescribed conditions are met enables the computer system to provide visual content as the user performs an activity, thereby providing improved visual feedback to the user and/or performing an operation when a set of conditions has been met without requiring further user input.

In some embodiments, displaying the indication of the second activity (e.g., 614 and/or 620) includes displaying one or more images of the environment (e.g., 604) (e.g., the one or more images of the environment captured via the camera) (e.g., a live preview and/or live feed captured by the camera and/or the one or more images of the environment depicting the second activity being performed in the environment) of the second activity being performed in the environment (e.g., as described above in FIGS. 6B-6E). Displaying one or more images of the environment of the second activity being performed in the environment as a part of displaying the indication when prescribed conditions are met enables the computer system to provide visual content including images of the user performing an activity, thereby providing improved visual feedback to the user and/or performing an operation when a set of conditions has been met without requiring further user input.

In some embodiments, detecting the second activity being performed in the environment (e.g., 604) does not include detecting a user input (e.g., an input (e.g., an air gesture, a touch input, and/or a verbal input) request directed to a set of input devices as opposed to inputs in the environment that are not directed to (e.g., made to change and/or for the sole purposes of changing an operation of the computer system)) (e.g., an explicit request) (e.g., corresponding to a request that includes an indication of the second activity (and/or a request to stop detecting that the first activity is being performed)) (e.g., as described above in FIGS. 6B-6E). Detecting the second activity being performed in the environment without detecting a user input enables the computer system to automatically detect user activity without an explicit user input and provide the user with appropriate visual feedback corresponding to the activity, thereby providing improved visual feedback to the user and/or reducing the number of inputs needed to perform an operation.

In some embodiments, detecting the second activity being performed in the environment (e.g., 604) does not include detecting a request (e.g., a verbal request directed to a set of input devices (e.g., microphone, camera, and/or other sensors different from the camera) opposed to sounds observed while performing or initiating the second activity) (e.g., an explicit request) including an indication that the second activity (e.g., 614 and/or 620) is being performed (e.g., as described above in FIGS. 6B-6E). Detecting the second activity being performed in the environment without detecting a request including an indication that the second activity is being performed enables the computer system to automatically detect a user activity without an explicit user command and provide the user with appropriate visual feedback corresponding to the activity, thereby providing improved visual feedback to the user and/or reducing the number of inputs needed to perform an operation.

In some embodiments, the indication of the first activity (e.g., 614 and/or 620) includes a representation of a first set of one or more participants (e.g., 608 and/or 610) (e.g., of user(s), of player(s), and/or of team(s)) participating in the first activity. In some embodiments, the indication of the second activity (e.g., 614 and/or 620) includes a representation of a second set of one or more participants (e.g., 608 and/or 610), different from the representation of the first set of participants, (e.g., of user(s), of player(s), and/or of team(s)) participating in the second activity (e.g., as described above in FIGS. 6B-6E) (e.g., going from a single player sport to a multi-player sport, going from baseball to bowling, where there are more than two teams in bowling). In some embodiments, the representation of the first set of participants includes a number of the first set of participants, and the representation of the second set of participants includes a number of the second set of participants. In some embodiments, the number of the first set of participants is different from the number of the second set of participants. Having the indication of the first activity includes a representation of a first set of one or more participants participating in the first activity and having the indication of the second activity includes a representation of a second set of one or more participants participating in the second activity when prescribed conditions have been met enables the computer system to provide visual content that provides the number of participants in an activity, thereby providing improved visual feedback to the user and/or reducing the number of inputs needed to perform an operation.

In some embodiments, updating the indication of the first activity (e.g., 614 and/or 620) includes changing a portion of the indication (e.g., clock(s), timer(s), graphic(s), text(s), animation(s), sound(s), haptic output(s), and/or scoreboard(s)) of the first activity (e.g., 614 and/or 620) according to (e.g., based on) a first set of rules associated with the first activity (e.g., the first set of one or more characteristics) (e.g., as described above in FIGS. 6B-6E). In some embodiments, while displaying the indication of the second activity (e.g., 614 and/or 620), the computer system detects a second event (e.g., scoring a goal, shooting a basketball, kicking a soccer ball, moving, and/or talking) corresponding to the second activity being performed in the environment (e.g., 604) (e.g., as described above in FIGS. 6B-6E). In some embodiments, in response to detecting the second event corresponding to the second activity being performed in the environment (e.g., 604), the computer system updates the indication of the second activity (e.g., 614 and/or 620) (e.g., with different values, name, symbols, and/or with different increases in score, statistics, and/or penalties), wherein updating the indication of the second activity includes changing a portion of the indication (e.g., clock(s), timer(s), graphics, text(s), animation(s), haptic output(s), and/or a scoreboard(s)) of the second activity according to (and/or based on) a second set of rules associated with the second activity (e.g., the third set of one or more characteristics) different from the first set of rules (e.g., as described above in FIGS. 6B-6E). Updating the indication of the first activity or the indication of the second activity based on prescribed conditions being met enables the computer system to customize visual updates for multiple activities so that they are easily distinguishable from each other, thereby providing improved visual feedback to the user and/or reducing the number of inputs needed to perform an operation.

In some embodiments, while displaying the indication of the first activity (e.g., 614 and/or 620), the computer system detects a second event (e.g., a scoring event (e.g., goal, basket, touchdown, ace, point, a completion of a predefined task, and/or a completion of a sequence of predefined tasks) has or will likely take place that is detected through images and/or audio capture by one or more input devices (e.g., microphone, camera, and/or other sensors different from the camera)) corresponding to the first activity (e.g., as described above in FIGS. 6B-6E): in response to detecting the second event corresponding to the first activity: in accordance with a determination that the second event corresponding to the first activity is a scoring event (e.g., goal, basket, touchdown, ace, point, a completion of a predefined task, and/or a completion of a sequence of predefined tasks), displaying, via the display component, a first indication of the score for the first activity (e.g., as described above in FIGS. 6B-6E); and in accordance with a determination that the second event corresponding to the first activity is not the scoring event, forgoing displaying, via the display component, the first indication of the score for the first activity (e.g., as described above in FIGS. 6B-6E). In some embodiments, the third set of rules being the same as the first set of rules. Displaying the first indication of the score for the first activity or not displaying the first indication of the score for the first activity based on prescribed conditions being met enables the computer system to provide visual content relevant to the activity captured by the computer system, thereby providing improved visual feedback to the user and/or performing an operation when a set of conditions has been met without requiring further user input.

In some embodiments, the scoring event is a scoring event that has not occurred (e.g., a probable scoring event, where, in some embodiments, the first indication of the score is displayed before the actual scoring event has occurred) (e.g., as described above in FIGS. 6B-6E). Displaying a scoring event before the scoring event has occurred enables the computer system to provide an updated score before an actual scoring event occurs, thereby providing improved visual feedback to the user and/or reducing the number of inputs needed to perform an operation.

In some embodiments, the scoring event is a scoring event that has occurred (e.g., an actual scoring event, where, in some embodiments, the first indication of the score is displayed only after the actual scoring event has occurred) (e.g., as described above in FIGS. 6B-6E). In some embodiments, the indication of score for the first activity occurs after a first predetermined period of time after the scoring event occurs and the indication of score remains displayed for a second predetermined period of time (e.g., temporarily and/or permanently). Displaying the scoring event after the scoring event that has occurred enables the computer system to provide an updated score after an actual scoring event occurs, thereby providing improved visual feedback to the user and/or reducing the number of inputs needed to perform an operation.

In some embodiments, after updating the indication of the first activity (e.g., 614 and/or 620), the computer system detects an event corresponding to a completion of the first activity (e.g., as described above in FIGS. 6B-6E). In some embodiments, detecting the event corresponding to the completion of the first activity in the environment occurs while displaying the indication of the first activity. In some embodiments, detecting event corresponding to the completion of the first activity occurs while not displaying the indication of the first activity. In some embodiments, in response to detecting the event corresponding to the completion of the first activity, in accordance with the determination that the first activity includes the first set of one or more characteristics and the first set of one or more characteristics is associated with a fourth set of rules, the computer system displays, via the display component, an indication of one or more results of the first activity (e.g., a winner, a loser, a score, a list of players, a list of awards, a list of top scores of the first activity (e.g., of the particular performance and/or current performance of the first activity and/or historical performances of the first activity)) (e.g., as described above in FIGS. 6B-6E). In some embodiments, in response to detecting the event corresponding to the completion of the first activity, in accordance with the determination that the first activity includes the first set of one or more characteristics and the first set of one or more characteristics is associated with a fifth set of rules different from the fourth set of rules, the computer system forgoes displaying the indication of one or more results of the first activity (e.g., as described above in FIGS. 6B-6E). Displaying an indication of one or more results of the first activity or not displaying the indication of one or more results of the first activity when prescribed conditions have been met enables the computer system to provide an alert of a completion of an activity and one or more results (e.g., a winner, loser, and/or another result) of the activity, thereby providing improved visual feedback to the user and/or performing an operation when a set of conditions has been met without requiring further user input.

In some embodiments, after updating the indication of the first activity (e.g., 614 and/or 620), the computer system detects an event (e.g., as described above in FIGS. 6B-6E). In some embodiments, detecting the event occurs while displaying the indication of the first activity. In some embodiments, detecting the event occurs while not displaying the indication of the first activity. In some embodiments, in response to detecting the event, in accordance with the determination that the first activity includes the first set of one or more characteristics and the first set of one or more characteristics is associated with a sixth set of rules, the computer system displays, via the display component, an indication of a violation of a rule (e.g., a rule in the sixth set of rules) corresponding to the first activity (e.g., foul, penalty, fault, offsides, and/or time violation) (e.g., as described above in FIGS. 6B-6E). In some embodiments, in response to detecting the event, in accordance with the determination that the first activity includes the first set of one or more characteristics and the first set of one or more characteristics is associated with a seventh set of rules different from the sixth set of rules, the computer system forgoes displaying the indication of the violation of the rule (e.g., a rule in the sixth set of rules) corresponding to the first activity (e.g., as described above in FIGS. 6B-6E). Displaying an indication of a violation of the rule or not displaying the indication of the violation of the rule based on prescribed conditions being met enables the computer system to provide an alert of violations that occur during the activity, thereby providing improved visual feedback to the user and/or performing an operation when a set of conditions has been met without requiring further user input.

In some embodiments, the first set of one or more characteristics includes characteristics corresponding to a competition (e.g., a game, a sport, a tournament, a match, a heat, a single player competition, a multi-player competition, an event that is judged, an event that is graded, and/or an event that is scored) (e.g., as described above in FIGS. 6B-6E). Having the first set of one or more characteristics includes characteristics corresponding to a competition enables the computer system to detect competitive activities occurring and provides relevant visual content, thereby providing improved visual feedback to the user and/or performing an operation when a set of conditions has been met without requiring further user input.

In some embodiments, the computer system (e.g., 600) is in communication with an audio generation device (e.g., smart speakers, home theater system, soundbars, headphones, earphones, earbuds, speakers, television speakers, augmented reality headset speakers, audio jacks, optical audio output, Bluetooth audio outputs, HDMI audio outputs, and/or audio sensors) (e.g., as described above in FIGS. 6A-6E). In some embodiments, while detecting that the first activity is being performed, the computer system detects a third scoring event corresponding to the first activity being performed in the environment (e.g., 604) (e.g., as described above in FIGS. 6B-6E). In some embodiments, in response to detecting the third scoring event corresponding to the first activity, in accordance with the determination that the first activity includes the first set of one or more characteristics, the computer system outputs, via the audio generation device, an audible indication of the third scoring event for the first activity (e.g., as described above in FIGS. 6B-6E). In some embodiments, in response to detecting the third scoring event corresponding to the first activity, in accordance with the determination that the first activity does not include the first set of one or more characteristics, the computer system forgoes outputting, via the audio generation device, the audible indication of the third scoring event for the first activity (e.g., as described above in FIGS. 6B-6E). Outputting an audible indication of the third scoring event for the first activity or not outputting the audible indication of the third scoring event for the first activity when prescribed conditions have been met enables the computer system to provide audio alerts relevant to events occurring in an activity captured by the computer system, thereby providing improved feedback to the user and/or performing an operation when a set of conditions has been met without requiring further user input.

In some embodiments, the computer system (e.g., 600) is in communication with a second computer system (e.g., 600). In some embodiments, in response to detecting the first event corresponding to the first activity being performed in the environment (e.g., 604) (e.g., as described above in FIGS. 6B-6E), in accordance with a determination that the first activity includes the first set of one or more characteristics, the computer system sends a second indication of a second score for the first activity to the second computer system (e.g., as described above in FIGS. 6B-6E). In some embodiments, in response to detecting the first event corresponding to the first activity being performed in the environment, in accordance with a determination that the first activity does not include the first set of one or more characteristics, the computer system forgoes sending the second indication of the second score for the first activity to the second computer system (e.g., as described above in FIGS. 6B-6E). Sending a second indication of a second score for the first activity to a second computer system or not sending the second indication of the second score for the first activity to the second computer system when a particular set of prescribed conditions are met enables the computer system to intelligently transmit data about an ongoing activity to other devices, thereby providing improved feedback to the user and/or performing an operation when a set of conditions has been met without requiring further user input.

In some embodiments, the indication of the first activity (e.g., 614 and/or 620) includes a third indication of a third score for the first activity (e.g., score(s), time(s) for completion of task(s), and/or grade(s)) (e.g., as described above in FIGS. 6B-6E). Having the indication of the first activity includes a third indication of a third score for the first activity when prescribed conditions have been met enables the computer system to provide relevant visual content related to scoring event occurring during the activity, thereby providing improved feedback to the user and/or performing an operation when a set of conditions has been met without requiring further user input.

In some embodiments, the computer system (e.g., 600) is in communication with a movement component (e.g., an actuator (e.g., a pneumatic actuator, hydraulic actuator and/or an electric actuator), a movable base, a rotatable component, and/or a rotatable base) (e.g., as described above in FIGS. 6B-6E). In some embodiments, while detecting that the first activity is being performed, the computer system detects movement of a key object (e.g., ball, frisbee, and/or disc) (e.g., of first acidity) (e.g., 616) in a field-of-detection (e.g., field-of-view of one or more cameras, field-of-detection of sound of a microphone, and/or field-of-sensing of a radar sensor) from a first location in the environment (e.g., 604) to a second location, different from the first location, in the environment (e.g., 604) (e.g., as described above in FIGS. 6B-6E). In some embodiments, in response to detecting movement of the key object (e.g., 616) in the field-of-detection, the computer system moves, via the movement component, from a first position to a second position, different from the first position (e.g., as described above in FIGS. 6B-6E). In some embodiments, at the first position, the key object is not in the field-of-view/detection of the computer system while the key object is at the second location in the environment. In some embodiments, at the second position, the key object is in the field-of-view of the computer system while the key object is at the second location in the environment. In some embodiments, the computer system moves from the first position to the second position after detecting that the key object is no longer in and/or is moving out of the field-of-view/detection of the computer system.

In some embodiments, in accordance with a determination that the first activity is a first type of activity, the key object (e.g., 616) is a first object in the environment (e.g., 604) (e.g., as described above in FIGS. 6B-6E). In some embodiments, in accordance with a determination that the first activity is not the first type of activity, the key object (e.g., 616) is not the first object in the environment (e.g., 604) (e.g., as described above in FIGS. 6B-6E). ISE, in accordance with a determination that a second activity has been detected (and the first activity is no longer detected), the computer system identifies a new key object and ceases to identify an old key object (e.g., key object for the first activity) as the key object.

In some embodiments, detecting the first event corresponding to the first activity being performed in the environment (e.g., 604) includes detecting that an action is being performed using the key object (e.g., 616) (e.g., football crossing goal line, soccer ball in soccer net, puck in goal, and/or basketball in basketball hoop) (e.g., as described above in FIGS. 6B-6E).

FIGS. 8A-8E illustrate exemplary user interfaces for providing interactive user interfaces using an electronic computer system in accordance with some embodiments. The user interfaces in these figures are used to illustrate the processes described below, including the processes in FIGS. 9, 10, and 11.

FIGS. 8A-8E illustrate a computer system 800 (e.g., a tablet) displaying different user interface objects. It should be recognized that computer system 800 can be other types of computer systems such as a smart phone, a smart watch, a laptop, a communal device, a smart speaker, an accessory, a personal gaming system, a desktop computer, a fitness tracking device, and/or a head-mounted display (HAMD) device. In some embodiments, computer system 800 includes and/or is in communication with one or more input devices and/or sensors (e.g., a camera, a lidar detector, a motion sensor, an infrared sensor, a touch-sensitive surface, a physical input mechanism (such as a button or a slider), and/or a microphone). Such sensors can be used to detect presence of, attention of, statements from, inputs corresponding to, requests from, and/or instructions from a user in an environment. It should be recognized that, while some embodiments described herein refer to inputs being voice inputs, other types of inputs can be used with techniques described herein, such as touch inputs via a touch-sensitive surface and air gestures detected via a camera. In some embodiments, computer system 800 includes and/or is in communication with one or more output devices (e.g., a display screen, a projector, a touch-sensitive display, speaker, and/or a movement component). Such output devices can be used to present information and/or cause different visual changes of computer system 800. In some embodiments, computer system 800 includes and/or is in communication with one or more movement components (e.g., an actuator, a moveable base, a rotatable component, and/or a rotatable base). Such movement components, as discussed above, can be used to change a position (e.g., location and/or orientation) of computer system 800 and/or a portion (e.g., including one or more sensors, input components, and/or output components) of computer system 800. In some embodiments, computer system 800 includes one or more components and/or features described above in relation to computer system 100 and/or device 200. In some embodiments, computer system 800 includes one or more agents and/or functions of an agent as described above with respect to FIG. 5. In some embodiments, computer system 800 is, includes, implements, and/or is in communication with one or more agent systems, as described above with respect to FIG. 5, for performing (and/or causing performance of) one or more operations of an agent.

FIGS. 8A-8E illustrate a computer system 800 (e.g., a smartphone, a smartwatch, a television) that is in communication with one or more input devices (e.g., a camera, a depth sensor, and/or a microphone). Computer system 800 displays, via a display component (e.g., a display screen, a projector, and/or a touch-sensitive display), media content (e.g., movies, television shows, books, web pages, music, online content, and/or applications). Computer system 800 can detect inputs (e.g., verbal inputs, air gestures, and/or touch inputs,) via the one or more input devices. In the examples described below with respect to FIGS. 8A-8E, computer system 800 implements an agent (e.g., a virtual personal assistant) that can interact with a user and perform tasks. For example, in response to detecting a verbal input during media content, computer system 800 can display a representation (e.g., 816) of the agent that appears to respond to the verbal input. In the examples illustrated in FIGS. 8A-8E, the agent is represented as an avatar (e.g., 816) that is an animated face. As described in the examples of FIGS. 8A-8E, the agent can provide (e.g., via output devices of computer system 800) contextual information that is relevant to currently output (e.g., provided, displayed, and/or playing back) content in response to the verbal input (and/or in response to other types of input (e.g., physical input, contact input, non-contact input, and/or air gesture input).

In some embodiments, contextual information is background information related to (e.g., corresponding to, describing, about, and/or relevant to) (e.g., directly and/or indirectly) media content (and/or output media content). For example, contextual information can include background information corresponding to the history of the media content, commentary by individuals who worked on the creation of the media content (e.g., directors, actors, artists, and/or writers), background information corresponding to the making of the media content, trivia and/or facts corresponding to the media content, and/or any noteworthy details. In some embodiments, outputting contextual information does not include outputting metadata (e.g., playback position, media quality, and/or data corresponding to aspects of the currently playing media).

In some embodiments, a verbal input for contextual information can be a question. For example, “How did they make this movie?” In some embodiments, a verbal input for contextual information can be a declarative statement. For example, “This is a great movie.” In some embodiments, computer system 800 can detect an air gesture (e.g., via a camera) (and/or other type of input) instead of a verbal input for contextual information. For example, a point, a swipe, a tap, a wave, a hold, and/or a gaze input.

In some embodiments, computer system 800 outputs contextual information corresponding to the current playback position (e.g., a timestamp, and/or a particular moment in time corresponding to a media playback) of currently displayed media content. For example, if a verbal input is detected during a first scene of a movie, computer system 800 can output contextual information for the first scene of the movie. In this example, if computer system 800 detects verbal input during a third scene of a movie, computer system 800 can output contextual information for the third scene of the movie (e.g., different from the contextual information for the first scene). In some embodiments, computer system 800 outputs the same contextual information for inputs corresponding to a different playback positions. For example, if computer system 800 detects verbal input during a third scene of a movie, computer system 800 can output contextual information for the first scene of the movie (e.g., in a scenario in which the first and third scene are similar and/or share contextual information). In some embodiments, different media types result in different contextual information. For example, a verbal input directed to a movie media type can yield different contextual information than a music media type.

FIGS. 8A-8E each include two portions, a left portion and a right portion. The right portions of FIGS. 8A-8E illustrate a top-down schematic view 876 of a physical environment that includes computer system 800 that includes camera 806. The top-down schematic views of FIGS. 8A-8E illustrate field of view 804 of camera 806 of computer system 800. Field of view 804 is visually represented as the area between the dotted lines in 876. The top-down schematic view 876 can also include one or more users (e.g., 802) (e.g., users detected by computer system 800). The left portions of FIGS. 8A-8E illustrate output of a display in communication with computer system 800 (e.g., and represent what is currently being displayed by the display, such as media content 808 in FIG. 8A).

FIG. 8A illustrates computer system 800, which is displaying media content 808. In FIG. 8A, media content 808 is a movie. In some embodiments, computer system 800 displays and/or outputs other types of content (e.g., television shows, books, web pages, music, online content, and/or applications). Media content 808 includes title indicator 810, director indicator 812, and car indicator 814. Title indicator 810 indicates the title of the currently playing media (e.g., The Car Movie), director indicator 812 indicates the director of the currently playing media (e.g., Janet A.), and car indicator 814 indicates a car within the currently playing media. At FIG. 8A, computer system 800 outputs audio from media content 808 (e.g., a musical score of the movie). At FIG. 8A, computer system 800 detects verbal input 805a (e.g., “Wow! That scene was amazing!”) from user 802.

As illustrated in FIG. 8B, in response to detecting verbal input 805a, and based on a determination (e.g., by computer system 800 and/or one or more other computer systems in communication with computer system 800) that contextual information should be output, computer system 800 displays agent representation 816 overlaid on media content 808. In FIG. 8B, in response to detecting verbal input 805a, computer system 800 outputs audio output 818 that includes contextual information about media content 808 (e.g., “According to the director, it took ten attempts to film the big jump.”). In some embodiments, computer system 800 receives (e.g., retrieves, accesses, and/or downloads) the visual display of agent representation 816 and the audio output of any contextual information via a different media stream than the media stream of media content 808. In some embodiments, audio output 818 also includes an option (e.g., to the user) to access further contextual information (e.g., “Do you want to hear the director talk about the making of the scene?”). At FIG. 8B, computer system 800 detects verbal input 805b (e.g., “Yes I do.”) from user 802. In some embodiments, before detecting verbal input 805b, computer system 800 detects input representing a command to perform an operation (e.g., pause, rewind, and/or fast forward a media content item). In some embodiments, the input representing the command to perform the operation is a command to start content (e.g., play and/or initiate an output). For example, computer system 800 can detect a request to begin playback of the media content “The Car Movie” and, during playback, detect verbal input 805a and/or 805b (e.g., and in response provides contextual information about “The Car Movie”).

In some embodiments, while outputting contextual information, computer system 800 changes the displayed media. For example, while outputting contextual information, computer system 800 can, in response to detecting input, pause the displayed media, cease displaying the displayed media outright, shrink the displayed media, blur the displayed media, and/or mute the displayed media. In some embodiments, computer system 800 returns the displayed media to a previous state (e.g., normal playback) (e.g., once contextual information ceases to be output (e.g., output of contextual information ends) and/or in response to detecting input).

As illustrated in FIG. 8C, in response to detecting verbal input 805b, computer system 800 ceases to display media content 808 (e.g., including title indicator 810, director indicator 812, and car indicator 814) and displays context user interface 820 in its place. In some embodiments, computer system 800 displays context user interface 820 concurrently with media content 808 (e.g., media content 808 can be paused, reduced in size, and/or overlaid by context user interface 820). Context user interface 820 incudes agent representation 816 and name indicator 822. As illustrated in FIG. 8C, computer system 800 has changed the appearance of agent representation 816 as compared to FIG. 8B. In this example, agent representation 816 takes the form of a particular person, the director of media content 808. In FIG. 8C, name indicator 822 indicates the name corresponding to the currently displayed agent representation 816. Consistent with the information illustrated in FIGS. 8A and 8B (e.g., director indicator 812), computer system 800 displays agent representation 816 with the appearance of Janet A., the director of “The Car Movie”. Notably, in the example illustrated in FIG. 8C, the agent has taken on the appearance of a different personality and/or persona (e.g., character, subject, and/or user). Additionally, the agent can change other characteristics that correspond to (e.g., that mimic, are similar to, and/or are characteristics of) the persona (e.g., Janet A.), such as speech (e.g., voice, vocabulary, pace, and/or expressions) and/or mannerisms (e.g., gestures, cues, and/or facial movements). In some embodiments, agent representation 816 in FIG. 8C represents the same agent as agent representation 816 in FIGS. 8A and 8B (e.g., same agent but with a different persona). For example, a system agent can access and implement characteristics of the persona (e.g., accessed and/or provided via an application programming interface (API) and/or a database) (e.g., using a large language model (LLM) and/or other agent components of the system agent). In some embodiments, agent representation 816 in FIG. 8C represents a different agent as agent representation 816 in FIGS. 8A and 8B (e.g., a different agent with a different persona). For example, a system agent can “hand over” interactive functionality to a different software agent and/or corresponding application, which implements characteristics of the persona (e.g., using some or no agent components of the system agent).

As illustrated in FIG. 8C, while computer system 800 displays context user interface 820, computer system 800 outputs contextual information related to “The Car Movie” as audio output 828 (e.g., “I wanted this scene to be realistic so we filmed on location in San Diego, like my other two films, “The City” and “Hero Tale.”). In this example, the contextual information includes details regarding the creation of The Car Movie represented as media content 808. Notably, computer system 800 outputs contextual information related to the media content using an avatar with the personality and appearance of Janet. A. In some embodiments, computer system 800 displays the contextual information (e.g., displays a text that includes the contextual information (e.g., such as a transcription of audio output 828) (e.g., with or without also providing the contextual information as audio output (e.g., only transcription with no audio output))

In some embodiments, computer system 800 provides one or more indications of content related to the contextual information. For example, as illustrated in FIG. 8C, computer system 800 displays indications of content related to the contextual information: media indicator 824 and media indicator 826. Media indicator 824 indicates a media content item corresponding to (e.g., referenced by) the director (e.g., the movie “The City” that is referenced in audio output 828). Media indicator 826 indicates a media content item corresponding to the director (e.g., the movie “Hero Tale” that is referenced in audio output 828). In some embodiments, media indicator 824 and media indicator 826 can be output together with (e.g., in conjunction with, while, and/or after) the contextual information (represented as audio output 828) and/or agent representation 816. For example, media indicator 824 and media indicator 826 can be displayed concurrently with agent representation 816 (as illustrated in FIG. 8C) and/or not concurrently with agent representation (e.g., temporarily obscuring agent representation 816). Providing media indicators 824 and 826 can provide a user with additional contextual information relevant without interrupting the output of (e.g., as audio output) contextual information by computer system 800.

Notably, media indicator 824 and media indicator 826 can be considered visual representations of contextual information, and are output by computer system 800 concurrently with output of the contextual information represented by audio output 828. While the contextual information of media indicators 824 and 826 and the contextual information of audio output 828 are provided in response to a verbal input (e.g., verbal input 805b of FIG. 8B), computer system 800 displays media indicator 824 and media indicator 826 while audibly outputting an audio description.

At FIG. 8C, computer system 800 detects verbal input 805c (e.g., “Add those to my watchlist”). In some embodiments, verbal input 805c can be a gesture. For example, a touch, a point, a swipe, a tap, a wave, a hold, and/or a gaze.

In some embodiments, verbal input 805c is a request to download. In some embodiments, rather than display media indicator 824 and media indicator 826, computer system 800 can output an audio description corresponding to media indicator 824 and media indicator 826.

In some embodiments, in response to detecting input (e.g., 805c) that is directed to other content (e.g., content different than displayed content that has already had an operation performed on it), computer system 800 performs the same operation on the different content. For example, in a scenario where computer system 800 displays a music video media content concurrently with two television show media content items (e.g., that have been saved to a watchlist via verbal input) if computer system 800 detects a verbal input to add the music video content to a watchlist, in response to detecting a verbal input, computer system 800 can save the music video media content to a watchlist.

In some embodiments, in response to detecting input (e.g., 805c) that is directed to other content, computer system 800 can perform a different operation on the different content (e.g., different than an operation performed in response to detecting the same input directed to other content that is not the different content). For example, in a scenario where computer system 800 displays an indicator (e.g., 824 and/or 826) corresponding to a music video media content concurrently with indicators (e.g., 824 and/or 826) two television show media content items (e.g., that have been saved to a watchlist via verbal input) if computer system 800 detects a verbal input to add the music video content to a watchlist, in response to detecting a verbal input, computer system 800 can download the music video media content (e.g., instead of adding to the watchlist). This can be due to, for example, the different content being configured to correspond to different operations and/or the different content not being supported by operations for other media content (e.g., other types of media content) (e.g., music videos are not able to be added to a movie watchlist).

In some embodiments, computer system 800 detects a verbal input that is not directed to a media content item and, in response, does not perform an operation on that media content item. For example, in a scenario where computer system 800 is displaying an indicator (e.g., 824 and/or 826) of a music content item and an indicator (e.g., 824 and/or 826) of a movie content item, if computer system 800 detects input that is directed to the music content item, computer system 800 does not initiate an operation on the movie content item.

In some embodiments, computer system 800 can display a visual confirmation in response to detecting verbal input 805c and/or performing the operation in response to detecting verbal input 805c. As illustrated in FIG. 8D, in response to detecting verbal input 805c, computer system 800 displays confirmation indicator 824a as overlaid on media indicator 824 and confirmation indicator 826a as overlaid on media indicator 826. Confirmation indicator 824a indicates that computer system 800 has added media indicator 824 to a watchlist. Confirmation indicator 826a indicates that computer system 800 has added media indicator 826 to a watchlist. In some embodiments, verbal input 805c is (and/or includes) a non-verbal input. For example, computer system 800 can perform the same operation in response to detecting a non-verbal input such as a non-contact input. For example, computer system 800 can add media indicator 824, and media indicator 826 to a watchlist in response to detecting an air gesture, a point, a swipe, a tap, a wave, a hold, and/or a gaze.

In the example of FIG. 8D, confirmation indicators are displayed as badges that partially overlay respective content, and that include graphics and text to indicate that the operation was successful. In some embodiments, confirmation indicator (e.g., 824a and/or 826a) includes one or more types of indications and/or output. For example, computer system 800 can outline media indicator 824, and media indicator 826 with a glow, a highlight, and/or a badge. In some embodiments, computer system 800 can output a haptic output in response to detecting verbal input 805c. For example, a vibration, an audible alert, and/or a buzz.

In some embodiments, confirmation indicator 824a and confirmation indicator 826a include and/or are displayed concurrently with a visual representation of the media content item. For example, in FIG. 8D computer system 800 displays visual representations (e.g., media indications 824 and 826) in addition to 824a and 826a). Examples of visual representations of media content items include cover art, title, packaging, a screenshot, a promotional image, a page and/or portion of the media content item, a logo, and/or visual content that is used to represent the media item).

As illustrated in FIG. 8D, computer system 800 continues to output contextual information related to “The Car Movie” as audio output 830 (e.g., “The scene includes three parts, the last being the big car jump”) despite a user interrupting the output of contextual information with verbal input (e.g., verbal input 805c). In this example, as computer system 800 outputs contextual information, computer system 800 does not modify the output of contextual information when an interruption is detected. For example, computer system 800 does not lower the volume of audio output 830 and/or does not diminish the size of agent representation 816 in response to an interruption. This allows a user to freely interact with computer system 800 while contextual information is output. In some embodiments, in response to detecting an interruption, computer system 800 continues to output contextual information and one or more aspects of the output of contextual information (e.g., shrinks agent representation 816 but does not lower the volume of audio output 828 and/or 830). In some embodiments, in response to detecting an interruption, computer system 800 ceases to output the contextual information. At FIG. 8D, computer system 800 detects verbal input 805d (e.g., “Why?”).

In some embodiments, in response to detecting verbal input 805c, computer system 800 can “hand back” to the agent associated with agent representation 816 of FIG. 8B to acknowledge the verbal input. For example, in the example of FIG. 8C described above, in response to detecting verbal input 805c, computer system 800 can temporarily change agent representation 816 from the appearance of the director back to the standard appearance (e.g., of the system agent representation 816 as illustrated in FIG. 8A) to acknowledge verbal input 805c rather than display confirmation indicators. In some embodiments, computer system 800 performs an indication that agent representation 816 is about to change (e.g., a spin, and/or a rotation) to hand over between different agents and/or between different personas and/or personalities.

As illustrated in FIG. 8E, in response to detecting verbal input 805d, computer system 800 outputs contextual information as a response to verbal input 805d through audio output 830 (e.g., “The scene is composed of three parts because . . . ”).

In some embodiments, a verbal input can call a transparent (e.g., nonvisible, hidden, and/or obscured) agent with displayed media content. For example, in a scenario in which computer system 800 is displaying movie media content without displaying an agent, in response to detecting a verbal input, computer system 800 can use an agent to interact with a user and/or displayed media content without displaying a representation (e.g., 816) of the agent. In some embodiments, the same verbal input initiates the same agent display operation across different media content types. In some embodiments, a verbal input can cause an agent to continue to be displayed. In some embodiments, a verbal input can cause an operation to be performed without displaying an agent.

In some embodiments, a verbal input not directed to an agent will not cause an agent to be involved while computer system 800 performs an operation. The operation can be a visual operation and/or the operation can be an audio operation. In some embodiments, in response to a verbal request, computer system 800 can output an audio only response (e.g., as if the agent is answering).

In some embodiments, a response to detecting a verbal input includes audio output other than the agent. In some embodiments, a response to detecting a verbal input includes visual content other than the agent. In some embodiments, a response to detecting a verbal input includes moving the agent.

In some embodiments, when a user is interacting with an agent, computer system 800 can display an indication corresponding to an agent to indicate that the agent is listening, thinking, and/or initiating a response. For example, computer system 800 can display an agent in different manners to indicate that an input is being detected (e.g., a face appearing as if listening intently, a static display, an ear, and/or a swirling icon).

FIG. 9 is a flow diagram illustrating a process (e.g., process 900) for providing playback location dependent information in accordance with some embodiments. Some operations in process 900 are, optionally, combined, the orders of some operations are, optionally, changed, and some operations are, optionally, omitted.

As described below, process 900 provides an intuitive way for providing playback location dependent information. Process 900 reduces the cognitive burden on a user for being provided playback location dependent information, thereby creating a more efficient human-machine interface. For battery-operated computing devices, enabling a user to be provided playback location dependent information faster and more efficiently conserves power and increases the time between battery charges.

In some embodiments, process 900 is performed at a computer system (e.g., 100, 200, and/or 800) that is in communication with one or more input devices (e.g., 140 and/or 200-14) (e.g., a camera, a depth sensor, and/or a microphone) and one or more output devices (e.g., 140 and/or 200-16) (e.g., a speaker, a haptic output device, a display screen, a projector, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device.

While playing back media content (e.g., 810, 812, and/or 814), the computer system detects (902), via the one or more input devices, a non-contact input (e.g., 805a, 805b, and/or 805d) (e.g., from a user) (e.g., an input that does not include (e.g., require and/or depend on) a contacting (e.g., a touch on and/or physical manipulation of) a physical input device) (e.g., a verbal input and/or an air gesture) that corresponds to (e.g., is directed to, is selection of, is pointed in a direction of (e.g., a direction of a representation of), includes reference to, mentions, names, identifies, and/or is configured to be associated with) the media content (e.g., as described in above in FIG. 8A).

In response to (904) detecting the non-contact input (e.g., 805a) that corresponds to the media content, in accordance with a determination that playback of the media content (e.g., “The Car Movie” of FIG. 8A, including 810, 812, and/or 814) is at a first playback position (e.g., elapsed time, progress state, chapter, and/or scene), the computer system outputs (906), via the one or more output devices, first information (e.g., 816, 818, 828, and/or 830) corresponding to (e.g., describing, relating to, derived from, included in, included with, related to, and/or supplemental to) the media content, wherein the first information does not include an indication of the first playback position (e.g., as described above with respect to FIGS. 8A-8B) (e.g., first information is not the current elapsed time, progress, chapter, and/or scene). In some embodiments, the first information includes the indication of the first playback position. In some embodiments, the first information is based on the non-contact input such that the computer system outputs different information in response to detecting different non-contact inputs.

In response to (904) detecting the non-contact input that corresponds to the media content, in accordance with a determination that playback of the media content (e.g., 810, 812, and/or 814) is at a second playback position different from the first playback position, the computer system outputs (908), via the one or more output devices, second information (e.g., similar to 818, 828, and/or 830) corresponding to (e.g., describing, relating to, derived from, included in, included with, related to, and/or supplemental to) the media content, wherein the second information is different from the first information, and wherein the second information does not include an indication of the second playback position (e.g., as described above with respect to FIGS. 8A-8B) (e.g., second information is not the current elapsed time, progress, chapter, and/or scene). In some embodiments, the second information includes the indication of the second playback position. In some embodiments, the second information is based on the non-contact input such that the computer system outputs different information in response to detecting different non-contact inputs. Depending on a current playback position (e.g., the first or second playback position) of the media content, outputting different information in response to detecting the non-contact input allows the computer system to respond with information relevant and/or corresponding to a current playback position, thereby providing improved feedback to a user and/or performing an operation when a set of conditions has been met without requiring further input.

In some embodiments, the first information (e.g., 816 and/or 818) includes first contextual information corresponding to the first playback position (e.g., based on scene of the media content (e.g., actors in the scene of the media content, location of the media content, and/or any other related information of the scene) and/or intent of input (e.g., ask a question and/or gives statement)) (e.g., and not corresponding to the second playback position and/or another playback position different from the second playback position). In some embodiments, the second information includes second contextual information corresponding to the second playback position (e.g., as described above with respect to FIGS. 8B-8C) (e.g., and not corresponding to the first playback position and/or another playback position different from the first playback position). In some embodiments, the first contextual information corresponds to another playback position (e.g., within a predefined amount before the first playback position) in proximity to the first playback position (e.g., the other playback position is before the first playback position). In some embodiments, the second contextual information corresponds to another playback position (e.g., within a predefined amount before the second playback position) in proximity to the second playback position (e.g., the other playback position is before the second playback position). In some embodiments, the second contextual information is the same as the first contextual information. The first information including first contextual information corresponding to the first playback position and the second information including second contextual information corresponding to the second playback position allows the computer system to provide information that is relevant to the playback position of the media content at the time the non-contact input is detected, thereby providing improved feedback to the user and/or performing an operation when a set of conditions has been met without requiring further input.

In some embodiments, after (and/or while) outputting the first information (e.g., 818) corresponding to the media content, the computer system detects an input (e.g., 805b) (e.g., a verbal input (e.g., a verbal utterance, a sound, an audible request, an audible command, and/or an audible statement) and/or a non-verbal input (e.g., a swipe input, a hold-and-drag input, a gaze input, an air gesture, and/or a mouse click)) (e.g., to show more information on the first information and/or to explain the first information further) that corresponds to the first information (e.g., 816 and/or 818)(e.g., the first contextual information). In some embodiments, the input, which corresponds to the first information, corresponds to a question with respect to the first information. In some embodiments, in response to detecting the input that corresponds to the first information (e.g., 805b), the computer system outputs, via the one or more output devices, additional information (e.g., 828) (e.g., corresponding to the first information, the first playback position, another playback position different from the first playback position, and/or the media content) (e.g., additional contextual information) different from the first information (e.g., as described above in FIG. 8C). In some embodiments, after outputting the second information corresponding to the media content, the computer system detects an input that corresponds to the second information. In some embodiments, in response to detecting the input that corresponds to the second information, the computer system outputs, via the one or more output devices, other information (e.g., corresponding to the second information, the second playback position, another playback position different from the second playback position, and/or the media content) (e.g., additional other information) different from the second information and/or the additional information. Outputting additional information in response to detecting the input that corresponds to the first information allows the computer system to provide more information when requested, thereby providing improved feedback to a user and/or providing additional control options without cluttering the user interface with additional displayed controls.

In some embodiments, the non-contact input (e.g., 805a) that corresponds (e.g., includes a reference to, describes, relating to, included in, included with) to the media content includes (and/or is) verbal input (e.g., 805a) (e.g., as described above with respect to FIG. 8A) (e.g., an audible request, an audible command, and/or an audible statement). The non-contact input corresponding to the media content including verbal input provides the computer system with increased flexibility and/or accessibility in receiving communication from a user and/or enables the computer system to perform an operation based on audio, thereby reducing the number of inputs needed to perform an operation, providing additional control options without cluttering the user interface with additional displayed controls, and/or performing an operation when a set of conditions has been met without requiring further user input.

In some embodiments, the verbal input (e.g., 805a) includes (and/or is) a statement (and/or a declarative sentence) (e.g., stating a fact and/or does not include a question, a request, and/or a command) that corresponds to (e.g., that includes a reference to, that describes, that relates to, and/or associated with) the media content (e.g., as described above with respect to FIG. 8A) (e.g., “this scene is intense”, “that background looks familiar”, and/or “I like the song that's playing right now”). The verbal input including a statement that corresponds to the media content allows a user to communicate with a statement to the computer system and the computer system inferring from the statement with respect to information to output, thereby providing improved feedback to the user and/or performing an operation when a set of conditions has been met without requiring further input.

In some embodiments, the verbal input (e.g., 805a) includes (and/or is) a question (e.g., 805d) (e.g., “what song is playing right now?”, “how did the director think of this scene?”, “can you give me more information on this scene?”, and/or “where is this background?’) that corresponds to the media content (e.g., as described above in FIG. 8D). The verbal input including a question allows a user to be able to communicate with the computer system with a question corresponding to the media content, thereby providing improved feedback to the user and/or performing an operation when a set of conditions has been met without requiring further input.

In some embodiments, the non-contact input (e.g., 805a) that corresponds to the media content includes (and/or is) an air gesture (e.g., a hand input to pick up, a hand input to press, an air tap, an air swipe, and/or a clench and hold air input). The non-contact input including an air gesture provides the computer system with increased flexibility and/or accessibility in receiving communication from a user and/or enables the computer system to perform an operation based on a non-audio input, thereby reducing the number of inputs needed to perform an operation, providing additional control options without cluttering the user interface with additional displayed controls, and/or performing an operation when a set of conditions has been met without requiring further user input.

In some embodiments, the first playback position is within a first portion that includes a first plurality of playback positions. In some embodiments, the second playback position is within a second portion (e.g., different from the first portion) that includes a second plurality of playback positions different from the first plurality of playback positions (e.g., as described above with respect to FIGS. 8A-8B) (e.g., different range of time, chapters, scenes, and/or segments of the media content). In some embodiments, while playing back the media content, the computer system detects, via the one or more input devices, another input (e.g., another non-contact input) (e.g., different from the non-contact input) that corresponds to the media content. In some embodiments, in response to detecting the other input and in accordance with a determination that playback of the media content is at a third playback position different from the first playback position and the second playback position, the computer system outputs, via the one or more output devices, the first information. In some embodiments, in response to detecting the non-contact input that corresponds to the media content and in accordance with a determination that playback of the media content is at the third playback position, the computer system outputs, via the one or more output devices, the first information. In some embodiments, in response to detecting the other input and in accordance with a determination that playback of the media content is at a fourth playback position different from the first playback position and the second playback position, the computer system outputs, via the one or more output devices, the second information. In some embodiments, in response to detecting the non-contact input that corresponds to the media content and in accordance with a determination that playback of the media content is at the fourth playback position, the computer system outputs, via the one or more output devices, the second information. The first playback position being within a first portion that includes a first plurality of playback positions and the second playback position being within a second portion that includes a second plurality of playback positions different from the first plurality of playback positions allows the computer system to respond with information relevant to a portion that is currently being played back (e.g., rather than a single playback position and/or a portion that is not currently being played back), thereby providing improved feedback to the user and/or performing an operation when a set of conditions has been met without requiring further input.

In some embodiments, the one or more output devices includes a first display component (e.g., 140 and/or 200-16). In some embodiments, the media content is a first media content (e.g., 810, 812, and/or 814). In some embodiments, outputting the first information (e.g., 816 and/or 818) corresponding to the first media content includes displaying, via the first display component, second media content (e.g., 810, 812, and/or 814) corresponding to the first information. In some embodiments, the second media content is different from the first media content (e.g., as described above with respect to FIGS. 8A-8B). In some embodiments, outputting the second information corresponding to the first media content includes displaying, via the first display component, third media content corresponding to the second information. In some embodiments, the third media content is different from the first media content and/or the second media content. In some embodiments, the first media content is still output while the second media content is displayed. In some embodiments, the first media content is no longer output while the second media content is displayed. Outputting the first information corresponding to the first media content including displaying second media content corresponding to the first information allows the computer system to provide different media content to supplement the first media content, thereby providing improved feedback to a user, reducing the number of inputs needed to perform an operation, and/or performing an operation when a set of conditions has been met without requiring further input.

In some embodiments, the one or more output devices includes one or more audio output components (e.g., smart speakers, home theater system, soundbars, headphones, earphones, earbuds, speakers, television speakers, augmented reality headset speakers, audio jacks, optical audio output, Bluetooth audio outputs, and/or HDMI audio outputs). In some embodiments, outputting the first information (e.g., 818) corresponding to the media content includes providing, via the one or more audio output components, an audio output (e.g., as shown by 818, 828, and 830 as described above with respect to FIGS. 8B-8C) (e.g., music, sounds and/or speech) (e.g., corresponding to the first information). In some embodiments, the media content ceases playing back while providing, via the one or more audio output components, the audio output corresponding to the first information. In some embodiments, the media content continues playing back (e.g., with no audio output corresponding to the media content, with visual output corresponding to the media content only, and/or with audio output corresponding to the media content at a lower volume) while providing, via the one or more audio output components, the audio output corresponding to the first information. Outputting the first information corresponding to the media content including providing an audio output allows the computer system to verbally output contextual information, thereby providing improved feedback to a user, reducing the number of inputs needed to perform an operation, and/or performing an operation when a set of conditions has been met without requiring further input.

In some embodiments, the one or more output devices includes one or more display components (e.g., a display screen, a projector, and/or a touch-sensitive display). In some embodiments, outputting the first information (e.g., 818) corresponding to the media content includes displaying, via the one or more display components, a visual output (e.g., 816) (e.g., as described above with respect to FIG. 8B) (e.g., video, image, animation, subtitles, 3D rendering, augmented reality overlay, motion graphics, data visualization, digital art, etc.) (e.g., corresponding to the first information) (e.g., playback of the file, video commentary, and/or directors cut corresponding to the first information). In some embodiments, the media content ceases playing back (e.g., while still being displayed (e.g., the media content is paused and/or the media content is displayed with less emphasis or a smaller size) and/or while no longer being displayed) while displaying the visual output. In some embodiments, media content continues playing back (e.g., with less emphasis and/or at a smaller size) while displaying the visual output. Outputting the first information corresponding to the media content including displaying visual output allows the computer system to visually output contextual information, thereby providing improved visual feedback to a user, reducing the number of inputs needed to perform an operation, and/or performing an operation when a set of conditions has been met without requiring further input.

In some embodiments, the media content is being played back with a first output characteristic representing normal playback (e.g., for audio output (e.g., volume, equalization, spatialization, and/or direction) and/or for visual output (e.g., size, position, coloring, and/or visual filtering)) before detecting the non-contact input (e.g., 805a) that corresponds to the media content. In some embodiments, in response to detecting the non-contact input (e.g., 805a) and in accordance with a determination that playback of media content is at the first playback position, the computer system changes the first output characteristic to a second output characteristic (e.g., a second volume lower than a first volume, a second playback speed that is slower than a first playback speed, a second size smaller than a first size, a second emphasis less than a first emphasis, audio content is paused, and/or visual content is paused) different from the first output characteristic (e.g., as described above with respect to FIGS. 8A-8B). In some embodiments, in response to detecting the non-contact input and in accordance with a determination that playback of the media content is at the second playback position, changing the first output characteristics to another output characteristic (e.g., the other output characteristic is the same as and/or different from the second output characteristic) different from the first output characteristic. In some embodiments, changing the first output characteristic to the second output characteristic occurs while outputting the first information. In some embodiments, changing the first output characteristic to the second output characteristic occurs before outputting the first information. Changing the first output characteristic to a second output characteristic in response to detecting the non-contact input allows the computer system to provide the user with feedback that first information is being output, thereby providing improved feedback to a user, reducing the number of inputs needed to perform an operation, and/or performing an operation when a set of conditions has been met without requiring further input.

In some embodiments, changing the first output characteristic to the second output characteristic includes pausing playback of the media content (e.g., as described above with respect to FIGS. 8A-8B). In some embodiments, changing the first output characteristic to the second output characteristic includes changing how the media content is displayed (e.g., with less emphasis and/or a smaller size). In some embodiments, changing the first output characteristic to the second output characteristic includes computer system 800 ceases display of the media content. Changing the first output characteristic to the second output characteristic including pausing playback of the media content allows the computer system to reduce visual and/or auditory distractions while outputting the first information corresponding to the first playback position and/or providing a user with feedback that first information is being output, thereby providing improved feedback to a user, reducing the number of inputs needed to perform an operation, and/or performing an operation when a set of conditions has been met without requiring further input.

In some embodiments, changing the first output characteristic to the second output characteristic includes computer system 800 ceases display of the media content (e.g., as described above with respect to FIGS. 8B-8C) (e.g., while and/or after pausing the media content playback and/or changing the audio output). In some embodiments, the media content and the first information is displayed in a user interface, where the media content is replaced by the first information in response to detecting the non-contact input and in accordance with a determination that playback of the media content is at the first playback position. In some embodiments, the media content is displayed in a first user interface and the first information is displayed in a second user interface different from the first user interface. Changing the first output characteristic to the second output characteristic includes computer system 800 ceases display of the media content allows the computer system to reduce visual distractions while outputting the first information, thereby providing improved visual feedback to a user, reducing the number of inputs needed to perform an operation, and/or performing an operation when a set of conditions has been met without requiring further input.

In some embodiments, after changing the first output characteristic to the second output characteristic, the computer system detects a request to cease display of the first information (e.g., 816 and/or 818) (and/or continue playback of the media content) (and/or change focus to playback of the media content (e.g., rather than to the first information)). In some embodiments, in response to (and/or after) detecting the request to cease display of the first information (e.g., 818) (and/or continue playback of the media content) (and/or change focus to playback of the media content) (e.g., rather than to the first information), the computer system changes the second output characteristic to a third output characteristic (e.g., the first output characteristic) (e.g., representing normal playback (e.g., normal volume, normal playback speed, normal size, and/or normal emphasis)) different from the second output characteristic (e.g., as described above with respect to FIGS. 8A-8C). In some embodiments, the third output characteristic is the same as the first output characteristic. In some embodiments, the third output characteristic is different from the first output characteristic. In some embodiments, playing back the media content with the third output characteristic includes re-displaying the media content. In some embodiments, playing back the media content with the third output characteristic includes re-playing the media content. Changing the second output characteristic to the third output characteristic in response to detecting the request to cease display of the first information allows the computer system to provide feedback that output of the first information is completed and/or allows the computer system to automatically continue playing back the media content at a normal playback after output of the first information is completed, thereby providing improved feedback to a user, reducing the number of inputs needed to perform an operation, and/or performing an operation when a set of conditions has been met without requiring further input.

In some embodiments, the first information (e.g., 816 and/or 818) (and/or the second information) corresponding to the media content does not include an indication of metadata (e.g., output of information regarding one or more attributes of the media content (e.g., chapter number, playback time, and/or name of the media content)) of the media content. In some embodiments, the first information includes the indication of metadata of the media content. The first information corresponding to the media context not including an indication of metadata of the media context allows the computer system to provide contextual information that is not merely metadata of the media content, thereby providing improved feedback to a user.

In some embodiments, the one or more output devices includes an audio generation component (e.g., smart speaker, home theater system, soundbar, headphone, earphone, earbud, speaker, television speaker, augmented reality headset speaker, audio jack, optical audio output, Bluetooth audio output, and/or HDMI audio output). In some embodiments, playing back the media content includes outputting, via the audio generation component, audio content (e.g., 818) (e.g., as described above with respect to FIGS. 8B-8E) (e.g., music and/or speech). In some embodiments, audio content continues being output when outputting the first information and/or the second information. In some embodiments, audio content stops when outputting the first information and/or the second information. Playing back the media content including outputting audio content allows the computer system to provide information for media content that includes an audio portion, thereby providing improved feedback to the user and/or performing an operation when a set of conditions has been met without requiring further input.

In some embodiments, the one or more output devices includes a display component (e.g., a display screen, a projector, and/or a touch-sensitive display). In some embodiments, playing back the media content includes displaying, via the display component, visual content (e.g., 816 and/or 818) (e.g., as described above with respect to FIGS. 8A-8C) (e.g., text, video, image, animations, 3D rendering, augmented reality overlay, motion graphics, data visualization, and/or digital art). In some embodiments, visual content continues being displayed when outputting the first information and/or the second information. In some embodiments, visual content stops being displayed and/or is paused when outputting the first information and/or the second information. Playing back the media content including displaying visual content allows the computer system to provide information for media content that includes a visual portion, thereby providing improved feedback to the user and/or performing an operation when a set of conditions has been met without requiring further input.

In some embodiments, before playing back the media content, the computer system detects, via the one or more input devices, a second input (e.g., a verbal input (e.g., a verbal utterance, a sound, an audible request, an audible command, and/or an audible statement) and/or a non-verbal input (e.g., a swipe input, a hold-and-drag input, a gaze input, an air gesture, and/or a mouse click)) corresponding to a request to initiate playback of the media content (e.g., as described above with respect to FIGS. 8B-8C). In some embodiments, in response to detecting the second input, the computer system initiates playback of the media content (e.g., as described above with respect to FIGS. 8B-8C). In some embodiments, in response to detecting a third input corresponding to the first information and/or the second information (e.g., input to interact with the first information and/or the second information and/or input to initiate new content), the computer systems initiates playback of another media content different from the media content. In some embodiments, in response to detecting a fourth input in conjunction with outputting the first information and/or the second information, the computer system initiates playback of another media content different from the media content, the first information, and/or the second information. In some embodiments, in response to detecting a fifth input corresponding to the media content in conjunction with outputting the first information and/or the second information, the computer system returns to normal playback of the media content. Initiating playback of the media content in response to detecting the second input allows the computer system to initiate playback when an input is detected, thereby providing improved feedback to a user and/or performing an operation when a set of conditions has been met without requiring further user input.

In some embodiments, in response to detecting the non-contact input (e.g., 805a) that corresponds to the media content and in accordance with a determination that playback of the media content is at a third playback position (e.g., elapsed time, progress state, chapter, and/or scene) different from the first playback position and the second playback position, the computer system outputs, via the one or more output devices, third information corresponding (e.g., describing, relating to, derived from, included in, included with, related to, and/or supplemental to) to the media content (e.g., as described above with respect to FIGS. 8A-8B), wherein the third information is different from the first information (e.g., 818) and the second information. Outputting third information corresponding to the media content in response to detecting the non-contact input that corresponds to the media content and in accordance with a determination that playback of the media content is at a third playback position allows the computer system to output different information for different playback positions, thereby providing improved feedback to a user and/or performing an operation when a set of conditions has been met without requiring further user input.

In some embodiments, in response to detecting the non-contact input (e.g., 805a) that corresponds to the media content and in accordance with a determination that playback of the media content is at a fourth playback position (e.g., elapsed time, progress state, chapter, and/or scene) different from the first playback position and the second playback position (e.g., and/or the third playback position), the computer system outputs, via the one or more output devices, the first information (e.g., 818) corresponding to the media content (e.g., as described above with respect to FIGS. 8A-8B). In some embodiments, the fourth playback position has the same context as the first playback position. In some embodiments, the fourth playback position is included in a plurality of playback positions that also includes the first playback position that will output the same information when a non-contact input is detected. Outputting the first information corresponding to the media content in response to detecting the non-contact input that corresponds to the media and in accordance with a determination that playback of the media content is at a fourth playback position allows the computer system to respond with the same information corresponding to the media at different playback times, providing improved feedback to the user and/or performing an operation when a set of conditions has been met without requiring further input.

In some embodiments, the media content is a third media content. In some embodiments, while playing back fourth media content different from the third media content, the computer system detects, via the one or more input devices, a second non-contact input different (e.g., separate) from the first non-contact input (e.g., 805a) that corresponds to the fourth media content. In some embodiments, the second non-contact input is the same as the first non-contact input but while different media content is being played back. In some embodiments, in response to detecting the second non-contact input that corresponds to the fourth media content, in accordance with a determination that playback of the fourth media content is at the first playback position, the computer system outputs, via the one or more output devices, fourth information corresponding to (e.g., describing, relating to, derived from, included in, included with, related to, and/or supplemental to) the fourth media content, wherein the fourth information is different from the first information (e.g., 818) and the second information (e.g., as described above with respect to FIGS. 8A-8B). In some embodiments, the fourth information does not include an indication of the first playback position (e.g., the fourth information is not the current elapsed time, progress, chapter, and/or scene). In some embodiments, in response to detecting the second non-contact input that corresponds to the fourth media content, in accordance with a determination that playback of the fourth media content is at the second playback position, the computer system outputs, via the one or more output devices, fifth information corresponding to (e.g., describing, relating to, derived from, included in, included with, related to, and/or supplemental to) the fourth media content, wherein the fifth information is different from the fourth information, the first information, and the second information (e.g., as described above with respect to FIGS. 8A-8B). In some embodiments, the fifth information does not include an indication of the second playback position (e.g., the fifth information is not the current elapsed time, progress, chapter, and/or scene). Outputting different information for different media content at the same playback positions allows the computer system to output relevant information to what is being played back, thereby providing improved feedback to a user and/or performing an operation when a set of conditions has been met without requiring further input.

Note that details of the processes described above with respect to process 900 (e.g., FIG. 9) are also applicable in an analogous manner to other processes described herein. For example, process 1000 optionally includes one or more of the characteristics of the various processes described above with reference to process 900. For example, the outputted first media content of process 1000 can be the playing back media content of process 900. For brevity, these details are not repeated below.

FIG. 10 is a flow diagram illustrating a process (e.g., process 1000) for performing an operation without interrupting playback in accordance with some embodiments. Some operations in process 1000 are, optionally, combined, the orders of some operations are, optionally, changed, and some operations are, optionally, omitted.

As described below, process 1000 provides an intuitive way for performing an operation without interrupting playback. Process 1000 reduces the cognitive burden on a user for causing performance of an operation without interrupting playback, thereby creating a more efficient human-machine interface. For battery-operated computing devices, enabling a user to cause performance of an operation without interrupting playback faster and more efficiently conserves power and increases the time between battery charges.

In some embodiments, process 1000 is performed at a computer system (e.g., 100, 200 and/or 800) that is in communication with one or more input devices (e.g., 140 and/or 200-14) (e.g., a camera, a depth sensor, and/or a microphone) and one or more output devices (e.g., 140 and/or 200-16) (e.g., a speaker, a haptic output device, a display screen, a projector, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device.

While outputting, via the one or more output devices, first content (e.g., 816 and/or 828 of FIG. 8C) (e.g., playback of content, a transcription of content, an output of an agent, media content, and/or audio), the computer system detects (1002), via the one or more input devices, a first input (e.g., 805c) (e.g., from a user) (e.g., a tap input and/or a non-tap input (e.g., a verbal input, an audible request, an audible command, an audible statement, a swipe input, a hold-and-drag input, a gaze input, an air gesture, and/or a mouse click)) corresponding to (e.g., in a direction of, that references, and/or at a location of) a first portion of the first content (e.g., as described above with respect to FIG. 8C).

While continuing outputting the first content, in response to detecting the first input (e.g., 805c), and in accordance with a determination that the first input corresponds to (e.g., in a direction of, that references, and/or at a location of) first media content (e.g., represented by 824) referenced (e.g., 824) in (e.g., displayed in, included in, identified in, mentioned in, represented in, and/or uttered in) the first portion of the first content, the computer system performs (1004) an operation (e.g., adds to watchlist in FIG. 8D) corresponding to the first media content (e.g., involving, with respect to, and/or using) (e.g., saves the first media content, stores the first media content, downloads the first media content, and/or outputs a portion of the first media content), wherein the first media content is different from the first content (e.g., as described above with respect to FIG. 8D). Performing an operation corresponding to the first media content in response to detecting the first input and in accordance with a determination that the first input corresponds to the first media content referenced in the first portion of the first media content while continuing outputting the first content allows the computer system to provide a seamless user experience by performing an action requested by a user without interrupting the first content, thereby providing improved feedback to the user, reducing the number of inputs needed to perform an operation, providing additional control options without cluttering the user interface with additional displayed controls, and/or performing an operation when a set of conditions has been met without requiring further input.

In some embodiments, continuing outputting the first content includes maintaining at least one aspect of outputting the first content (e.g., 816 and audio output are not affected in FIGS. 8C-8D) (e.g., as described above with respect to FIGS. 8C-8D) (e.g., not reducing an audio volume of the first content and/or not reducing a display size of output of the first content) (e.g., in response to detecting the first input and/or performing the operation corresponding to the first media content). In some embodiments, before detecting the first input, the computer system outputs, via the one or more output devices, the first content with a set of one or more output characteristics (e.g., for audio output: volume, equalization, spatialization, and/or direction) (e.g., for visual output: size, position, coloring, and/or visual filtering). In some embodiments, in response to detecting the first input, the computer system m continues outputting the first media content with at least one output characteristic of the set of one or more output characteristics (e.g., while performing the operation corresponding to the first media content) (e.g., not reducing the audio volume and/or not reducing the display size). In some embodiments, in response to detecting the first input, the computer system (1) maintains at least one output characteristic of the set of one or more output characteristics and (2) changes at least one output characteristic of the set of one or more output characteristics. Continuing outputting the first content including maintaining at least one aspect of outputting the first content allows the computer system to provide a seamless user experience by performing an action requested by a user without interrupting the first content, thereby providing improved feedback to the user, reducing the number of inputs needed to perform an operation, and/or performing an operation when a set of conditions has been met without requiring further input.

In some embodiments, continuing outputting the first content includes changing, via the one or more output devices, an aspect of outputting the first content (e.g., as described above with respect to FIGS. 8C-8D) (e.g., reducing an audio volume of the first content, reducing a display size of output of the first content, changing an appearance of an avatar that is included in and/or displayed with the first content, and/or changing a size of a user-interface element from a first size to a second size different from (e.g., smaller or bigger than) the first size) (e.g., in response to detecting the first input and/or performing the operation corresponding to the first media content). Continuing outputting the first content including changing an aspect of outputting the first content allows the computer system to provide feedback to a user that an input was detected and/or that an operation is about to be and/or is being performed, thereby providing improved feedback to the user, reducing the number of inputs needed to perform an operation, and/or performing an operation when a set of conditions has been met without requiring further input.

In some embodiments, the one or more output devices includes a first display component (e.g., 140 and/or 200-16). In some embodiments, performing the operation corresponding to the first media content includes outputting, via the first display component, a visual confirmation of the operation (e.g., 824a and 826a) (e.g., as described above with respect to FIGS. 8C-8D) (e.g., text, movement of an avatar, image, animation, 3D rendering, augmented reality overlay, motion graphics, data visualization, digital art, highlight, glow, and/or badge). In some embodiments, performing the operation corresponding to the first media content includes outputting an audio confirmation of the operation (e.g., audio sound and/or audio speech). Performing the operation corresponding to the first media content including outputting a visual confirmation of the operation allows the computer system to enhance user engagement by providing visual feedback that operation will be, is, and/or has been performed, thereby providing improved feedback to a user, reducing the number of inputs needed to perform an operation, and/or performing an operation when a set of conditions has been met without requiring further input.

In some embodiments, the visual confirmation includes (and/or is displayed near, within a predefined distance of, and/or at least partially on top of) a representation (e.g., title and/or image) of the first media content (e.g., 824 and 826) (e.g., as described above with respect to FIG. 8D). The visual confirmation including a representation of the first media content allows the computer system to provide feedback that the operation performed and/or being performed corresponds to the first media content, thereby providing improved feedback to a user, reducing the number of inputs needed to perform an operation, and/or performing an operation when a set of conditions has been met without requiring further input.

In some embodiments, the one or more output devices includes a set of one or more audio generation components (e.g., speakers outputting audio output 828 and audio output 830) (e.g., as described above with respect to FIGS. 8C-8D) (e.g., smart speakers, home theater system, soundbars, headphones, earphones, earbuds, speakers, television speakers, augmented reality headset speakers, audio jacks, optical audio output, Bluetooth audio outputs, and/or HDMI audio outputs). In some embodiments, outputting the first content includes outputting, via the set of one or more audio generation components, audio (e.g., 828 and 830) (e.g., a soundtrack, music, and/or dialogue) (e.g., before, while, and/or after detecting the first input) (e.g., before, while, and/or after performing the operation corresponding to the first media content). Outputting the first content including outputting audio allows the computer system to maintain audio during a process for performing an operation, thereby providing improved feedback to a user and/or performing an operation when a set of conditions has been met without requiring further input.

In some embodiments, the one or more output devices includes a second display component (e.g., a display screen, a projector, and/or a touch-sensitive display). In some embodiments, outputting the first content includes displaying, via the display component, visual content (e.g., 816, 824, and/or 826) (e.g., as discussed above with respect FIGS. 8C-8D) (e.g., video, image, animation, 3D rendering, augmented reality overlay, motion graphics, data visualization, and/or digital art) (e.g., while outputting the audio). Outputting the first content including displaying visual content enables the computer system to provide content through more than one channel (e.g., acoustically and visually), thereby providing improved feedback to a user and/or performing an operation when a set of conditions has been met without requiring further input.

In some embodiments, performing the operation corresponding to the first media content includes saving (e.g., represented by 824a and 826b) (e.g., causing the computer system and/or another computer system to save) the first media content to a set of (e.g., zero or more) media content (e.g., as discussed above with respect to FIGS. 8C-8D) (e.g., a watchlist, a favorites list, and/or a playlist). In some embodiments, saving the first media content includes saving a reference to (e.g., a link of, an address of, an identifier of (e.g., a unique identifier and/or a relative identifier), and/or information usable to identify, locate, and/or retrieve) the first media content. Performing the operation corresponding to the first media content including saving the first media content to a set of media content allows the computer system to provide a user with an option and/or control to save the first media content, thereby providing improved feedback to the user and/or performing an operation when a set of conditions has been met without requiring further input.

In some embodiments, performing the operation corresponding to the first media content includes downloading the first media content (e.g., as described above with respect to FIG. 8D) (e.g., from a server and/or other computer system remote from the computer system). Performing the operation corresponding to the first media content including downloading the first media content allows the computer system to provide a user with an option and/or control to download the first media content, thereby providing improved feedback to the user and/or performing an operation when a set of conditions has been met without requiring further input.

In some embodiments, the operation is a first operation. In some embodiments, while continuing outputting the first content, in response to detecting the first input (e.g., 805c), and in accordance with a determination that the first input corresponds to (e.g., in a direction of, that references, and/or at a location of) a second media content (e.g., 824 and/or 826) referenced in (e.g., displayed in, included in, identified in, mentioned in, represented in, and/or uttered in) the first portion of the first content, the computer system performs a second operation (e.g., the same as or different from the first operation) corresponding to the second media content, wherein the second media content is different from the first content and the first media content (e.g., as described above with respect to FIGS. 8D-8E). In some embodiments, the first input corresponds to a plurality of media content referenced in (e.g., the first portion of) the first media content (e.g., the input corresponds to both the first media item and the second media item). In some embodiments, while continuing outputting the first content, in response to detecting the first input, and in accordance with a determination that the first input corresponds to the first media content and the second media content, performing a third operation (e.g., the same as or different from the first operation and/or the second operation) corresponding to the first media content and a fourth operation (e.g., the same as or different from the first operation, the second operation, and/or the third operation) corresponding to the second media content. Performing the second operation corresponding to the second media content while continuing outputting the first content, in response to detecting the first input, and in accordance with a determination that the first input corresponds to the second media content referenced in the first portion of the first media content while continuing outputting the first content allows the computer system to perform operations on different media content based on which media content that the first input corresponds, thereby providing improved feedback to a user and/or performing an operation when a set of conditions has been met without requiring further input.

In some embodiments, the second operation is different from the first operation (e.g., as described above with respects with FIGS. 8C-8E). In some embodiments, the second media content is a different type of media than the first media content. The second operation being different from the first operation allows the computer system to cater its operation to which content that an input corresponds, thereby providing improved feedback to a user and/or performing an operation when a set of conditions has been met without requiring further input.

In some embodiments, the operation is a third operation. In some embodiments, the one or more output devices includes a third display component. In some embodiments, while continuing outputting the first content, in response to detecting the first input (e.g., 805c), and in accordance with a determination that the first input corresponds to the first media content and a third media content referenced in the first portion of the first content (e.g., as described above with respect to FIG. 8C), the computer system performs a fourth operation (e.g., the same as and/or different from the third operation) corresponding the first media content (e.g., as described above with respect to FIG. 8D). In some embodiments, while continuing outputting the first content, in response to detecting the first input, and in accordance with the determination that the first input corresponds to the first media content and the third media content referenced in the first portion of the first content, the computer system performs a fifth operation (e.g., the same as and/or different from the third operation and/or the fourth operation) corresponding to the third media content, wherein the third media content is different from the first content and the first media content (e.g., as described above with respect to FIG. 8E). In some embodiments, in conjunction with performing the fourth operation, the computer system displays, via the third display component, an indication of the fourth operation. In some embodiments, in conjunction with performing the fifth operation, the computer system displays (e.g., concurrently and/or sequentially with one or more indications of one or more other operations (e.g., the indication of the fourth operation)), via the third display component, an indication of the fifth operation (e.g., as described above with respect to FIG. 8E). Displaying indications of operations in conjunction with performing the operations allows the computer system to visually indicate what is being performed by the computer system, thereby providing improved feedback to a user and/or performing an operation when a set of conditions has been met without requiring further input.

In some embodiments, while continuing outputting the first content, in response to detecting the first input (e.g., 805c), and in accordance with a determination that the first input does not correspond to the first media content, the computer system forgoes performing the operation corresponding to the first media content (e.g., as described above with respect to FIG. 8C) (e.g., while performing another operation different from the operation). Forgoing performing the operation corresponding to the first media content while continuing outputting the first content, in response to detecting the first input, and in accordance with a determination that the first input does not correspond to the first media content allows the computer system to selectively perform an operation depending on an input detected, thereby providing improved feedback to a user.

In some embodiments, while outputting the first content, the computer system detects, via the one or more input devices, a second input (e.g., 805b) (e.g., a tap input and/or a non-tap input (e.g., a verbal input, an audible request, an audible command, an audible statement, a swipe input, a hold-and-drag input, a gaze input, an air gesture, and/or a mouse click)) different from the first input (e.g., 805a). In some embodiments, in response to detecting the second input, in accordance with a determination that the second input corresponds to a first type of input (e.g., a left swipe input as opposed to a right swipe input) (e.g., a tap gesture as opposed to a pinch gesture) (e.g., a first verbal instruction as opposed to a second verbal instruction) (e.g., a verbal input as opposed to an air gesture), the computer system ceases output of (e.g., pauses and/or no longer outputs) the first content (e.g., displays agent representation 816 as illustrated in FIGS. 8C-8D) (and/or performs another operation based on the second input) (e.g., as described above with respect to FIGS. 8C-8D). In some embodiments, in response to detecting the second input and in accordance with a determination that the second input corresponds to the first type of input, the computer system displays an indication of the first content (e.g., that was not displayed before detecting the second input). In some embodiments, in response to detecting the second input (e.g., 805c), in accordance with a determination that the second input corresponds to a second type of input different from the first type of input, computer system 800 forgoes ceasing output of the first content (e.g., as described above with respect to FIGS. 8C-8D) (and/or performs the other operation (and/or a different operation that is different from the other operation) based on the second input). Selectively ceasing output of the first content depending on a type of gesture detected allows the computer system to react differently to different request, instructions, and/or statements, thereby providing improved feedback to a user and/or performing an operation when a set of conditions has been met without requiring further input.

In some embodiments, the one or more output devices includes a fourth display component (e.g., 140 and/or 200-16). In some embodiments, in conjunction with (e.g., before, while, and/or after) detecting the first input (e.g., 805c), the computer system displays, via the fourth display component, the first portion of the first content (e.g., as described above with respect to FIGS. 8A-8D). Displaying the first portion of the first content in conjunction with detecting the first input allows a user to see the first portion before providing the first input and/or the computer system to acknowledge what the operation is being performed with, thereby providing improved feedback to the user and/or performing an operation when a set of conditions has been met without requiring further input.

In some embodiments, the one or more output devices includes an audio generation component (e.g., smart speaker, home theater system, soundbar, headphone, earphone, earbud, speaker, television speaker, augmented reality headset speaker, audio jack, optical audio output, Bluetooth audio output, and/or HDMI audio output). In some embodiments, in conjunction with (e.g., before, while, and/or after) detecting the first input (e.g., 805c), the computer system outputs, via the audio generation component, the first portion of the first content (e.g., as described above with respect to FIGS. 8A-8D). Acoustically outputting the first portion of the first content in conjunction with detecting the first input allows a user to hear the first portion before providing the first input and/or the computer system to acknowledge what the operation is being performed with, thereby providing improved feedback to the user and/or performing an operation when a set of conditions has been met without requiring further input.

In some embodiments, the first media content is a first type of content (e.g., audio content, visual content, a movie, a show, an audiobook, an audio album, an animation, media commentary, and/or an avatar) than the first content (e.g., as described above with respect to FIG. 8C). The first media content being a different type of content than the first content allows the computer system to be flexible when and/or on what types of content operations are performed, thereby providing improved feedback to a user.

In some embodiments, the first content is (and/or includes) audio content (e.g., 830) (e.g., as described above with respect to FIG. 8D) (e.g., music, sounds, and/or speech). In some embodiments, the first media content is and/or includes audio content. The first content including audio content allows the computer system to perform operations on things referenced in the audio content, thereby providing improved feedback to a user.

In some embodiments, the first media content is (and/or includes) visual content (e.g., 816, 824, and/or 826) (e.g., as described above with respect to FIG. 8D) (e.g., an image and/or a video) (e.g., playback of content and/or video commentary) (e.g., that corresponds to the first content). In some embodiments, the first media content is and/or includes visual content (e.g., a movie by the same director as the first content, a television show, new commentary, and/or a deleted scene). The first media content including visual content allows the computer system to extract indications referring to visual content and save for later, thereby providing improved feedback to a user.

In some embodiments, the first input (e.g., 805c) is (and/or includes) verbal input (e.g., as described above with respect to FIG. 8C) (e.g., an audible request, an audible command, and/or an audible statement). The first input being verbal input allows the computer system to provide increased flexibility and/or accessibility in receiving communication from a user and/or enables the computer system to perform an operation and/or change media output based on audio, thereby reducing the number of inputs needed to perform an operation, providing additional control options without cluttering the user interface with additional displayed controls, and/or performing an operation when a set of conditions has been met without requiring further user input.

In some embodiments, the first input is (and/or includes) a gesture (e.g., as described above with respect to FIG. 8C) (e.g., a touch gesture (e.g., a swipe input, a hold-and-drag input, and/or a tap input) and/or an air gesture(e.g., a hand input to pick up, a hand input to press, an air tap, an air swipe, and/or a clench and hold air input)). The input being a gesture allows the computer system to provide increased flexibility and/or accessibility in receiving communication from a user and/or enables the computer system to perform an operation and/or change media output based on a on a non-touch or non-audible input, thereby reducing the number of inputs needed to perform an operation, providing additional control options without cluttering the user interface with additional displayed controls, and/or performing an operation when a set of conditions has been met without requiring further user input.

Note that details of the processes described above with respect to process 1000 (e.g., FIG. 10) are also applicable in an analogous manner to other processes described herein. For example, process 900 optionally includes one or more of the characteristics of the various processes described above with reference to process 1000. For example, the playing back media content of process 900 can be the first media content of process 1000. For brevity, these details are not repeated below.

FIG. 11 is a flow diagram illustrating a process (e.g., process 1100) for responding to a request without interrupting output in accordance with some embodiments. Some operations in process 1100 are, optionally, combined, the orders of some operations are, optionally, changed, and some operations are, optionally, omitted.

As described below, process 1100 provides an intuitive way for responding to a request without interrupting output. Process 1100 reduces the cognitive burden on a user for responding to a request without interrupting output, thereby creating a more efficient human-machine interface. For battery-operated computing devices, enabling a user to be provided a response to a request without interrupting output faster and more efficiently conserves power and increases the time between battery charges.

In some embodiments, process 1100 is performed at a computer system (e.g., 100, 200, and/or 800) that is in communication with one or more input devices (e.g., 140 and/or 200-14) (e.g., a camera, a depth sensor, and/or a microphone), an audio output component (e.g., 140 and/or 200-16) (e.g., one or more speakers), and a display component (e.g., 140 and/or 200-16) (e.g., one or more display screens, projects, and/or touch-sensitive displays). In some embodiments, the computer system is a watch, a phone, a tablet, a fitness tracking device, a processor, a head-mounted display (HMD) device, a communal device, a media device, a speaker, a television, and/or a personal computing device.

The computer system detects (1102), via the one or more input devices, a first input (e.g., 805b) (e.g., verbal input and/or air gesture) (e.g., a tap input and/or a non-tap input (e.g., a verbal input, an audible request, an audible command, an audible statement, a swipe input, a hold-and-drag input, a gaze input, an air gesture, and/or a mouse click)) corresponding to (e.g., is, includes, and/or represents) a first request (e.g., a request for information, a request to perform an operation, and/or a request to initiate output of content).

In response to detecting the first input corresponding to the first request, the computer system outputs (1104), via the audio output device, a first audio portion (e.g., one or more sounds such as a dialogue, music, and/or audible output) of a first response (e.g., 828) (e.g., the first response is a response to the first request).

While outputting the first audio portion of the first response, the computer system detects (1106), via the one or more input devices, a second input (e.g., 805c) corresponding to (e.g., is, includes, and/or represents) a second request (e.g., a request for information, a request to perform an operation, and/or a request to initiate output of content), wherein the second input is different from the first input (e.g., as described in FIG. 8C). In some embodiments, the second input includes a non-verbal input (e.g., air gesture, gaze, and/or physical contact with an input device). In some embodiments, the second request is different from the first request.

In response to detecting the second input corresponding to the second request and while continuing outputting without interrupting the first audio portion of the first response (e.g., without altering characteristics (e.g., volume, speed, and/or pitch) of the output of the first audio portion), the computer system displays (1108), via the display component, a first visual portion (e.g., 824a, 826a) (e.g., text, a symbol, a button, a selectable user interface object, an image, a video, media, a chart, a drawing a representation of a face, and/or agent) (e.g., concurrently while outputting the first audio portion of the first response) of a second response different from the first response (e.g., as described above with respect to FIG. 8D). In some embodiments, in response to detecting the second input corresponding to the second request and while continuing outputting the first audio portion of the first response without interrupting (e.g., without altering characteristics (e.g., volume, speed, and/or pitch) of the first audio portion) the first audio portion of the first response, the computer system displays, via the display component, a second visual portion of a third response (e.g., the second response or a different response) different from the first response. In some embodiments, the computer system displays the second visual portion of the third response concurrently with the first visual portion of the second response. In some embodiments, the computer system continues to update audio (e.g., volume, speed, and/or pitch of speech, and/or sounds (e.g., including one or more pauses)) of the first audio portion of the first response, irrespective of whether the second input (e.g., or a different input) is detected. Displaying the first visual portion of the second response in response to detecting the second input and while continuing outputting without interrupting the first audio portion of the first response allows the computer system to (1) provide a seamless user experience by engaging with a user without interrupting ongoing audio output and/or (2) improve accessibility by providing visual feedback to a user's request without complicating audio discernment for the user, thereby providing improved visual feedback to the user, reducing the number of inputs needed to perform an operation, providing additional control options without cluttering the user interface with additional displayed controls, and/or performing an operation when a set of conditions has been met without requiring further user input.

In some embodiments, the first response is (and/or includes) playback of media content (e.g., 816 and/or 828) (e.g., as described above with respect to FIG. 8B-8C) (e.g., a media content item such as a file and/or stream) (e.g., video output, audio output, TV show, movie, online video, music video, song, audiobooks, podcast, and/or game). In some embodiments, outputting the media content includes outputting the first audio portion of the first response. In some embodiments, the computer system outputs the first visual portion of the second response concurrently with the media content (and/or without interrupting output of the media content). The first response being playback of the media content allows the computer system to enhance user experience by providing audio and/or visual content to a user, thereby providing improved feedback to the user, and/or performing an operation when a set of conditions has been met without requiring further user input.

In some embodiments, the first response is (and/or includes) output (e.g., verbal output such as audio and/or visual output such as movement) of an agent (e.g., 816) (e.g., as described above with respect to FIG. 8C) (e.g., system or non-system agent, such as an agent managing operation of the computer system and/or an agent provided by an application executing on the computer system) (e.g., an avatar of a personal assistant). In some embodiments, the computer system outputs a representation of the agent concurrently with the first audio portion of the first response (e.g., without interrupting output of the first audio portion of the first response). In some embodiments, outputting the first visual portion of the second response includes outputting a representation of the agent. The first response being output of an agent allows the computer system to (1) enhance user experience by introducing a non-disruptive agent to handle a user's request(s) and/or (2) improve accessibility, thereby providing improved feedback to the user, reducing the number of inputs needed to perform an operation, and/or performing an operation when a set of conditions has been met without requiring further user input.

In some embodiments, the second response does not include audio output (e.g., 824a, 826a) (e.g., as described in FIG. 8D). In some embodiments, the second response does not interrupt the audio of the first response. In some embodiments, the second response includes a visual indication as an acknowledgement and/or completion of the second request (e.g., displaying one or more badges in response to the second request) (e.g., changing color, and/or contrast of content being output in response to the first request, and/or overlaying a glow, and/or other visual effect and/or other UI element on content being output). In some embodiments, audio output is any output that is capable of being perceived by a human ear, including, and not limited to sound waves, music, speech, and other audible representations of data. The second response not including audio output enables the computer system to provide a streamlined user experience by minimizing disruptive audio interventions, thereby reducing the number of inputs needed to perform an operation and/or performing an operation when a set of conditions has been met without requiring further user input.

In some embodiments, the first request is (and/or includes) a request for information (e.g., as described above with respect to FIG. 8C) (e.g., search query, product inquiry, content inquiry, weather information request, language translation request, and/or media catalog search request). In some embodiments, the first request does not concern content output by the display component and/or the audio output component. In some embodiments, the first request concerns content output by the display component and/or the audio generation component (e.g., the first request corresponds to a request to the computer system about information concerning media content being output). The first request being the request for information allows the computer system to provide content when requested, thereby providing improved visual feedback to the user.

In some embodiments, the first request is (and/or includes) a request (and/or instruction) to perform (and/or execute) an operation (e.g., 805c) (e.g., as described above with respect to FIG. 8C) (e.g., display content, change an appearance of content, change a form of a representation of content, display a new user interface and/or user-interface element, output of audio, transfer content, modify content, trigger a reminder, and/or change a setting (e.g., brightness, volume, contrast, and/or size of a window) of the computer system). The first request being a request to perform an operation allows the computer system to perform operations on behalf of a user, thereby providing improved visual feedback to the user.

In some embodiments, the first request is (and/or includes) a request to initiate output of content (e.g., as described above with respect to FIG. 8C) (e.g., media content). In some embodiments, the request to initiate output of content represents (e.g., is and/or includes) a command (e.g., instruction and/or statement understood as a command) directed at the computer system to start playback (e.g., audio and/or visual playback) of content (e.g., an item of media content). In some embodiments, the computer system outputs the first audio portion of the first response in response to detecting the request initiate output of content. The first request being a request to initiate output of content allows the computer system to perform operations on behalf of a user, thereby providing improved visual feedback to the user.

In some embodiments, in response to detecting the first input (e.g., 805c) corresponding to the first request, the computer system displays, via the display component, a first visual portion (e.g., 816, 824, and/or 826) of the first response (e.g., as described above with respect to FIG. 8D) (e.g., video, image, animation, 3D rendering, augmented reality overlay, motion graphics, data visualization, and/or digital art). In some embodiments, the first visual portion of the first response includes visual effects (e.g., Computer Generated Imagery (CGI) and/or practical effects) and/or animations. In some embodiments, the first visual portion of the first response includes animated text and/or typography that transforms and/or transitions while being displayed. In some embodiments, the first visual portion of the first response includes one or more badges representing a status of the first request. In some embodiments, displaying the first visual portion of the first response includes changing one or more color characteristics (e.g., hue, saturation, tone, and/or brightness) and/or lighting effects. In some embodiments, displaying the first visual portion of the first response includes transitioning between scenes (e.g., fade-ins, fade-outs, crossfades, or wipes) and/or animations. Displaying the first visual portion of the first response in response to detecting the first input corresponding to the first request allows the computer system to enhance the user experience with visual output, thereby providing improved visual feedback to the user and/or performing an operation when a set of conditions has been met without requiring further user input.

In some embodiments, the first visual portion of the second response is displayed concurrently with the first visual portion of the first response (e.g., as described above with respect to FIG. 8D). In some embodiments, while outputting the first visual portion of the first response, the computer system displays, via the display component, the first visual portion of the second response (e.g., the first visual portion of the first response includes a visual indication (e.g., a badge) of the completion of the second request (e.g., in response to the second request asking to add a movie to a certain list, displaying a UI element representing the movie and/or other indicators about the status of the second request on top of the first visual portion of the first response.)). The first visual portion of the second response being displayed concurrently with the first visual portion of the first response allows the computer system to preserve user engagement by providing visual feedback to additional requests concurrently with ongoing visual output, thereby providing improved visual feedback to the user and/or performing an operation when a set of conditions has been met without requiring further user input.

In some embodiments, in response to detecting the second input (e.g., 805d), the computer system continues displaying, via the display component, the first visual portion of the first response (e.g., as described above with respect to FIG. 8E). In some embodiments, in response to detecting the second input, the computer system forgoes interrupting the visual output of the first response. In some embodiments, the first visual portion of the second response partially (e.g., briefly and/or for a predefined period of time) overlaps the first visual portion of the first response at a point in time. Continuing displaying the first visual portion of the first response in response to detecting the second input allows the computer system to preserve user engagement by not interrupting the current visual output, thereby providing improved visual feedback to the user and/or performing an operation when a set of conditions has been met without requiring further user input.

In some embodiments, before outputting the first audio portion (e.g., 828) of the first response, the computer system outputs first content corresponding to a first agent (e.g., 816 and/or 818 of FIG. 8B) (e.g., as described above with respect to FIGS. 8C-8D) (e.g., system agent) (e.g., an avatar of a personal assistant) (e.g., a representation of the first agent, an indication of the first agent, and/or a user interface element associated with the first agent). In some embodiments, in conjunction with (e.g., after and/or in response to) outputting the first audio portion of the first response, the computer system ceases output of content (e.g., the first content and/or other content different from the first content) corresponding to the first agent (e.g., 816 and/or 818 of FIG. 8C) (e.g., as described above with respect to FIG. 8C). In some embodiments, in conjunction with outputting the first visual portion (e.g., 824a and/or 826a) of the second response, the computer system outputs second content corresponding to the first agent (e.g., 824a and/or 826a) (e.g., 816 and/or 830 of FIG. 8D) (e.g., as described above with respect to FIG. 8D) (e.g., a representation of the first agent, an indication of the first agent, and/or a user interface element associated with the first agent). In some embodiments, the first agent is displayed concurrently with a second agent (e.g., different from the first agent) (e.g., an application agent) (e.g., an agent specific to content being output, such as the first response). In some embodiments, content of the first agent briefly (e.g., for a predefined period of time) interrupts content of the second agent. In some embodiments, content of the first agent does not interrupt audio output corresponding to the second agent. In some embodiments, the computer system outputs an indication of acknowledgement and/or provides a response to the second request without interrupting the first response (e.g., a representation of the first agent and/or the second agent displays a thumbs up to acknowledge the second request) (e.g., a representation of the first agent and/or the second agent nods its head as an affirmative response to the second request). Outputting content corresponding to the first agent in conjunction with outputting the first visual portion of the second response and before outputting the first audio portion of the first response allows the computer system to enhance user engagement by providing feedback without interrupting ongoing audio and/or visual output, thereby providing improved feedback to the user and/or performing an operation when a set of conditions has been met without requiring further user input.

In some embodiments, after a predefined period of time has elapsed since outputting the second content corresponding to the first agent, the computer system ceases display of the second content (e.g., 816, 824, 826, 824a, and/or 826a of FIG. 8D) (e.g., as described above with respect to FIG. 8D) (e.g., while continuing outputting the first audio portion of the first response). In some embodiments, the computer system outputs content corresponding to the second agent in conjunction with ceasing display of the second content. In some embodiments, the computer system ceases display of the second content after responding to and/or acknowledging the second response. In some embodiments, the second agent is a representation of a character concerning (relating to, used in) the first response. Ceasing display of the second content after the predefined period of time has elapsed since outputting the second content allows the computer system to enhance user experience by providing the relevant agent to a user' request, thereby providing improved feedback to the user and/or performing an operation when a set of conditions has been met without requiring further user input.

In some embodiments, the computer system (e.g., 800) is in communication with a movement component (e.g., 140, 200-16, and/or 200-18). In some embodiments, in response to detecting the first input (e.g., 805b) corresponding to the first request, the computer system moves, via the movement component, a portion (e.g., a housing and/or an enclosure including a display component and/or the one or more input devices) (e.g., a front portion) of the computer system (e.g., in a predefined manner, such as a predefined movement (e.g., 360 degree turn such that content corresponding to the first agent is displayed before moving (and/or a first predefined period while moving, such as a beginning of moving) and content corresponding to the second agent is displayed after moving (and/or a second predefined period (e.g., different from the first predefined period) while moving, such as an end of moving))). Displaying the animation indicating the handover between the first agent and the other agent allows the computer system to enhance user engagement by using visual output to explicitly mark the handover to another agent, thereby providing improved visual feedback to the user and/or performing an operation when a set of conditions has been met without requiring further user input.

In some embodiments, the second response includes (and/or is) haptic output. In some embodiments, the second response does not include visual output. Having the second response include haptic output enables the computer system to enhance user engagement by providing tangible feedback to the user, thereby performing an operation when a set of conditions has been met without requiring further user input.

In some embodiments, the first input includes (and/or is) a verbal (e.g., speech, auditory, and/or voice) input. In some embodiments, a verbal input refers to spoken words and/or linguistic details such as content and logical structure of a verbal communication. Having the first input include a verbal input provides the computer system with (1) increased flexibility and/or accessibility in receiving communication from a user and/or (2) enables the computer system to perform an operation and/or change media output based on audio, thereby reducing the number of inputs needed to perform an operation, providing additional control options without cluttering the user interface with additional displayed controls, and/or performing an operation when a set of conditions has been met without requiring further user input.

In some embodiments, the first input includes (and/or is) a gesture (e.g., as described in FIG. 8C) (e.g., air gesture via a camera and/or contact with a physical input device (e.g., tap gesture, pinch gesture, and/or swipe gesture)). Having the first input include a gesture provides the computer system with (1) increased flexibility and/or accessibility in receiving communication from a user and/or (2) enables the computer system to perform an operation and/or change media output based on non-audio or non-touch input, thereby reducing the number of inputs needed to perform an operation, providing additional control options without cluttering the user interface with additional displayed controls, and/or performing an operation when a set of conditions has been met without requiring further user input.

In some embodiments, the first input includes (and/or is) gaze input (e.g., as described in FIG. 8C) (e.g., a direction of attention of a user (e.g., one or more eyes of the user)). In some embodiments, a gaze input is an input that is detected without the user touching an input element and is based on utilizing information about a user's gaze (eye) direction or focus to control and/or interact with the computer system. Having the first input include a gaze input provides the computer system with (1) increased flexibility and/or accessibility in receiving communication from a user and/or (2) enables the computer system to perform an operation and/or change media output based on non-audio or non-touch input, thereby reducing the number of inputs needed to perform an operation, providing additional control options without cluttering the user interface with additional displayed controls, and/or performing an operation when a set of conditions has been met without requiring further user input.

In some embodiments, the second input (e.g., 805d) includes (and/or is) audible (e.g., 805d) (e.g., as described in FIG. 8D) (e.g., verbal, speech, auditory, and/or voice) input. In some embodiments, audible input refers to spoken words and/or linguistic details such as content and logical structure of a verbal communication. In some embodiments, audible input is detected via the one or more input devices, such as a microphone. Having the second input include a verbal input provides the computer system with (1) increased flexibility and/or accessibility in receiving communication from a user and/or (2) enables the computer system to perform an operation and/or change media output based on audio, thereby reducing the number of inputs needed to perform an operation, providing additional control options without cluttering the user interface with additional displayed controls, and/or performing an operation when a set of conditions has been met without requiring further user input.

In some embodiments, the second input includes (and/or is) gaze input (e.g., as described in FIG. 8D) (e.g., a direction of attention of a user (e.g., one or more eyes of the user)). In some embodiments, a gaze input is an input that is detected without the user touching an input element and is based on utilizing information about a user's gaze (eye) direction or focus to control and/or interact with the computer system. Having the second input include a gaze input provides the computer system with (1) increased flexibility and/or accessibility in receiving communication from a user and/or (2) the ability to perform an operation and/or change media output based on non-audio or non-touch input, thereby reducing the number of inputs needed to perform an operation, providing additional control options without cluttering the user interface with additional displayed controls, and/or performing an operation when a set of conditions has been met without requiring further user input.

In some embodiments, the second input includes (and/or is) a gesture (e.g., as described in FIG. 8D) (e.g., air gesture via a camera and/or contact with a physical input device (e.g., tap gesture, pinch gesture, and/or swipe gesture)). Having the second input include a gesture provides the computer system with (1) increased flexibility and/or accessibility in receiving communication from a user and/or (2) the ability to perform an operation and/or change content output based on non-audio or non-touch input, thereby reducing the number of inputs needed to perform an operation, providing additional control options without cluttering the user interface with additional displayed controls, and/or performing an operation when a set of conditions has been met without requiring further user input.

Note that details of the processes described above with respect to process 900 (e.g., FIG. 9) are also applicable in an analogous manner to the processes described herein. For example, process 700 optionally includes one or more of the characteristics of the various processes described above with reference to process 900. For example, the second response of process 900 can be performed while playing back the media content of process 700. For brevity, these details are not repeated below.

FIGS. 12A-12B illustrate exemplary user interface for providing an application to perform a requested task in accordance with some embodiments. The user interfaces in these figures are used to illustrate the processes described below, including the processes in FIGS. 13 and 15.

FIGS. 12A-12B and 14A-14C illustrate computer system 1200 (e.g., a tablet) using an agent to perform a task. It should be recognized that computer system 1200 can be other types of computer systems such as a smart phone, a smart watch, a laptop, a communal device, a smart speaker, an accessory, a personal gaming system, a desktop computer, a fitness tracking device, and/or a head-mounted display (HMD) device. In some embodiments, computer system 1200 includes and/or is in communication with one or more input devices and/or sensors (e.g., a camera, a lidar detector, a motion sensor, an infrared sensor, a touch-sensitive surface, a physical input mechanism (such as a button or a slider), and/or a microphone). Such sensors can be used to detect presence of, attention of, statements from, inputs corresponding to, requests from, and/or instructions from a user in an environment. It should be recognized that, while some embodiments described herein refer to inputs being voice inputs, other types of inputs can be used with techniques described herein, such as touch inputs via a touch-sensitive surface and air gestures detected via a camera. In some embodiments, computer system 1200 includes and/or is in communication with one or more output devices (e.g., a display screen, a projector, a touch-sensitive display, speaker, and/or a movement component). Such output devices can be used to present information and/or cause different visual changes of computer system 1200. In some embodiments, computer system 1200 includes and/or is in communication with one or more movement components (e.g., an actuator, a moveable base, a rotatable component, and/or a rotatable base). Such movement components, as discussed above, can be used to change a position (e.g., location and/or orientation) of computer system 1200 and/or a portion (e.g., including one or more sensors, input components, and/or output components) of computer system 1200. In some embodiments, computer system 1200 includes one or more components and/or features described above in relation to computer system 100 and/or electronic device 200. In some embodiments, computer system 1200 includes one or more agents and/or functions of an agent as described above with respect to FIG. 5. In some embodiments, computer system 1200 is, includes, implements, and/or is in communication with one or more agent systems, as described above with respect to FIG. 5, for performing (and/or causing performance of) one or more operations of an agent.

FIGS. 12A-12B illustrate exemplary user interfaces for using an agent to perform a task in accordance with some embodiments. The user interfaces in these figures are used to illustrate the processes described below, including the process in FIG. 13.

FIGS. 12A-12B are split between a left portion and a right portion to illustrate a user (e.g., user 1210 representing a person and/or subject) interacting with an agent (e.g., represented on user interface 1204 by avatar 1208 (e.g., illustrated as a smiley face on FIGS. 12A-12B)) via computer system 1200. In the examples illustrated in FIGS. 12A-12B, the right portion illustrates a physical environment that includes a user (e.g., user 1210) interacting with computer system 1200 (e.g., issuing voice inputs (e.g., voice input 1205A and/or 1205B) to interact with computer system 1200), detected through a field of view of one or more cameras (represented by the dotted lines casting away from computer 1200). As illustrated in FIGS. 12A-12B, the left portion indicates content and/or applications (e.g., alongside and/or without the agent) displayed in user interface 1204 by computer system 1200 via the display component (e.g., represented by display 1202). While FIGS. 12A-12C illustrate computer system 1200 displaying particular applications and/or content within display 1202, it should be recognized that such applications and/or content are merely for explanatory purposes and that such applications can be in different locations, at different sizes, include different content and that more, fewer, and/or different applications can be used in accordance with techniques described herein.

As discussed in more detail below, computer system 1200 displays avatar 1208 to indicate that user 1210 is interacting with an agent. In some embodiments, an agent (e.g., represented by avatar 1208) represents an interactive knowledge base (and/or an agent system implementing an agent). In some embodiments, computer system 1200 is in communication with the interactive knowledge base. In some embodiments, computer system 1200 is in communication with an agent (e.g., third-party and/or remotely located) to interact with the interactive knowledge base. In some embodiments, the interactive knowledge base is one or more artificial intelligence models. For example, the interactive knowledge base is one or more large language models. In some embodiments, the interactive knowledge base corresponds to an application (e.g., system based and/or remotely located) and computer system 1200 and/or the agent interact with the application-based interactive knowledge base (e.g., via an Application Programming Interface (API)) (e.g., to obtain information form, request responses from, and/or update capabilities based on the interactive knowledge base).

In some embodiments, the agent is implemented on an agent system that is remote from computer system 1200 and a user interface object (e.g., avatar 1208) and computer system 1200 outputs the user interface object to represent communication with an interactive knowledge base (e.g., to be an interactive interface between a user and the interactive knowledge base). For example, computer system 1200 can display avatar 1208 to inform users (e.g., user 1210) that computer system 1200 is interacting with (e.g., querying, addressing, obtaining information from, and/or using) an interactive knowledge base. For example, computer system 1200 is displaying avatar 1208 is an indication that an agent (e.g., representing an interactive knowledge database) is active and/or available for interaction (e.g., without summoning with an additional input). In some embodiments, a particular representation is associated with a particular agent. For example, avatar 1208 can have an appearance that indicates (e.g., and/or that is otherwise uniquely used with) a particular agent (e.g., interactive knowledge database) (e.g., such that if a different agent is used, a different avatar can be used).

In some embodiments, computer system 1200 performs determinations based on the interactive knowledge base corresponding to tasks and/or requests. For example, computer system 1200 determines the steps to perform a task requested by user 1210. In some embodiments, an agent is a remote computer system and/or system for interacting with an interactive knowledge base. For example, computer system 1200 queries and/or requests the agent to perform a determination for computer system 1200. For example, computer system 1200 requests the steps and/or method for performing a task from the agent. While FIGS. 12A-12B illustrate computer system 1200 and/or the agent performing exemplary functionality with and/or without indicating an interaction with an interactive knowledge base, it should be understood that computer system 1200 and/or the agent continue to interact with an interactive knowledge base. For example, as discussed below, computer system 1200 determining that it cannot perform a requested task includes computer system 1200 interacting with an interactive knowledge base.

In the examples described below with respect to FIGS. 12A-12B, an agent of a computer system 1200 receives a request to perform a task that the agent is not capable of performing (e.g., lacks functionality and/or resources to do so). In these examples, the agent is able to interact with additional resources (e.g., tools, agents, knowledge bases, and/or applications) to assist and/or cause performance of the requested task.

At FIGS. 12A-12B, computer system 1200 has a set of one or more capabilities and the agent (e.g., represented by avatar 1208) corresponds to computer system 1200's capabilities. In some embodiments, computer system 1200's capabilities correspond to the hardware and/or system-based applications native to computer system 1200. For example, computer system 1200 is capable of, but not limited to, outputting the current time, tracking a timer, and/or outputting system information (e.g., current battery life and/or connectivity strength). For example, enabling user 1210 to ask, “what time is it?” and computer system 1200 (in response to detecting such input) outputs the current time. In some embodiments, computer system 1200's capabilities include the capabilities of the applications present on computer system 1200. For example, computer system 1200 is capable of performing calendar-based tasks due to having a calendar application. For example, enabling user 1210 to ask, “when is my next meeting?” and computer system 1200 (in response to detecting such input) outputs the next meeting and/or event by accessing the user's calendar application. In some embodiments, computer system 1200's capabilities correspond to computer system 1200's ability to interact with third-party applications and/or computer systems. For example, computer system 1200 is able to retrieve content from a third-party music application through its ability to interact with functionality of the music application. For example, enabling user 1210 to ask the agent “play my favorites playlist” and computer system 1200 (in response to detecting such input) outputs audio content from the third-party music application.

At FIGS. 12A-12B, the agent has a set of one or more capabilities, different than the capabilities of computer system 1200 (and/or of one or more other agents implemented by, accessible to, and/or provided by computer system 1200). In some embodiments, the agent corresponds to a system-based agent that has a set of one or more capabilities that correspond to computer system 1200. For example, an agent native to computer system 1200 that requests system information from computer system 1200. For example, the agent requests computer system 1200's current battery level and requests computer system 1200 output the current battery level to user 1210. In some embodiments, the set of one or more capabilities corresponds to the agent's ability to interact with computer system 1200. For example, the agent possessing permission to interact with computer system 1200's data and/or storage. In some embodiments, the set of one or more capabilities correspond to the agent's ability to interact with applications and/or third-party applications on computer system 1200 and/or remotely located. For example, enabling user 1210 to ask the agent “when is my next meeting?” and the agent requests computer system 1200 to output the next meeting and/or event by accessing the user's calendar application. In some embodiments, the agent corresponds to a first application that has a set of one or more capabilities. For example, the agent corresponds to a navigation application and provides computer system 1200 and/or a system-based agent with navigation capabilities.

As illustrated in FIG. 12A, environment 1206 includes user 1210 within computer system 1200's field of view (e.g., represented by the dotted lines casting away from computer system 1200). At FIG. 12A, computer system 1200 detects user 1210. In some embodiments, computer system 1200 transitions from an inactive to an active state upon detecting user 1210. In some embodiments, when computer system 1200 is inactive, computer system 1200 reduces screen brightness, reduces input device capabilities (e.g., turning off a touch sensitive display component until a user is detected and/or requiring a wake input to receive additional inputs), and/or reduces content displayed on user interface 1204. In some embodiments, when computer system transitions to an active state, computer system 1200 increases screen brightness, displays additional user interface components (e.g., avatar 1208), and/or enabled additional input devices. In some embodiments, transitioning between an inactive state and an active state is done through an animation. For example, fading out displayed content when transitioning to inactive and/or fading in content to be displayed when transitioning to active (e.g., displaying content at a reduced brightness and/or opacity and increasing the brightness and/or opacity over a predetermined amount of time).

At FIG. 12A, in response to computer system 1200 detecting user 1210, computer system 1200 awaits an input from user 1210. As illustrated in FIG. 12A, computer system 1200 displays avatar 1208 within user interface 1204. In some embodiments, computer system 1200 begins detecting inputs upon detecting user 1210. In some example, computer system 1200 waits until avatar 1208 is displayed to detect an input to indicate that user 1210 is interacting with an agent. In some embodiments, computer system 1200 displaying user interface 1204 including only avatar 1208 indicates that computer system 1200 is awaiting an input from a detected user (e.g., user 1210). For example, computer system 1200 awaits a request from user 1210 to perform a task (e.g., voice input 1205A). In some embodiments, awaiting input is and/or includes being available and/or able to detect input (e.g., is listening for verbal inputs via a microphone and/or using an image feed from a camera to watch for air gestures).

At FIG. 12A, while detecting user 1210 and awaiting an input from a user (e.g., user 1210), user 1210 asks computer system 1200 to perform a task. As illustrated in FIG. 12A, user 1210 asks, “I want to practice my Spanish vocabulary. What can I do?” (e.g., voice input 1205A, as represented by speech bubble 1212). As a result, computer system 1200 detects voice input 1205A from user 1210 asking computer system 1200 to perform a task, as illustrated in FIG. 12A. In some embodiments, computer system 1200 animates and/or changes the visual characteristics of avatar 1208 (e.g., resizing, reshaping, repositioning, and/or altering prominence level of avatar 1208) to indicate that computer system 1200 is detecting voice input 1205A.

At FIG. 12B, in response receiving the request to perform the task, computer system 1200 determines that the agent (e.g., a system-based agent (e.g., application and/or system native on computer system 1200) corresponding to the capabilities of computer system 1200) is unable to perform the task (e.g., voice input 1205A). In some embodiments, the task includes a set of one or more steps to perform the task. In the example of FIGS. 12A-12B, the agent represented by avatar 1208 does not have a language practicing capability (e.g., no programmed functionality to perform that task). However, computer system 1200 (e.g., the agent) can determine the task that is requested (e.g., helping with Spanish vocabulary practice) and/or that it is outside of the agent's current and/or available capabilities. As another example, a navigation tasks can include obtaining a current location of computer system 1200, obtaining a desired destination, and/or providing routing information for navigating from the current location to the desired destination. In some embodiments, computer system 1200 performs the determination that the agent (e.g., corresponding to computer system 1200's capabilities) is unable to perform the task. In some embodiments, computer system 1200 requests that an agent (e.g., a native agent and/or remotely located agent) perform the determination of task and/or agent capabilities. In some embodiments, the determination that the agent (e.g., corresponding to computer system 1200's capabilities) is unable to perform the task includes comparing the set of one or more steps to perform the task with the one or more capabilities of computer system 1200. For example, when user 1210 asks computer system 1200 for its current location, computer system 1200 can determine that the agent does not have access to data for obtaining a current location (e.g., providing location related data is outside of the capabilities of the current agent). In the example of FIGS. 12A-12B, computer system 1200 can determine that the agent represented by 1208 does not have access to a suitable knowledge base and/or does not have a quizzing function that can be used to practice language skills.

In some embodiments, as mentioned above, an agent has a set of one or more capabilities. In some embodiments, computer system 1200 uses the agent to perform the task requested by user 1210 (e.g., the task is within the capabilities of the agent and computer system 1200 uses the agent to perform the task(s) and provide output). For example, computer system 1200 receiving a request to obtain navigation information for user 1210, and computer system 1200 requesting the agent obtain and/or determine the navigation content to output for user 1210. In some embodiments, performing a task (e.g., the overall task) includes performing a set of one or more steps (e.g., actions, tasks, sub-tasks, and/or parts) (e.g., retrieving data, processing such data, and/or generating visual output). In some embodiments, the set of one or more tasks includes the agent obtaining information from an application (e.g., a system application and/or a third-party application) and outputting a response corresponding to the task, without indicating that the agent is unable to perform the task.

At FIG. 12B, in response to determining that the agent is unable to perform the task, computer system 1200 determines an agent and/or application that is able to perform the task. In some embodiments, a task corresponds to a set of one or more steps required to perform the task (e.g., that are determined by computer system 1200 and/or an agent). In some embodiments, an application has a set of one or more capabilities. In some embodiments, computer system 1200 compares the set of one or more steps required to perform the task and the capabilities of a set of one or more applications in communication with computer system 1200. For example, computer system 1200 compares the required steps to perform user 1210's request with the capabilities of a set of applications stored on computer system 1200. In this example, computer system 1200 determines that quiz application 1226 is able to perform the task based on quiz application 1226's capabilities.

At FIG. 12B, in response to determining that the agent is unable to perform the task and that quiz application 1226 is able to perform the task, computer system 1200 outputs a response. In this example, the response outputted by computer system 1200 includes an indication that computer system 1200 cannot perform the task (e.g., audio output 1240) (e.g., “I cannot help you with that . . . ”) and a prompt for permission from user 1210 to launch (and/or utilize and/or share data with) the application (e.g., quiz application 1226) that is able to perform the task (e.g., audio output 1240) (“ . . . but you can use QuizApp to make Vocabulary quiz cards. Do you want to get started?”). In some embodiments, while outputting audio output 1240 (e.g., including the indication and/or the prompt) computer system 1200 animates and/or alters the visual characteristics of avatar 1208 (e.g., resizing, reshaping, repositioning, and/or altering prominence level of avatar 1208) to indicate that the agent is responding to (e.g., appearing to speak to) user 1210. In some embodiments, the response does not include a prompt (e.g., permission is not necessary and/or was previously granted). In some embodiments, the prompt includes additional permission requests. For example, computer system 1200 outputting a prompt within audio output 1240 for permission to share system data, user data corresponding to user 1210, and/or other application data with the application (e.g., quiz application 1226). In some embodiments, the indication that computer system 1200 cannot perform the task includes haptic feedback (e.g., a haptic feedback through a haptic hardware component in communication with computer system 1200 and/or haptic feedback through another computer system held and/or worn by user 1210), visual content (e.g., displayed content corresponding to computer system 1200, the agent, and/or the application (e.g., quiz application 1226)), and/or audio content (e.g., a synthetic voice output and/or tone output). In some embodiments, the indication and/or response includes an indication of the application (e.g., quiz application 1226) that is able to perform the task.

In some embodiments, computer system 1200 (e.g., the agent asked to perform the task) interacts with the application that can perform the task via one or more interfaces, such as an API. For example, the agent represented by avatar 1208 can be capable of knowing it cannot perform a task, but have the capability of interfacing via an API with an application that can perform the task. The agent can then interact with a user 1210 to gather input and/or data for the task and provide to the application. Likewise, the agent can receive output from the application and appear to provide (e.g., via output of speech and/or visual user interface objects) such output via one or more output components of computer system 1200. In some embodiments, the agent hands over a portion of a user interface to the application (e.g., a portion or all of user interface 1204 for displaying a result of the requested task, such as a Spanish vocabulary flashcard).

In some embodiments, computer system 1200 is able to perform the task, computer system 1200 does not output the response and/or indication and performs the task. In some embodiments, an agent performs and/or requests computer system 1200 to perform the task. For example, an agent performing a task includes: computer system 1200 transmitting user 1210's request to an agent, the agent determining the steps required to perform the task, and the agent requesting computer system 1200 perform the steps required to perform the task.

At FIG. 12B, after prompting user 1210 for permission to use quiz application 1226 to perform the task, user 1210 issues an affirmative response (e.g., voice input 1205B). As illustrated in FIG. 12B, user 1210 states “yes,” providing computer system 1200 the affirmative response to the prompt for permission to use quiz application 1226. As a result, computer system 1200 detects voice input 1205B, providing computer system 1200 permission to use the application to perform the task.

At FIG. 12B, in response to detecting voice input 1205B (e.g., illustrated in FIG. 12B as “yes”), providing computer system 1200 permission to use quiz application 1226, computer system 1200 launches quiz application 1226. As illustrated in FIG. 12B, computer system 1200 launching quiz application 1226 includes computer system 1200 displaying content from quiz application 1226. As illustrated at FIG. 12B, computer system 1200 displays quiz application 1226's title (e.g., quiz application title 1226A), a flash card control (e.g., quiz app control 1226D), and one or more flash cards (e.g., English flash card 1226B and/or Spanish flash card 1226C). In some embodiments, the content from quiz application 1226 includes audio content. For example, audio versions of the flash cards (e.g., English flash card 1226B and/or Spanish flash card 1226C) displayed by computer system 1200 can be provided as audio output. As illustrated at FIG. 12B, alongside the content from quiz application 1226, computer system 1200 displays avatar 1208 to indicate that user 1210 is continuing to interact with the agent. In some embodiments, quiz application 1226 is a remote application and computer system 1200 receives quiz application 1226's content from another computer system. For example, computer system 1200 communicating with a third-party server and/or computer system to receive remotely stored content and/or additional content.

In some embodiments, quiz application 1226 corresponds to a third-party and/or remote agent. In some embodiments, computer system 1200 (e.g., using the agent) communicates with the quiz application agent. In some embodiments, the quiz application agent determines the content to communicate (e.g., transmit and/or share) to computer system 1200 based on the task requested by user 1210. For example, computer system 1200 communicating to the quiz application agent that user 1210 requested to practice Spanish, and the quiz application agent determines the content that computer system 1200 should display.

In some embodiments, a task requires computer system 1200 and/or the agent to interact with computer system 1200's resources. For example, user 1210 asking, “Can I get help doing my tax return?” In some embodiments, computer system 1200 identifies one or more files related to the task (e.g., tax return and/or wage related documents) and requests permission from user 1210 to perform an operation with and/or on the file. For example, computer system 1200 identifying tax return documents and prompting user 1210 for permission to send the tax return documents to a document editing application. In some embodiments, computer system 1200 performs the operation with and/or on the files. In some embodiments, computer system 1200 transfers the one or more files to an application to perform the operation with and/or on the files.

FIG. 13 is a flow diagram illustrating a process for providing an application to perform a requested task using a computer system in accordance with some embodiments. Process 1300 is performed at a computer system (e.g., 100, 200, and/or 1200). Some operations in process 1300 are, optionally, combined, the orders of some operations are, optionally, changed, and some operations are, optionally, omitted.

As described below, process 1300 provides an intuitive way for providing an application to perform a requested task. The process reduces the cognitive burden on a user for providing an application to perform a requested task, thereby creating a more efficient human-machine interface. For battery operated computing devices, enabling a user to provide an application to perform a requested task faster and more efficiently conserves power and increases the time between battery charges.

In some embodiments, process 1300 is performed at a computer system (e.g., 100, 200, and/or 1200) that is in communication with one or more input devices (e.g., 140 and/or 200-14) (e.g., a camera, a depth sensor, and/or a microphone) and one or more output devices (e.g., 140 and/or 200-16) (e.g., a speaker, a haptic output device, a display screen, a projector, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device.

The computer system detects (1302), via the one or more input devices, an input (e.g., 1205A and/or 1405A) (e.g., a tap input and/or a non-tap input (e.g., a verbal input, an audible request, an audible command, an audible statement, a swipe input, a hold-and-drag input, a gaze input, an air gesture, and/or a mouse click)) corresponding to a request to perform a task (e.g., one or more actions and/or operations), wherein the input (and/or the request) is directed to (e.g., via an application interface of) a first application (e.g., as described above with respect to FIG. 12A) (e.g., an agent corresponding to the first application) (e.g., a system application or a user application).

In response to (1304) (and/or after) detecting the input (e.g., 1205A and/or 1405A), in accordance with a determination that the first application is not able to perform the task (e.g., and that another application (e.g., the second application) can and/or is able to perform the task) (e.g., that the task does not correspond to the first application and/or that the task corresponds to another application different from the first application), the computer system outputs (1306), via the one or more output devices, a response that includes (e.g., as described above with respect to FIG. 12B): (1308) an indication (e.g., 1240) that the first application is not able to perform the task (e.g., lacks capability, lacks functionality, lacks sufficient information, and/or lacks permission); and content (1310) (e.g., 1226A and/or 1226B) from a second application, wherein the second application is able to (e.g., determined to be able to) perform the task and wherein the second application is different from the first application (e.g., as described above with respect to FIG. 12B). In some embodiments, the computer system displays the response at a user interface of the first application. In some embodiments, the computer system displays the response while the first application continues to have focus (e.g., is active application). In some embodiments, the computer system displays the response without starting (e.g., executing, calling, activating, messaging, and/or communicating with the second application).

In response to (1304) detecting the input (e.g., 1205A and/or 1405A), in accordance with (1312) a determination that the first application is able to perform the task (e.g., that the task corresponds to the first application and, in some examples, one or more other applications different from the first application), the computer system forgoes (1314) outputting, via the one or more output devices, the response (e.g., 1240).

In response to (1304) detecting the input, in accordance with (1312) the determination that the first application is able to perform the task, the computer system performs (1316) (e.g., via the first application) a set of one or more actions (and/or operations) corresponding to (e.g., is related to, is a substitute for, and/or is configured to be performed with) the task (e.g., as illustrated in FIGS. 14B-14C) (e.g., as described with respect to FIGS. 12A-12B and 14A-14C) (e.g., perform the task, less than all of the task, and/or a different task that corresponds to the task). In some embodiments, performing the set of action corresponding to the task includes (e.g., and/or is performed in conjunction with (e.g., at the same time as and/or before)) outputting, via the one or more output devices, a second response corresponding to the task. In some embodiments, the second response is different from the response. In some embodiments, the second response does not include content from the first application that is able to perform the task. In some embodiments, both the agent and the first application can perform the task. In some embodiments, the agent corresponds to a second application different from the first application. Outputting the response that includes the indication that the first application is not able to perform the task and the content from the second application when the first application is not able to perform the task allows the computer system to indicate to a user an ability of the first application while also outputting a solution to the ability of the first application without requiring the user to identify the second application itself, thereby providing improved feedback to the user, reducing the number of inputs needed to perform an operation, and/or performing an operation when a set of conditions has been met without requiring further user input.

In some embodiments, the first application corresponds to (e.g., is, is connected to, queries, includes, accesses, obtains a response from, and/or obtains an output from) a first agent (e.g., 1208) (e.g., for responding to natural language requests). In some embodiments, the first agent represents (e.g., corresponds to, uses, includes, accesses, is connected to, obtains a response from, obtains an output from, and/or is generated from) one or more interactive knowledge bases (e.g., as described above with respect to FIG. 12A) (e.g., knowledge bases and/or information connecting different concepts, such that the first agent can respond to natural language requests). In some embodiments, the one or more interactive knowledge bases includes one or more artificial intelligence models and/or one or more large language models. In some embodiments, the first application is a communication layer for the first agent. In some embodiments, the first application is an application that communicates and/or obtains responses from the first agent. In some embodiments, the first application has additional functionality outside of accessing and/or communicating with the first agent. In some embodiments, the first application is a user interface in communication with the first agent and communicates the input to the first agent. In some embodiments, the first application requests the first agent to output a response based on the input through use of the one or more interactive knowledge bases. In some embodiments, the first application communicates directly with the first agent. In some embodiments, the first application communicates with the computer system and the computer system communicates and/or transcribes to the first agent. In some embodiments, at least a portion of the one or more interactive knowledge bases is stored by the computer system (e.g., in memory of the computer system). In some embodiments, in conjunction with detecting the input, the computer system outputs, via the one or more output devices, a representation (e.g., a UI object (e.g., a personal assistant and/or an avatar representing a personal assistant)) of the first agent. The first application corresponding to the first agent allows the computer system to respond to natural language requests that correspond to the one or more interactive knowledge bases, thereby providing improved feedback to the user, reducing the number of inputs needed to perform an operation, and/or performing an operation when a set of conditions has been met without requiring further user input.

In some embodiments, the second application corresponds to (e.g., is, is connected to, includes, accesses, obtains a response from, and/or obtains an output from) a second agent (e.g., for responding to natural language requests) (e.g., a third party application, third party API, and/or third party service) different (and/or separate) from the first agent (e.g., as described above with respect to FIGS. 12A-12B). In some embodiments, the second agent represents (e.g., corresponds to, uses, includes, accesses, is connected to, obtains a response from, obtains an output from, and/or is generated from) one or more interactive knowledge bases (e.g., different from the one or more interactive knowledge bases of the first agent). In some embodiments, the second agent is a local application on the computer system. In some embodiments, the second agent is a native application and/or system (e.g., operating system) application (e.g., of the computer system). In some embodiments, the second application is a third-party application (e.g., downloaded and/or installed on the computer system (e.g., by a user of the computer system)). In some embodiments, the second agent is a remote service and/or application in communication with the computer system. In some embodiments, the second agent is in communication with the first agent and/or the computer system (e.g., simultaneously when both). In some embodiments, the second agent is only in communication with the first agent and/or the computer system when queried by the first agent and/or the computer system. In some embodiments, in conjunction with and/or after outputting the response, the computer system outputs, via the one or more output devices, a representation (e.g., a UI object (e.g., a personal assistant and/or an avatar representing a personal assistant)) of the second agent. In some embodiments, the representation of the second agent is different from the representation of the first agent. In some embodiments, the second agent responds with different content than the first agent in response to detecting the same input (e.g., the same natural language request). The second application corresponding to the second agent allows the computer system to respond to natural language requests using different agents when a particular agent is better suited and/or able to respond to a particular natural language request, thereby providing improved feedback to the user, reducing the number of inputs needed to perform an operation, and/or performing an operation when a set of conditions has been met without requiring further user input.

In some embodiments, the computer system (e.g., 1200) is a first computer system. In some embodiments, the content from the second application is received from (e.g., obtained from, communicated from, and/or sent by) a second computer system different from the first computer system (e.g., as described above with respect to FIGS. 12A-12B). In some embodiments, the second computer system is a server, a network device, a hosting device, a watch, a phone, a tablet, a fitness tracking device, a processor, a head-mounted display (HMD) device, a communal device, a media device, a speaker, a television, and/or a personal computing device. In some embodiments, before outputting, via the one or more output devices, the content from the second application, the computer system: queries the second computer system for whether the second computer system is able to perform the task; receives a confirmation from the second computer system that the second computer system is able to perform the task; and/or, in response to receiving the confirmation, requesting content from the second computer system. Receiving the content from the second application from the second computer system allows the first computer system to respond to requests using content from other computer systems when needed, thereby providing improved feedback to the user, reducing the number of inputs needed to perform an operation, and/or performing an operation when a set of conditions has been met without requiring further user input.

In some embodiments, in response to (and/or after) detecting the input (e.g., 605A), the computer system identifies one or more files (e.g., locally stored on the computer system, remotely stored on another computer system (e.g., the second computer system or another computer system different from the second computer system), and/or remotely stored on a third-party service) (e.g., one or more related files) corresponding to the task (e.g., 1240) (e.g., as described above with respect to FIG. 12B). In some embodiments, the first application and/or the first agent identifies the one or more files. In some embodiments, the second application and/or the second agent identifies the one or more files. In some embodiments, the first application, the first agent, the second application, and/or the second agent requests the computer system to identify the one or more files. In some embodiments, identifying the one or more files is based on one or more file properties (e.g., file name, file history, file type, and/or file location). In some embodiments, identifying the one or more files is based on a score that corresponds to a likelihood that a file is related to the task. In some embodiments, the input does not indicate and/or identify the one or more files. In some embodiments, in response to identifying the one or more files corresponding to the task (and/or before or after outputting the content from the second application), the computer system outputs, via the one or more out devices, a request for permission (e.g., 1240) (and/or prompting for permission) (and/or from a user) to perform one or more operations with (e.g., on, using, and/or based on) the one or more files (e.g., as described above with respect to FIG. 12B) (e.g., read from the one or more files, write to the one or more files, send the one or more files to the second application, and/or perform the task on the one or more files). In some embodiments, the input is a first input. In some embodiments, while outputting the request for permission, the computer system detects, via the one or more input devices, a second input (e.g., different from the first input), via the one or more input devices, corresponding to the request for permission. In some embodiments, in response to detecting the second input and in accordance with a determination that the second input corresponds to approval (e.g., an affirmative response) (and/or before or after outputting the content from the second application), the computer system sends the one or more files to the second application. In some embodiments, in response to detecting the second input and in accordance with a determination that the second input corresponds to rejection, the computer system does not send (and/or forgoes send of) the one or more files to the second application. In some embodiments, the request for permission is included in a user interface (e.g., that is output via the one or more output devices). In some embodiments, the request for permission is output via one or more speakers in communication with the computer system. Outputting the request for permission to perform the one or more operations with the one or more files allows the computer system to obtain permission to use data to perform tasks directed to the first application (e.g., particularly, when the one or more files are associated with another application different from the first application), thereby providing improved feedback to the user, reducing the number of inputs needed to perform an operation, performing an operation when a set of conditions has been met without requiring further user input, and/or improving security. Identifying the one or more files in response to detecting the input allows the computer system (and/or the first application) to intelligently and/or automatically respond to natural language requests without requiring a user to define each parameter and/or input for the natural language requests, thereby providing improved feedback to the user, reducing the number of inputs needed to perform an operation, and/or performing an operation when a set of conditions has been met without requiring further user input.

In some embodiments, the input is a first input. In some embodiments, in conjunction with outputting, via the one or more out devices, the request for permission to perform the one or more operations with the one or more files, the computer system detects, via the one or more input devices, an input corresponding to an affirmative response to the request for permission (e.g., as described above with respect to FIG. 12B). In some embodiments, in response to (and/or in conjunction with and/or after) detecting the input corresponding to the affirmative response to the request for permission (e.g., 1205B), the computer system performs (e.g., via the second application) the one or more operations (e.g., read from the one or more files, write to the one or more files, send the one or more files to the second application, and/or perform the task on the one or more files) with the one or more files (e.g., as described above with respect to FIG. 12B). In some embodiments, in response to (and/or in conjunction with and/or after) detecting the input corresponding to the affirmative response to the request for permission and in accordance with a determination that the one or more files are remotely located, the computer system obtains, from another computer system remote from the computer system, the one or more files. In some embodiments, in response to (and/or in conjunction with and/or after) detecting the input corresponding to the affirmative response to the request for permission and in accordance with a determination that the one or more files are remotely located, the computer system sends, to the second application, an identification of a location of the one or more files. In some embodiments, the one or more operations is performed with the one or more files by the first application and/or the second application. Performing the one or more operations with the one or more files in response to detecting the input corresponding to the affirmative response to the request for permission allows the computer system to proceed with operation in response to detecting an affirmative response for permission, thereby providing improved feedback to the user, performing an operation when a set of conditions has been met without requiring further user input, and/or improving security.

In some embodiments, after (and/or in response to) detecting the input and in accordance with a determination that the first application is not able to perform the task, the computer system outputs, via the one or more output devices, a prompt (e.g., 1240) (e.g., prompt to illicit an input (e.g., a tap input and/or a non-tap input (e.g., a verbal input, an audible request, an audible command, an audible statement, a swipe input, a hold-and-drag input, a gaze input, an air gesture, and/or a mouse click)) from a user) (e.g., a statement to alert a user to the required additional input) for input. In some embodiments, the response includes the prompt. In some embodiments, the prompt is output after and/or in response to outputting the content from the second application. In some embodiments, the prompt is output before outputting the content from the second application. In some embodiments, the content from the second application is output after detecting input (e.g., a tap input and/or a non-tap input (e.g., a verbal input, an audible request, an audible command, an audible statement, a swipe input, a hold-and-drag input, a gaze input, an air gesture, and/or a mouse click)) corresponding to the prompt and in accordance with a determination that the input corresponding to the prompt is an affirmative response. In some embodiments, the content from the second application is not output after detecting input corresponding to the prompt and in accordance with a determination that the input corresponding to the prompt is a negative affirmative and/or rejection response. In some embodiments, the prompt is a request for permission to perform an operation (e.g., permission to launch an application, permission to access data, and/or permission to share data) (e.g., via the second application). In some embodiments, the input corresponding to the prompt includes additional task input (e.g., providing alternative task and/or cancelling the initial task). In some embodiments, the input corresponding to the prompt includes confirmation (e.g., acceptance of a request). In some embodiments, in response to detecting the input corresponding to the prompt, the computer system performs (e.g., via the first application and/or the second application) a second set of one or more actions (e.g., operations) corresponding to (e.g., is related to, is a substitute for, and/or is configured to be performed with) the task (e.g., perform the task, less than all of the task, and/or a different task that corresponds to the task). In some embodiments, the second set of one or more actions includes prompting a user for an alternative and/or related task. In some embodiments, the second set of one or more actions includes prompting a user for an alternative and/or related input. In some embodiments, performing the second set of action corresponding to the task includes (e.g., and/or is performed in conjunction with (e.g., at the same time as and/or before)) outputting, via the one or more output devices, a second response corresponding to the task. In some embodiments, the second response is different from the response. In some embodiments, the second response does not include content from the first application. Outputting the prompt for input when the first application is not able to perform the task allows the computer system to inform a user with respect to operation of the computer system and/or allow the user to control further operation of the computer system, thereby providing improved feedback to the user, reducing the number of inputs needed to perform an operation, and/or performing an operation when a set of conditions has been met without requiring further user input.

In some embodiments, the prompt includes a request to launch the second application (e.g., as described above with respect to FIG. 12B). In some embodiments, after (and/or while) outputting the prompt, the computer system detects, via the one or more output devices, an input (e.g., 1205B) corresponding to the request to launch the second application (e.g., as described above with respect to FIG. 12B). In some embodiments, in response to detecting the input corresponding to the request to launch the second application (e.g., QuizApp of FIG. 12B), in accordance with a determination that the input corresponding to the request to launch the second application corresponds to an affirmative response, the computer system launches (e.g., executing) the second application (e.g., as described above with respect to FIG. 12B) (e.g., causing the second application to execute as a background or foreground process of the computer system). In some embodiments, in response to detecting the input corresponding to the request to launch the second application, in accordance with a determination that the input corresponding to the request to launch the second application corresponds to a negative response (e.g., different from the affirmative response) (e.g., does not include an affirmative response), the computer system forgoes launch (e.g., execution) of the second application (e.g., as described above with respect to FIG. 12B). In some embodiments, launching the second application includes increasing display of, displaying, and/or maximizing display of a user interface of the second application. In some embodiments, launching the second application includes relinquishing control of the one or more output devices to the second application. In some embodiments, launching the second application includes initiating functionality provided by the second application without maximizing the second application. Selectively launching the second application in response to the input corresponding to the request to launch the second application after prompting for permission to use the one or more files allows the computer system to use different applications executing on the computer system to handle different requests, thereby providing improved feedback to the user, reducing the number of inputs needed to perform an operation, and/or performing an operation when a set of conditions has been met without requiring further user input.

In some embodiments, the prompt includes a request to share data with the second application (and/or requestion permission to request the computer system to share data with the second application) (e.g., as described above with respect to FIG. 12B). In some embodiments, after (and/or while) outputting the prompt, the computer system detects, via the one or more output devices, an input (e.g., 1205B) corresponding to the request to share data (e.g., the one or more files, device data, user data, current environment data, prompt data, input stream data, and/or output stream data) with the second application. In some embodiments, in response to detecting the input corresponding to the request to share data with the second application, in accordance with a determination that the input corresponding to the request to share data with the second application corresponds to an affirmative response, the computer system shares (e.g., sending) the one or more files to the second application (e.g., as described above with respect to FIG. 12B). In some embodiments, in response to detecting the input corresponding to the request to share data with the second application, in accordance with a determination that the input corresponding to the request to share data with the second application corresponds to a negative response (e.g., different from the affirmative response) (e.g., does not include an affirmative response), the computer system forgoes share (e.g., send) of the one or more files (and/or requesting the computer system and/or first application to share data) (e.g., device data, user data, current environment data, prompt data, input stream data, and/or output stream data) with the second application (e.g., as described above with respect to FIG. 12B). In some embodiments, sharing the one or more files with the second application is completed locally on the computer system. In some embodiments, sharing the one or more files with the second application includes querying a remote computer system to retrieve the one or more files to be shared. Selectively sharing the one or more files with the second application in response to the input corresponding to the request to share data with the second application after prompting for permission to use the one or more files allows the computer system to use different applications executing on the computer system to handle different requests, thereby providing improved feedback to the user, reducing the number of inputs needed to perform an operation, and/or performing an operation when a set of conditions has been met without requiring further user input.

In some embodiments, the input (e.g., 1205A) is a first input. In some embodiments, while outputting the response, the computer system detects, via the one or more input devices, a second input (e.g., 1205B) (e.g., corresponding to the response and/or a user interface element of the response) (e.g., a tap input and/or a non-tap input (e.g., a verbal input, an audible request, an audible command, an audible statement, a swipe input, a hold-and-drag input, a gaze input, an air gesture, and/or a mouse click)) different from the first input. In some embodiments, in response to detecting the second input, the computer system transitions from the first application (e.g., as a foreground process) to the second application (e.g., 1226A) (e.g., as a foreground process, such that, in some embodiments, the first application becomes a background process and/or an inactive process) (e.g., displaying, via a display component of the one or more output components, a user interface of the second application (e.g., while no longer outputting, via the one or more output devices, content corresponding to the first application (e.g., a user interface of the first application))) (e.g., the first application relinquishes control (e.g., of the one or more output devices) to the second application). In some embodiments, the first application relinquishing control to the second application includes the second application taking control of the one or more output devices. In some embodiments, relinquishing control of the one or more output devices includes forgoing output corresponding to the first application and outputting content corresponding to the second application. In some embodiments, the second application simultaneously gains control of the one or more output devices and outputs content. In some embodiments, the second application delays output of content from when the second application gains control of the one or more output devices. Transitioning from the first application to the second application in response to detecting the second input allows the computer system to provide focus to an application that is responding to a request rather than continue having the application operate without focus, thereby providing improved feedback to the user, reducing the number of inputs needed to perform an operation, and/or performing an operation when a set of conditions has been met without requiring further user input.

In some embodiments, performing the set of one or more actions includes obtaining, from a third application (e.g., Map App of FIGS. 14B-14C) (e.g., the second application or another application different from the second application) different from the first application (and/or the second application), content (e.g., 1432, 1434, and/or 1436) from the third application without indicating that the first application is not able to perform the task (e.g., as described above with respect to FIGS. 12A-12B). In some embodiments, performing the set of one or more actions includes outputting, via the one or more output devices, the content from the third application. In some embodiments, performing the set of one or more actions includes outputting, via the one or more output devices, content corresponding to the content from the third application. Obtaining the content from the third application without indicating that the first application is not able to perform the task allows the computer system to selectively indicate when the first application is not able to perform the task (e.g., such as when the content obtained from another application meets a set of one or more criteria, such as being private, personal, and/or otherwise sensitive content), thereby reducing the number of inputs needed to perform an operation and/or performing an operation when a set of conditions has been met without requiring further user input.

In some embodiments, the input (e.g., 1205A) is (and/or includes) a verbal input (e.g., 1212). In some embodiments, the verbal input includes key phrases and/or predetermined commands (e.g., a wake phrase, an action phrase, and/or a sleep phrase). In some embodiments, the verbal input includes a series of inputs (e.g., an initial wake input, an input prompt, and/or an input phrase). In some embodiments, the verbal input includes a key term to initiate input. The input being a verbal input allows the computer system to respond to different types of inputs, including a natural language input that is verbal, thereby providing improved feedback to the user, reducing the number of inputs needed to perform an operation, and/or performing an operation when a set of conditions has been met without requiring further user input.

In some embodiments, the indication that the first application is not able to perform the task includes a haptic output, via the one or more output devices (e.g., as described above with respect to FIGS. 12A-12B). In some embodiments, the haptic output is performed by the computer system. In some embodiments, the haptic output is performed by a second computer system that is in communication with the computer system. In some embodiments, the haptic input consists of haptic pulses. In some embodiments, the haptic pulses include a rhythm and/or pattern. In some embodiments, the computer system tailors the rhythm and/or pattern of the haptic pulses to define the particular output (e.g., providing different haptic feedback depending on the state of being able to perform the action and/or not being able to perform the action) (e.g., providing different haptic feedback depending on the application to perform the task). The indication that the first application is not able to perform the task including a haptic output allows the computer system to physically indicate to a user that is holding and/or touching the computer system with respect to an internal state of the computer system (e.g., how an application is operating), thereby providing improved feedback to the user and/or performing an operation when a set of conditions has been met without requiring further user input.

In some embodiments, the indication that the first application is not able to perform the task includes visual output (e.g., as described above with respect to FIGS. 12A-12B) (e.g., that is output via a display component of the one or more output devices) (e.g., of a user-interface element in a user interface that is displayed by the computer system). In some embodiments, the visual output corresponds and/or is specific to the first application (e.g., names the first application). In some embodiments, the visual output is a generalized representation for failing to perform the task regardless of application. The indication that the first application is not able to perform the task including a visual output allows the computer system to visually indicate to a user with respect to an internal state of the computer system (e.g., how an application is operating), thereby providing improved visual feedback to the user and/or performing an operation when a set of conditions has been met without requiring further user input.

In some embodiments, the indication that the first application is not able to perform the task includes physical movement of a first portion (e.g., a housing and/or an enclosure including a display component and/or the one or more input devices) (e.g., a front portion) (of the computer system via a movement component that physically moves the first portion) of the computer system (e.g., as described above with respect to FIGS. 12A-12B) (e.g., not mere movement of a user-interface element). In some embodiments, the computer system causes, via a movement component in communication with the computer system, the physical movement. In some embodiments, the physical movement includes translation and/or rotation of the first portion. In some embodiments, the physical movement is different from haptic and/or tactile output. In some embodiments, physical movement is haptic and/or tactile output.

In some embodiments, the indication that the first application is not able to perform the task includes audio output (e.g., as described above with respect to FIGS. 12A-12B) (e.g., that is output via a speaker of the one or more output devices). In some embodiments, the audio output corresponds and/or is specific to the first application (e.g., audio output to inform a user that the first application is not able to perform the task) (e.g., names the first application). In some embodiments, the audio output is a generalized alert output (e.g., a preset tone and/or rhythm output by the computer system when an application is unable to perform the task). In some embodiments, the audio output includes one or more instructions and/or prompting (e.g., a prompt eliciting additional input by a user). The indication that the first application is not able to perform the task including an audio output allows the computer system to acoustically indicate to a user with respect to an internal state of the computer system (e.g., how an application is operating), thereby providing improved feedback to the user and/or performing an operation when a set of conditions has been met without requiring further user input.

In some embodiments, the content from the second application includes audio content (e.g., as described above with respect to FIG. 12B). In some embodiments, the audio content is outputted by the computer system. In some embodiments, the audio content is outputted by a second computer system that is in communication with the computer system. In some embodiments, the computer system is in control of the second computer system and initiates output of the audio content on the second computer system. In some embodiments, the audio content is received from a remote computer system. In some embodiments, the audio content includes introduction content (e.g., initial information on the second application before outputs from the second application). In some embodiments, the second application immediately outputs audio content corresponding to the task. The content from the second application including audio content allows the computer system to output different content in different ways without always taking up visual space for a user, thereby providing improved feedback to the user and/or performing an operation when a set of conditions has been met without requiring further user input.

In some embodiments, the content from the second application includes visual content (e.g., 1226A, 1226B, 1226C, and/or 1226D) (e.g., as described above with respect to FIG. 12B) (e.g., that is output via a display component of the one or more output devices) (e.g., a user-interface element in a user interface that is displayed by the computer system). In some embodiments, the visual content corresponds and/or is specific to the second application (e.g., names the second application). In some embodiments, the visual content is output by the computer system. In some embodiments, the visual content is output by another computer system that is in communication with the computer system. In some embodiments, the visual content is received from a remote computer system (e.g., a remote media server). In some embodiments, the visual content includes content about the second application. The content from the second application including visual content allows the computer system to output different content in different ways, such as by emphasizing certain content by outputting such content visually, thereby providing improved feedback to the user and/or performing an operation when a set of conditions has been met without requiring further user input.

In some embodiments, performing (e.g., via the first application) the set of one or more actions (and/or operations) corresponding to (e.g., is related to, is a substitute for, and/or is configured to be performed with) the task includes displaying content (e.g., as described above with respect to FIG. 12B) (e.g., corresponding to the first application and/or the second application) (e.g., that is output via a display component of the one or more output devices) (e.g., a user-interface element in a user interface that is displayed by the computer system). In some embodiments, the computer system displays the content. In some embodiments, another computer system that is in communication with the computer system displays the content. In some embodiments, the content displayed includes content from the first application and/or the second application. Performing the set of one or more actions including displaying content allows the computer system to visually provide context of what the computer system is doing, thereby providing improved feedback to the user and/or performing an operation when a set of conditions has been met without requiring further user input.

In some embodiments, performing the set of one or more actions includes moving (e.g., physically moves), via a movement component (e.g., 140 and/or 200-16) of the one or more output devices, a second portion (e.g., a housing and/or an enclosure including a display component and/or the one or more input devices) ((e.g., a front portion) of the computer system via a movement component that physically moves the first portion) of the computer system (e.g., 1200) (e.g., not mere movement of a user-interface element). In some embodiments, moving includes translating and/or rotating the second portion. In some embodiments, moving is different from causing haptic and/or tactile output. In some embodiments, moving causes haptic and/or tactile output.

In some embodiments, performing (e.g., via the first application) the set of one or more actions (and/or operations) corresponding to (e.g., is related to, is a substitute for, and/or is configured to be performed with) the task includes outputting audio content (e.g., as described above with respect to FIG. 12B) (e.g., corresponding to the first application and/or the second application). In some embodiments, the computer system outputs the audio content. In some embodiments, another computer system that is in communication with the computer system outputs the audio content. In some embodiments, the second computer system is under the direction of (e.g., controlled by) the computer system. In some embodiments, the audio content corresponds to the first application and/or the second application. Performing the set of one or more actions including outputting audio content allows the computer system to acoustically provide context of what the computer system is doing, thereby providing improved feedback to the user and/or performing an operation when a set of conditions has been met without requiring further user input.

In some embodiments, the response includes content from the first application (e.g., 1208) (e.g., as described above with respect to FIG. 12B). In some embodiments, the content from the first application and the content from the second application is output simultaneously. In some embodiments, the content from the first application includes a representation of the first application. The response including content from both the first application and the second application allows the computer system to respond to input using multiple applications, thereby providing improved feedback to the user and/or performing an operation when a set of conditions has been met without requiring further user input.

In some embodiments, the indication includes an indication of the second application (e.g., 1226A) (and/or an indication that the second application is performing (and/or is able to perform) the task). In some embodiments, the indication of the second application includes a representation of the second application. In some embodiments, the indication of the second application is output alongside and/or simultaneously as the content from the second application. In some embodiments, the indication of the second application is output for a predetermined amount of time after outputting the response. In some embodiments, the indication of the second application is no longer output after the predetermined amount of time. The indication including the indication of the second application allows the computer system to indicate to a user an origin of content, thereby providing improved feedback to the user and/or performing an operation when a set of conditions has been met without requiring further user input.

Note that details of the processes described above with respect to process 1300 (e.g., FIG. 13) are also applicable in an analogous manner to the process described below/above. For example, process 1500 optionally includes one or more of the characteristics of the various processes described above with reference to process 1300. For example, the requested operation of process 1300 can also be the input for process 1500. For brevity, these details are not repeated below.

FIGS. 14A-14C illustrate exemplary user interface for providing multiple applications to perform a requested task in accordance with some embodiments. The user interfaces in these figures are used to illustrate the processes described below, including the processes in FIGS. 13 and 15.

As illustrated in environment 1206 of FIG. 14A, user 1210 is within computer system 1200's field of view (e.g., represented by dotted lines casting away from computer system 1200). At FIG. 14A, computer system 1200 detects user 1210. In some embodiments, computer system 1200 transitions from an inactive to an active state upon detecting user 1210. In some embodiments, when computer system 1200 is inactive, computer system 1200 reduces screen brightness, reduces input device capabilities (e.g., turning off a touch sensitive display component until a user is detected and/or requiring an initial input to wake computer system 1200 before allowing a request), and/or reduces content displayed on user interface 1204. In some embodiments, when computer system transitions to an active state, computer system 1200 increases screen brightness, displays additional user interface components (e.g., avatar 1208), and/or enabled additional input devices. In some embodiments, transitioning between an inactive state and an active state is done through an animation. For example, fading out displayed content when transitioning to inactive and/or fading in content to be displayed when transitioning to active (e.g., displaying content at a reduced brightness and/or opacity and increasing the brightness and/or opacity over a predetermined amount of time).

At FIG. 14A, in response to computer system 1200 detecting user 1210, computer system 1200 awaits an input from user 1210. As illustrated in FIG. 14A, computer system 1200 displays avatar 1208 within user interface 1204. In some embodiments, computer system 1200 begins detecting inputs upon detecting user 1210. In some embodiments, computer system 1200 waits until avatar 1208 is displayed to detect an input, indicating that user 1210 is interacting with an agent. In some embodiments, computer system 1200 displaying user interface 1204 including only avatar 1208 indicates that computer system 1200 is awaiting an input from a detected user (e.g., user 1210). For example, computer system 1200 awaits a request from user 1210 to perform a task (e.g., voice input 1405A).

At FIG. 14A, while computer system 1200 displays avatar 1208 (e.g., a representation and/or indication of an agent) and awaits an input from a user (e.g., user 1210), user 1210 asks computer system 1200 to perform a task. As illustrated in FIG. 14A, user 1210 asks “How can I get to work today?” (e.g., voice input 1405A). At FIG. 14A, computer system 1200 detects voice input 805A from user 1210 asking computer system 1200 to perform a task.

At FIG. 14B, in response to detecting voice input 1405A, computer system 1200 determines that there are multiple options (e.g., drive option 1432, public transport option 1434, and/or carpool option 1436) able to perform the task. In some embodiments, computer system 1200 performs the determination and compiles the options (e.g., drive option 1432, public transport option 1434, and/or carpool option 1436) to be displayed. In some embodiments, computer system 1200 is in communication with a remote computer system and/or agent that performs the determination and communicates the options to computer system 1200. In some embodiments, the determination that there are multiple options is based on the capabilities of a set of one or more applications on computer system 1200 and/or in communication with computer system 1200. For example, computer system 1200 is able to include a third-party public transportation application named Bus App (e.g., represented by public transport option 1434) because the application is on computer system 1200 and/or computer system 1200 is in communication with the Bus App. For example, as described above with respect to FIGS. 12A-12B, the agent represented by avatar 1208 can interface with the Bus App using an API for the purpose of completing the requested task.

At FIG. 14B, computer system 1200 determines that an agent is able to use multiple options (e.g., resources, agents, and/or applications) to perform the task based on the capabilities of an application corresponding to the option. In this example, drive option 1432 and carpool option 1436 are options based on the capabilities of a maps application (named Map App). In this example, Map App is an application that provides navigation and/or routing information to a user (e.g., user 1210) based on driving, walking, and/or a combination of driving and walking. For example, carpool option 1436 includes both a walk (e.g., illustrated as “3 minute walk”) and a drive (e.g., illustrated as “18 minute drive”) portion, as illustrated in FIG. 14B. In some embodiments, when multiple options are able to perform the task, computer system 1200 weighs the options against a predetermined metric corresponding to the task, and computer system 1200 only includes a predetermined number of options based on the weights. For example, computer system 1200 weighing four options to complete a navigation task, computer system 1200 includes the top three options based on duration to complete the route. For example, computer system 1200 not including an option outside of a predetermined range of the other options (e.g., not displaying an option that is 10%, 15%, and/or 25% worse compared to the other options).

At FIG. 14B, in response to determining that there are multiple options able to perform the task, computer system 1200 outputs the multiple options (e.g., drive option 1432, public transport option 1434, and/or carpool option 1436). As illustrated in FIG. 14B, computer system 1200 displays three options (e.g., drive option 1432, public transport option 1434, and/or carpool option 1436) alongside avatar 1208. Also illustrated in FIG. 14B, computer system 1200 outputs an indication that there are multiple options to perform the task (e.g., audio output 1428 (“Here are some options I found.”)). In this example, computer system 1200 continues to display avatar 1208 to indicate that user 1210 is still interacting with an agent. In some embodiments, computer system ceases to display avatar 1208 upon displaying one or more options. At FIG. 14B, each one of the three displayed options represent an option that is capable of being performed by (and/or using and/or caused by) computer system 1200 to satisfy user 1210's requested task. In some embodiments, computer system 1200 outputs the multiple options in an order corresponding to a metric of each option. For example, computer system 1200 outputting the multiple options in order from quickest to slowest in time to complete the task. In some embodiments, computer system 1200 outputs the multiple options in an order corresponding to a user's most used application and/or option. For example, computer system 1200 outputs drive option 1432 first based on user 1210's repeated use of Map App to navigate while driving.

In some embodiments, computer system 1200 displays information corresponding to one or more of the multiple options for performing the task. For example, such information can be information relevant to the task and/or the manner of performing the task via the corresponding option. In some embodiments, options have the same and/or different information and/or types of information. As illustrated in FIG. 14B, each option includes content describing the option's capability and/or method of performing the task. In this example, drive option 1432 includes a title (e.g., drive option title 1432A), a title of the corresponding application (and/or resource) (e.g., application 1432B) used for drive option 1432, and a duration of the option to perform the task (e.g., drive option duration 1432C). In this example, public transport option 1434 includes a title (e.g., public transport title 1434A), a title of the corresponding application (and/or resource) (e.g., Bus App title 1434B) used for public transport option 1434, a cost description (e.g., public transport cost 1434C), and a departure time (e.g., public transport departure 1434D). In this example, carpool option 1436 includes a title (e.g., carpool title 1436A), a title of the corresponding application (and/or resource) (e.g., application 1436B (e.g., same as application 1432B in this example)) used for carpool option 1436, and a combined duration description (e.g., duration 1436C). In this example, computer system 1200 outputs two options (drive option 1432 and/or carpool option 1436) from the same application.

At FIG. 14B, computer system 1200 outputs a representation of one or more of the multiple options (e.g., drive option 1432, public transport option 1434, and/or carpool option 1436) performing the requested task. For example, computer system 1200 outputs a map due to user 1210's request being a navigation task. In some embodiments, the options are displayed on top of the representation. For example, computer system 1200 displaying drive option 1432 and/or public transport option 1224 overlayed onto the map. In some embodiments, computer system 1200 displays the one or more options overlayed onto the representation with a set of differing visual characteristics (e.g., color, emphasis, and/or shape). For example, computer system 1200 displaying drive option 1432 in a color corresponding to the application used to complete the option and displaying public transport option 1434 in a different color corresponding to the application. In some embodiments, computer system 1200 uses one of the applications corresponding to the multiple options to display the corresponding option and the alternative options. For example, computer system 1200 displaying drive option 1432 in Map App, and displaying the bus route corresponding to public transport option 1434 within MapApp. In some embodiments, outputting the multiple options include audio content. For example, computer system 1200 outputting a generated speech readout of the one or more options.

At FIG. 14B, while displaying the multiple options able to perform the task, user 1210 issues voice input 1405B corresponding to selection of the second option (e.g., public transport option 1434). As illustrated in FIG. 14B, user 1210 states “Take the bus” corresponding to public transport option 1434 presented by computer system 1200. At FIG. 14B, computer system 1200 detects voice input 1405B corresponding to the selection of public transport option 1434.

At FIG. 14C, in response to detecting voice input 1405B, computer system 1200 performs a set of one or more actions to perform the task by using public transport option 1434. In this example, the set of one or more actions include obtaining the information required to book a bus ticket from user 1210's current position to user 1210's work via public transport, requesting “BusApp” book a bus ticket for user 1210 using the information about user 1210's route, performing a payment transaction for the bus ticket for user 1210, and/or confirming the ticket is successfully purchased. In some embodiments, computer system 1200 is in communication with a remote computer system, and the remote computer system performs the set of one or more actions required to perform the task. For example, computer system 1200 requesting a remote computer system book user 1210's bus ticket, and computer system 1200 receives a conformation including information about user 1210's booked bus ticket. While FIGS. 14A-14C illustrate computer system 1200 performing a navigation-based task for user 1210 through public transport option 1434, it should be recognized that this is for exemplary purposes and illustrates merely one type of task and one method of performing the task, and computer system 1200 can be capable of alternative tasks and/or methods of performing the tasks and/or alternative tasks.

At FIG. 14C, in response to detecting voice input 1405B (and/or in conjunction with (e.g., while, after, and/or in response to) performing the task) computer system 1200 receives, provides, and/or outputs information from performance of the task. For example, while computer system 1200 completes a set of one or more steps to perform the task using public transport option 1434, computer system 1200 retains information corresponding to the set of one or more actions to perform the task. At FIG. 14C, computer system 1200 receives (e.g., from Bus App) task-related information including ticket number 1434F, bus route number 1434G, and departure time 1434H. As a result, computer system 1200 compiles the retained information into confirmation 1434E, as illustrated in FIG. 14C.

As illustrated in FIG. 14C, in response to successfully completing the set of one or more actions required to perform the task using public transport option 1434, computer system 1200 outputs confirmation 1438 (e.g., user 1210's bus ticket information received from Bus App) and an indication (e.g., audio output 1230) that the task has been completed. As illustrated in FIG. 14C, the indication (e.g., audio output 1230) includes “Okay. Your ticket has been purchased.” In this example, confirmation 1438 includes user 1210's ticket number 1438A, route number 1438B, and departure time 1438C. In this example, computer system 1200 updated the departure information for public transportation option 1434 due to the time different between showing the option to user 1210 and when user 1210's ticket was booked. In this example, computer system 1200 continues to display avatar 1208 to indicate that user 1210 is still interacting with the agent. For example, indicating that the agent completed the task. In some embodiments, computer system 1200 continues to display avatar 1208 to indicate that user 1210 is able to provide additional inputs. For example, indicating that computer system 1200 awaits an input by continuing to include avatar 1208 on user interface 1204, as illustrated in FIG. 14C.

FIG. 15 is a flow diagram illustrating a process for providing multiple applications to perform a requested task using a computer system in accordance with some embodiments. Process 1500 is performed at a computer system (e.g., 100, 200, and/or 1200). Some operations in process 1500 are, optionally, combined, the orders of some operations are, optionally, changed, and some operations are, optionally, omitted.

As described below, process 1500 provides an intuitive way for providing multiple applications to perform a requested task. The process reduces the cognitive burden on a user for providing multiple applications to perform a requested task, thereby creating a more efficient human-machine interface. For battery operated computing devices, enabling a user to provide multiple applications to perform a requested task faster and more efficiently conserves power and increases the time between battery charges.

In some embodiments, process 1500 is performed at a computer system (e.g., 100, 200, and/or 1200) that is in communication with one or more input devices (e.g., 140 and/or 200-14) (e.g., a camera, a depth sensor, and/or a microphone) and one or more output devices (e.g., 140 and/or 200-16) (e.g., a speaker, a haptic output device, a display screen, a projector, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device.

The computer system detects (1502), via the one or more input devices, input (e.g., 1405A) (e.g., a tap input and/or a non-tap input (e.g., a verbal input, an audible request, an audible command, an audible statement, a swipe input, a hold-and-drag input, a gaze input, an air gesture, and/or a mouse click)) corresponding to a request directed to an agent (e.g., 1208) (e.g., via an application interface of a first application, a first application, an agent corresponding to a first application, and/or a first application in communication with a first agent) (e.g., of the computer system) to perform a task (e.g., as described above with respect to FIG. 14A) (e.g., one or more actions and/or operations).

In response to detecting the input (e.g., 1405A), the computer system outputs (1504), via the one or more output devices, a response (e.g., 1428, 1432, 1434, and/or 1436) corresponding to (e.g., related to, identifying, determined based on, addressing, and/or for performing) the task, wherein the response (e.g., as described above with respect to FIG. 14B) includes: (1506) first content (e.g., 1432), corresponding to a first application (e.g., Mapp App of FIG. 14B), that represents (e.g., is, is a portion of, includes, describes, identifies, is a visual representation of, and/or is an audio representation of) a first option for performing the task using the first application; and second (1508) content (e.g., 1434), corresponding to a second application (e.g., Bus App of FIG. 14B) different from the first application, that represents a second option for performing the task using the second application, wherein the second content is different from the first content. Outputting the response including the first content and the second content allows the computer system to integrate options corresponding to different applications into a single response to the request corresponding to the task, thereby providing improved feedback to the user and/or performing an operation when a set of conditions has been met without requiring further user input.

In some embodiments, outputting the response includes displaying, via the one or more output devices (and/or via a display component), the first content (e.g., 1432) and the second content (e.g., 1434) (e.g., as described above with respect to FIG. 14B). In some embodiments, the first content and the second content are displayed sequentially. In some embodiments, the sequential order of the first content and the second content is based on user preference. In some embodiments, the sequential order of the first content and the second content is based on use of the first application and/or the second application (e.g., what application was most previously used and/or what application is used most often). In some embodiments, the first content is displayed alongside (e.g., concurrently with) the second content. Outputting the response including displaying the first content and the second content allows the computer system to visually indicate options to a user, thereby providing improved visual feedback to the user and/or performing an operation when a set of conditions has been met without requiring further user input.

In some embodiments, the first content (e.g., 1432) and the second content (e.g., 1434) are displayed concurrently (e.g., as described above with respect to FIG. 14B). In some embodiments, displaying the first content and the second content concurrently is within a user interface object (e.g., displaying two route options on the same map user interface and/or displaying two rideshare options on the same map user interface). In some embodiments, displaying concurrently includes displaying the first content alongside the second content (e.g., both the first content and the second content are visible but within separate user interface objects). Concurrently displaying the first content and the second content allows the computer system to provide different options for different applications at the same time rather than requiring them to be provided at different times and/or separate, thereby providing improved visual feedback to the user and/or performing an operation when a set of conditions has been met without requiring further user input.

In some embodiments, outputting the response includes displaying, via a first display component of the one or more output devices, a user interface (e.g., 1204, 1432, 1434, and/or 1436) corresponding to (e.g., representing, depicting, and/or in communication with) the first application. In some embodiments, the first content (e.g., 1432) and the second content (e.g., 1434) are displayed within the (e.g., displaying two route options within a first navigation application and/or displaying two rideshare options within a first navigation application) user interface corresponding to the first application (e.g., as described above with respect to FIG. 14B) (and/or not corresponding to the second application). In some embodiments, the computer system displays the first content and the second content within the first application by translating the second content into a type of the first content. In some embodiments, the computer system overlays the second content onto content of the first application. Displaying the first content and the second content into the user interface corresponding to the first application allows the computer system to combine content from different applications into a user interface of one of the applications so as, in some embodiments, to maintain visual consistency for users (e.g., as a result of a user interface of the first application being familiar and/or set as default to one or more users for the task), thereby providing improved visual feedback to the user and/or performing an operation when a set of conditions has been met without requiring further user input.

In some embodiments, outputting the response includes displaying, via a second display component, a user interface corresponding to a third application (e.g., a system application, a system agent, and/or a system application in communication with a system agent). In some embodiments, the first content (e.g., 1432) and the second content (e.g., 1434) are displayed within the user interface corresponding to the third application (e.g., an agent application and/or a third-party application) (e.g., as described above with respect to FIG. 14B). In some embodiments, the computer system translates the first content and the second content to third content able to be displayed in the user interface corresponding to the third application. In some embodiments, the computer system requests the first application to provide the first content in a first format displayable within the user interface corresponding to the third application. In some embodiments, the computer system requests the second application to provide the second content in a second format (e.g., the first format or another format different from the first format) displayable within the user interface corresponding to the third application. Displaying the first content and the second content into the user interface corresponding to the third application allows the computer system to combine content from different applications into a user interface of another application so as, in some embodiments, to maintain visual consistency for users (e.g., as a result of a user interface of the third application output before outputting the response), thereby providing improved visual feedback to the user and/or performing an operation when a set of conditions has been met without requiring further user input.

In some embodiments, the response includes an audio output (e.g., 1428) (and/or audio indication) (e.g., corresponding to the task, the first application, and/or the second application). In some embodiments, the audio output is output prior to the first content and/or the second content. In some embodiments, the audio output is a prompt informing the user that there are multiple options to complete the task. In some embodiments, the audio output includes a description of the multiple options available to complete the task. In some embodiments, the audio output includes the first content and/or the second content. In some embodiments, the audio output includes an indication of the first content and/or the second content. The response including audio output allows the computer system to output different content in different ways without always taking up visual space for a user, thereby providing improved feedback to the user and/or performing an operation when a set of conditions has been met without requiring further user input.

In some embodiments, after (and/or while) outputting the response, the computer system detects, via the one or more input devices, input (e.g., 1405B) (e.g., a tap input and/or a non-tap input (e.g., a verbal input, an audible request, an audible command, an audible statement, a swipe input, a hold-and-drag input, a gaze input, an air gesture, and/or a mouse click)) corresponding (and/or directed) to the first content (e.g., 1434). In some embodiments, in response to detecting the input corresponding to the first content, the computer system causes the first application to perform the task (e.g., 1434) (e.g., as described above with respect to FIG. 14C) (e.g., in accordance with the first option) (e.g., without causing the second application to perform the task). In some embodiments, the first application performs one or more additional operations to perform the task. In some embodiments, after (and/or while) outputting the response, detecting, via the one or more input devices, input (e.g., a tap input and/or a non-tap input (e.g., a verbal input, an audible request, an audible command, an audible statement, a swipe input, a hold-and-drag input, a gaze input, an air gesture, and/or a mouse click)) corresponding (and/or directed) to the first second. In some embodiments, in response to detecting the input corresponding to the second content, the computer system causes the second application to perform the task (e.g., in accordance with the second option) (e.g., without causing the first application to perform the task). Causing the first application to perform the task when detecting the input corresponding to the first content allows the computer system to direct performance of operations based on input, thereby providing improved feedback to the user and/or performing an operation when a set of conditions has been met without requiring further user input.

In some embodiments, the task corresponds to a navigation request (and/or that includes one or more navigation parameters). In some embodiments, the first application corresponds to (and/or is and/or includes) a transportation service (e.g., Bus App of FIG. 14B) (e.g., as described above with respect to FIG. 14B) (e.g., a livery and/or rideshare service) (e.g., corresponding to a livery and/or rideshare application, such as a service for establishing and/or booking a vehicle, an individual with a vehicle, and/or an individual for transportation). In some embodiments, causing the first application to perform the task includes: initiating (e.g., without detecting input after the input corresponding to the first content) a process to establish (e.g., book, set up, organize, and/or request) a vehicle of the transportation service (e.g., book ticket of 1438A) for the navigation request (e.g., as described above with respect to FIG. 14C) (e.g., using one or more navigation parameters of the navigation request). In some embodiments, the process includes: selecting a type of transportation provided by the first application (e.g., cost, level of comfort, and/or ride type) and/or the transportation service; connecting to an available provider, vehicle, and/or individual (e.g., corresponding to and/or associated with the transportation service); and/or accepting the available provider. Initiating the process to establish a vehicle of the transportation service for the navigation request when detecting the input corresponding to the first content allows the computer system to direct performance of operations based on input, thereby providing improved feedback to the user and/or performing an operation when a set of conditions has been met without requiring further user input.

In some embodiments, while detecting the input corresponding to the request directed to the agent to perform the task, the computer system displays, via a display component of the one or more output devices, a representation of the agent (e.g., 1208). In some embodiments, the representation of the agent is a user interface element that corresponds to and/or changes based on the input (e.g., a pulsing user interface element that pulses to match the input). In some embodiments, the representation of the agent is an avatar, character, and/or humanoid representation. In some embodiments, the representation of the agent is customized by a user. In some embodiments, the representation of the agent is displayed in response to detecting a predefined input (e.g., an utterance and/or button press). Displaying the representation of the agent while detecting the input corresponding to the request directed to the agent to perform the task allows the computer system to visually indicate where detected requests will be sent (e.g., to the agent), thereby providing improved visual feedback to the user and/or performing an operation when a set of conditions has been met without requiring further user input.

In some embodiments, while outputting the response, the computer system maintains display, via the one or more output devices, of the representation of the agent (e.g., 1208) (e.g. as described above with FIG. 14B). In some embodiments, the computer system alters a size and/or position of the representation to output and/or while outputting the response. In some embodiments, the computer system alters a visual characteristics of the representation to output and/or while outputting the response (e.g., lowers an opacity, blurs, and/or reduces prominence of the representation at least a portion of time while outputting the response). Maintaining display of the representation of the agent while outputting the response allows the computer system to visually indicate where the response is from (e.g., the agent), thereby providing improved visual feedback to the user and/or performing an operation when a set of conditions has been met without requiring further user input.

In some embodiments, in response to detecting the input (and/or in conjunction with (e.g., before, while, and/or after)) outputting the response, the computer system ceases display of the representation of the agent (e.g., 1408) (e.g., as described above with FIG. 14C). In some embodiments, the computer system alters a visual characteristic of the representation (e.g., decreases the opacity of the representation, reduces size, and/or alters position) until the representation is no longer displayed. Ceasing display of the representation of the agent in response to detecting the input allows the computer system to make room for content output as a response to the input, thereby providing improved visual feedback to the user and/or performing an operation when a set of conditions has been met without requiring further user input.

In some embodiments, the input (e.g., 1405A) is a first input. In some embodiments, the request is a first request. In some embodiments, the first request includes a first set of one or more parameters (e.g., starting, intermediate, and/or ending location). In some embodiments, the first request is to perform the task according to the first set of one or more parameters (e.g., goal of task, destination, type of request, users involved, locations involved) (e.g., navigation directions to work are parameters) (e.g., as described above with respect to FIG. 14A). In some embodiments, the computer system detects a second input (e.g., input different from 1405A), different from the first input, corresponding to a second request directed to the agent to perform the task, wherein the second request is different from the first request, wherein the second request includes a second set of one or more parameters different from the first set of one or more parameters, and wherein the second request is to perform the task according to the second set of one or more parameters (e.g., as described above with FIG. 14B) (e.g., and not the first set of one or more parameters). In some embodiments, a type of the first set of one or more parameters is the same type as the second set of one or more parameters. In some embodiments, in response to detection the second input, the computer system outputs, via the one or more output devices, a second response (e.g., 1432, 1434, and 1436), different from the first response, corresponding to the task. In some embodiments, the second response includes third content, corresponding to a third application, that represents a first option for performing the task, based on the second set of one or more parameters, using the third application. In some embodiments, the third content and the first content and/or second content are the same type of content (e.g., a navigation route and/or map location) but contain different details within the content (e.g., locations and/or destinations). In some embodiments, the third content and the first content and/or second content are different types of content. In some embodiments, the third application is the first application and/or the second application. In some embodiments, the third application is different from the first application and/or the second application. In some embodiments, the second response includes fourth content, corresponding to a fourth application, that represents a second option for performing the task, based on the second set of one or more parameters, using the fourth application. In some embodiments, the fourth content and the first content and/or second content are the same type of content (e.g., a navigation route and/or map location) but contain different details within the content (e.g., locations and/or destinations). In some embodiments, the fourth content and the first content and/or second content are different types of content. In some embodiments, the fourth application is the first application and/or the second application. In some embodiments, the fourth application is different from the first application and/or the second application. In some embodiments, the second response include the same applications as the first response but different content. In some embodiments, the second response includes the third content and the fourth content. Outputting different responses in response to detecting different requests to perform the same task allows the computer system to cater such responses to parameters used for tasks, thereby providing improved feedback to the user and/or performing an operation when a set of conditions has been met without requiring further user input.

In some embodiments, the response is a third response. In some embodiments, the input is a third input. In some embodiments, the request is a third request. In some embodiments, the task is a first task. In some embodiments, the computer system detects a fourth input, different from the third input, corresponding to a fourth request directed to the agent to perform a second task different from the first task (e.g., as described above with FIG. 14B). In some embodiments, the fourth input is the same type of input (e.g., verbal input and/or touch input) as the third input. In some embodiments, the fourth input includes one or more different parameters (e.g., navigation request, music request, and/or weather update request) than the third input. In some embodiments, the fourth input is a different type of input than the third input. In some embodiments, in response to detection the fourth input, the computer system outputs, via the one or more output devices, a fourth response corresponding to the second task, wherein the fourth response is different from the third response (e.g., as described above with FIG. 14B). In some embodiments, the fourth response include different content than included in the third response. In some embodiments, content included in the fourth response corresponds to the same and/or different applications than content included in the third response. In some embodiments, the same applications are used to complete the second task and the first task (e.g., maps application to output route information and/or maps application to output destination information (e.g., restaurant ratings, wait times, and/or menu options)). Outputting different responses when different inputs are detected with different tasks allows the computer system to cater responses to a task being asked to be performed, thereby providing improved feedback to the user and/or performing an operation when a set of conditions has been met without requiring further user input.

In some embodiments, the response, is a fifth response. In some embodiments, the input is a fifth input. In some embodiments, the request is a fifth request. In some embodiments, the task is a third task. In some embodiments, the computer system detects a sixth input, different from the fifth input, corresponding to a sixth request directed to the agent to perform a fourth task (e.g., as described above with FIG. 14B). In some embodiments, the sixth input is the same type of input as the fifth input (e.g., verbal input and/or touch input) but includes different content (e.g., different verbal command and/or verbal requests). In some embodiments, the sixth input and the fifth input are different types of input. In some embodiments, in response to detection the sixth input, the computer system outputs, via the one or more output devices, a sixth response, different from the fifth response, corresponding to the fourth task, wherein the sixth response includes: third content, corresponding to a fourth application different from the first application and the second application, that represents a first option for performing the fourth task using the fourth application (e.g., as described above with FIG. 14C) and fourth content, corresponding to a fifth application different from the fourth application (and/or the first application and/or the second application), that represents a second option for performing the fourth task using the fifth application (e.g., as described above with FIG. 14C). Outputting different responses corresponding to different applications when different inputs are detected allows the computer system to cater responses to an input detected, thereby providing improved feedback to the user and/or performing an operation when a set of conditions has been met without requiring further user input.

In some embodiment, the response is a seventh response. In some embodiments, the input is a seventh input. In some embodiments, the request is a seventh request. In some embodiments, the task is a fifth task. In some embodiments, the computer system detects an eighth input, different from the seventh input, corresponding to an eighth request directed to the agent to perform a seventh task (e.g., as described above with FIG. 14B). In some embodiments, in response to detecting the eighth input, the computer system outputs, via the one or more output devices, an eighth response, different from the seventh response, corresponding to the seventh task, wherein content of the eighth response is different from content of the seventh response (e.g., as described above with FIG. 14B). Outputting different responses with different content when different inputs are detected allows the computer system to cater responses to an input detected, thereby providing improved feedback to the user and/or performing an operation when a set of conditions has been met without requiring further user input.

In some embodiment the response is a ninth response. In some embodiments, the input is a ninth input. In some embodiments, the request is a ninth request. In some embodiments, the task is a seventh task. In some embodiments, the computer system detects a tenth input, different from the ninth input, corresponding to a tenth request directed to the agent to perform an eighth task (e.g., as described above with FIG. 14B). In some embodiments, in response to detecting the tenth input, the computer system outputs, via the one or more output devices, a tenth response corresponding to the eighth task, wherein the tenth response includes fifth content (e.g., only the fifth content) corresponding to a sixth application, wherein the fifth content represents a first option for performing the eighth task using the sixth application, and wherein the tenth response does not include content corresponding to another application different from the sixth application (e.g., as described above with FIG. 14C). In some embodiments, the sixth application is the first application or the second application. In some embodiments, the sixth application is different from the first application and/or the second application. In some embodiments, the fifth content is the first content or the second content. In some embodiments, the fifth content is different from the first content and/or the second content. Outputting a response corresponding to a single application (e.g., rather than multiple as was described above with respect to the ninth response) allows the computer system to cater responses to an input detected, thereby providing improved feedback to the user and/or performing an operation when a set of conditions has been met without requiring further user input.

In some embodiments, the response includes sixth content, corresponding to a seventh application (e.g., different from the first application and/or the second application), that represents a first option for performing the task using the seventh application. In some embodiments, the sixth content is different from the first content and the second content (e.g., as described above with FIGS. 14A-14C). In some embodiments, the first option for performing the task using the seventh application is different from the first option for performing the task using the first application and/or the second option for performing the task using the second application. The response including content corresponding to multiple applications (e.g., multiple separate pieces of content corresponding one application and other content corresponding another application) (e.g., content corresponding to three or more applications) allows the computer system to cater responses to an input detected, thereby providing improved feedback to the user and/or performing an operation when a set of conditions has been met without requiring further user input.

In some embodiments, the input corresponding to the request directed to the agent to perform the task is (and/or includes) a verbal input (e.g., 1405A) (e.g., an audible request, an audible command, and/or an audible statement). In some embodiments, the verbal input includes key phrases and/or predetermined commands (e.g., a wake phrase, an action phrase, and/or a sleep phrase). In some embodiments, the verbal input includes a series of inputs (e.g., an initial wake input, an input prompt, and/or an input phrase). In some embodiments, the verbal input includes a key term to initiate input. In some embodiments, the verbal input is initiated upon recognizing the audio (e.g., initiating action upon the computer system receiving the auditory signal). The input being a verbal input allows the computer system to respond to different types of inputs, including a natural language input that is verbal, thereby providing improved feedback to the user, reducing the number of inputs needed to perform an operation, and/or performing an operation when a set of conditions has been met without requiring further user input.

In some embodiments, the first content includes (and/or is) first audio content (e.g., 1428). In some embodiments, the first audio output corresponds to the first application (e.g., an audio output to inform a user that the first application is to perform the task). In some embodiments, the first audio output is a generalized alert output (e.g., a preset tone and/or rhythm output by the computer system when the first application is performing the task). In some embodiments, the first audio output includes one or more further instructions and/or prompting (e.g., a prompt eliciting additional input by a user). In some embodiments, the second content includes second audio content (e.g., different from the first audio content). In some embodiments, the second audio output corresponds to the second application (e.g., an audio output to inform a user that the second application is to perform the task). In some embodiments, the second audio output is a generalized alert output (e.g., a preset tone and/or rhythm output by the computer system when the second application is performing the task). In some embodiments, the second audio output includes one or more further instructions and/or prompting (e.g., a prompt eliciting additional input by a user). The content corresponding to the first application including audio content allows the computer system to output different content in different ways without always taking up visual space for a user, thereby providing improved feedback to the user and/or performing an operation when a set of conditions has been met without requiring further user input.

In some embodiments, the first content includes (and/or is) first visual content (e.g., 1402, 1404, 1408, 1432, 1434, and/or 1436) (e.g., as described above with FIGS. 14A-14C). In some embodiments, the first visual content is output by the computer system. In some embodiments, the first visual content is output by another computer system that is in communication with the computer system. In some embodiments, the first visual content is received from another computer system (e.g., a remote media server) remote from the computer system. In some embodiments, the first visual content includes content about the first application. In some embodiments, the second content includes (and/or is) second visual content (e.g., different from the first visual content). In some embodiments, the second visual content is output by the computer system. In some embodiments, the second visual content is output by another computer system that is in communication with the computer system. In some embodiments, the second visual content is received from another computer system (e.g., a remote media server) remote from the computer system. In some embodiments, the second visual content includes content about the second application. The content from the first application including visual content allows the computer system to output different content in different ways, such as by emphasizing certain content by outputting such content visually, thereby providing improved feedback to the user and/or performing an operation when a set of conditions has been met without requiring further user input.

Note that details of the processes described above with respect to process 1500 (e.g., FIG. 15) are also applicable in an analogous manner to the processes described below/above. For example, process 1300 optionally includes one or more of the characteristics of the various processes described above with reference to process 1500. For example, the multiple applications of process 1500 can outputted by process 1300. For brevity, these details are not repeated below.

FIGS. 16A-16C illustrate exemplary user interfaces for providing suggested content in accordance with some embodiments. The user interfaces in these figures are used to illustrate the processes described below, including the processes in FIGS. 17 and 18.

FIGS. 16A-16C illustrate a computer system 1600 (e.g., a tablet) displaying different user interface objects. It should be recognized that computer system 1600 can be other types of computer systems such as a smart phone, a smart watch, a laptop, a communal device, a smart speaker, an accessory, a personal gaming system, a desktop computer, a fitness tracking device, and/or a head-mounted display (HMD) device. In some embodiments, computer system 1600 includes and/or is in communication with one or more input devices and/or sensors (e.g., a camera, a lidar detector, a motion sensor, an infrared sensor, a touch-sensitive surface, a physical input mechanism (such as a button or a slider), and/or a microphone). Such sensors can be used to detect presence of, attention of, statements from, inputs corresponding to, requests from, and/or instructions from a user in an environment. It should be recognized that, while some embodiments described herein refer to inputs being voice inputs, other types of inputs can be used with techniques described herein, such as touch inputs via a touch-sensitive surface and air gestures detected via a camera. In some embodiments, computer system 1600 includes and/or is in communication with one or more output devices (e.g., a display screen, a projector, a touch-sensitive display, speaker, and/or a movement component). Such output devices can be used to present information and/or cause different visual changes of computer system 1600. In some embodiments, computer system 1600 includes and/or is in communication with one or more movement components (e.g., an actuator, a moveable base, a rotatable component, and/or a rotatable base). Such movement components, as discussed above, can be used to change a position (e.g., location and/or orientation) of computer system 1600 and/or a portion (e.g., including one or more sensors, input components, and/or output components) of computer system 1600. In some embodiments, computer system 1600 includes one or more components and/or features described above in relation to computer system 100 and/or agent system 200-20. In some embodiments, computer system 1600 includes one or more agents and/or functions of an agent as described above with respect to FIG. 5. In some embodiments, computer system 1600 is, includes, implements, and/or is in communication with one or more agent systems, as described above with respect to FIG. 5, for performing (and/or causing performance of) one or more operations of an agent. For example, user interface object 1604 can be a representation of an agent that interacts with inputs to computer system 1600 (e.g., and provides suggestions and/or context for such suggestions).

In the examples of FIGS. 16A-16C, computer system 1600 displays, via a display component (e.g., a display screen, a projector, and/or a touch-sensitive display), a user interface object that has the appearance of an animated face. As illustrated in FIGS. 16A-16C and described in the examples below, computer system 1600 displays a user interface object as moving and interacting in response to inputs from a user. For example, in response to detecting an input, computer system 1600 causes the user interface object to appear to perform movements and/or speak (e.g., output facial movements synchronized with audio output). In the example of FIGS. 16A-16C, computer system 1600 uses a user interface object to provide information (e.g., performing a movement, outputting audio, and/or changing appearance) such as, for example, responses to detected inputs (e.g., verbal, movement, air, touch) from a user. In the example of FIGS. 16A-16C, computer system 1600 detects a request from a user for computer system 1600 to display suggestions of content. While and/or after providing suggestions, the user issues a request for computer system 1600 to provide context as to why computer system 1600 provided the suggestions that it did. In the examples of FIGS. 16A-16C, the context relates to communications between the user that asked for the suggestion and another user that are relevant to the suggested material.

FIGS. 16A-16C each include two portions, a left portion and a right portion. The right portions of FIGS. 16A-16C illustrate top-down schematic views of a physical environment that includes computer system 1600. The top-down schematic views of FIGS. 16A-16C illustrate communications interface 1620 of computer system 1600 (e.g., which is a visual representation of a field of view of a camera that is in communication with computer system 1600). The top-down schematic views can also include one or more users (e.g., 1608) (e.g., users detected by computer system 1600). The left portions of FIGS. 16A-16C illustrate output of a display in communication with computer system 1600 (e.g., and represent what is currently being displayed by the display).

FIG. 16A illustrates computer system 1600 displaying user interface 1602. In FIG. 16A, computer system 1600 displays user interface object 1604 enlarged in the center of user interface 1602. As illustrated in FIG. 16A, user 1606 is present within field of view 1608. In this example, user 1606 is a main user of computer system 1600 (e.g., the owner and/or a user with administrative rights of computer system 1600). At FIG. 16A, computer system 1600 detects input 1605A from user 1606. Input 1605A represents verbal input, from user 1606 to computer system 1600, that includes a request (e.g., instruction and/or command) for computer system 1600 to provide one or more suggestions of content (e.g., represented by input 1605A as “What should I watch?”) for user 1606 to interact with. The content that user 1606 requests is media content. In some embodiments, media content includes television shows, movies, videos, songs, and/or books. As illustrated in FIG. 16A, input 1605A is a verbal input from user 1606. Computer system 1600 can detect inputs (e.g., voice inputs, air inputs, touch inputs, and/or gaze inputs) via one or more input components (e.g., a camera input device and/or microphone) in communication with computer system 1600. In some embodiments, input 1605A is (and/or includes) one or more of an air gesture, gaze gesture, a physical input (e.g., a click on a button and/or dial of a remote and/or a tap input) detected by computer system 1600.

FIG. 16B illustrates computer system 1600, via user interface 1602, displaying suggestions interface 1612. Suggestions interface 1612 includes user interface object 1604 on the left side of user interface 1602 shrunken from its size as illustrated in FIG. 16A. Suggestions interface 1612 also includes suggestion 1614, (representing a suggestion of “The Car Movie”), suggestion 1616 (representing a suggestion of “The Car Movie 2”), and suggestion 1618, (representing a suggestion of “The Comedy Show Season 2 Episode 3”) (wherein each of suggestion 1614, 1616, and 1618 is a user interface object). In some embodiments, user 1606 interacts with the suggestions that computer system 1600 displays on suggestions interface 1612. In some embodiments, suggestions interface 1612 is displayed with, overlaid on, and/or in replacement of user interface 1602. FIG. 16A illustrates suggestion interface 1612 overlaid on user interface 1602 (e.g., which is still visible in the background).

When presented with one or more suggestions, a user can be provided the ability to interact with one or more of the suggestions. In some embodiments, computer system 1600 detects input representing an interaction with a provided suggestion. In some embodiments, in response to detecting input representing the request by user 1606 for interacting (e.g., providing a contact or non-contact input) with one or more suggestions, computer system 1600 performs one or more operations related to the suggestions. For example, in response to computer system 1600 detecting a request to display a menu for a suggested content item, computer system 1600 displays an interface and/or menu that relates to the selected suggestion. For example, if computer system 1600 detects an input with respect to a movie suggestion that requests addition of the movie to a “Watch Later” list, computer system 1600 displays a “Watch Later” interface. In some embodiments, upon displaying suggestions interface 1612, computer system 1600 detects a request (e.g., input) from user 1606 to play the suggested media (e.g., movie, song, video). In some embodiments, computer system 1600 plays the media in response to detecting the request from user 1606 before detecting input 1605B (e.g., a request for context, discussed below) (e.g., input 1605B is detected during playback of the media). In some embodiments, computer system 1600 plays the media in response to detecting the request from user 1606 after computer system 1600 has provided context. In some embodiments, in response to detecting an input to play the media, computer system 1600 begins playback and ceases to display the remaining suggestions.

Also illustrated in FIG. 16B is audio output 1610. Computer system 1600 outputs audio output 1610 in conjunction with displaying suggestion interface 1612. Audio output 1610 is illustrated in FIG. 16B as a voice bubble that illustrates speech coming from user interface object 1604 (e.g., speech attributed to, appearing to come from, and/or sourced from an agent represented by user interface object 1604). Note that the voice bubble illustrated in FIG. 16B is for illustrative purposes only and is not visibly output from computer system 1600. In some embodiments, the audio output 1610 is displayed (e.g., printed as readable text on user interface 1602 and/or suggestion interface 1612). In some embodiments, audio output 1610 is audio (e.g., spoken) and/or visual (e.g., written). In some embodiments, computer system 1600 provides the suggestion of “The Car Movie” and/or “The Car Movie 2” as a verbal output instead of and/or in addition to displaying the suggestions via suggestion interface 1612, as illustrated in FIG. 16B. Computer system 1600 provides audio output 1610 to indicate to user 1606 that computer system 1600 has detected the request for suggested content and is providing displayed suggestions pertaining to the request (and in response to input 1605A). Illustrated on the top-down schematic view of computer system 1600 in FIG. 16B is user 1606 within field of view 1608 of computer system 1600. At FIG. 16B, computer system 1600 detects input 1605B from user 1606. Input 1605B is a verbal request for computer system 1600 to provide context (e.g., a reason and/or information relating to) as to why the content in suggestions interface 1612 (e.g., suggestion 1614, suggestion 1616, and suggestion 1618) was suggested. In some embodiments, input 1605B is and/or includes another type of input (e.g., a physical input and/or an air gesture).

As illustrated in FIG. 16C, in response to detecting input 1605B, computer system 1600 provides audio output 1626. Audio output 1626 is illustrated in FIG. 16C as a voice bubble that illustrates speech coming from user interface object 1604 (e.g., speech attributed to, appearing to come from, and/or sourced from an agent represented by user interface object 1604). Note that the voice bubble illustrated in FIG. 16C is for illustrative purposes only and is not visibly output from computer system 1600. In some embodiments, audio output 1626 is displayed (e.g., printed as readable text on user interface 1602 and/or suggestion interface 1612). In some embodiments, audio output 1626 is audio (e.g., spoken) and/or visual (e.g., written). In some embodiments, audio output 1626 includes context (e.g., contextual information) regarding the suggested content. For example, computer system 1600 provides audio output 1626 to provide user 1606 with context as to why computer system 1600 displayed the specific movie suggestions illustrated in FIG. 16B. Audio output 1626 communicates to user 1606 that computer system 1600 selected the suggestions based on a conversation between user 1606 and another user (e.g., person) named Jane. Audio output 1626 also communicates to user 1606 that the conversation between user 1606 and Jane included Jane suggesting that user 1606 watch “The Car Movie” series. As also illustrated in FIG. 16C, computer system 1600 displays communications interface 1620 overlaid on user interface 1602 (and/or concurrently with and/or in replacement of). Communications interface 1620 includes a portion of a text message conversation (e.g., message 1622 from user 1606 to Jane, and message 1624 from Jane to user 1606) between user 1606 and Jane. For example, displaying the text message conversation can provide user 1606 with the context they requested (e.g., in a form that indicates that suggestion is based at least in part on a social interaction). In the example in FIG. 16C, computer system 1600 displays the text messages in communications interface 1620 outside of the messaging application from which they originated while user interface object 1604 continues to be displayed (e.g., without launching a messaging application and/or replace an agent user interface such as user interface object 1604 and/or user interface 1602). The text message conversation includes user 1606 stating that they like action movies, to which Jane replied suggesting that user 1606 watch “The Car Movie” series.

Note that Jane mentions “The Car Movie” series but computer system 1600, as illustrated in FIG. 16B, suggests specifically “The Car Movie” and “The Car Movie 2.” In some embodiments, although Jane did not specify particular movies within the series, computer system 1600 (and/or an agent thereof) intelligently determines to suggest specific movies within the series that Jane mentioned. Message 1624 from Jane referenced “The Car Movie” series. Jane's reference did not explicitly indicate two separate movies but was sufficient reference for computer system 1600 to determine that Jane was referring to more than one movie that met the description indicated by message 1624. In some embodiments, Jane's message may not include an identifier (e.g., reference) to the specific content (e.g., “You should watch an action movie series!”) In some embodiments, computer system 1600 displays suggestion 1618 in response to detecting a communication to user 1606 saying, “You should check out the newest episode of John's show, it's hilarious!”).

In some embodiments, computer system 1600 communicates the details illustrated within the text messages in FIG. 16C in an audio format instead of visually on user interface 1602. The audio format of conversation details can be computer system 1600 reading the text conversation verbatim. In some embodiments, the audio format includes computer system 1600 reading a transcription of an audio or video call. The device that provides suggestions (e.g., computer system 1600) and the device on which the conversation took place (e.g., a personal device of user 1606) are two separate devices operating on the same user account.

By displaying communications interface 1620, computer system 1600 provides a reason for computer system 1600 suggesting the movies that it did in FIG. 16B. In some embodiments, the source of information from which computer system 1600 determines suggestions is a phone call, a video call, a video message, a transcription of an audio call/message, a voicemail, and/or a transfer of data from one device to another (e.g., if one device transfers data of a car movie to another device, the second device determines that the user likes car movies and will suggest car movies in the future).

In some embodiments, the suggestions that computer system 1600 displays on suggestions interface 1612 indicate that the suggestion is sourced from Jane. For example, computer system 1600 can display suggestion 1614 as illustrated in FIG. 16B as “‘The Car Movie’, as recommended by Jane.” In some embodiments, computer system 1600 can display suggestion 1616 as “‘The Car Movie 2’, from text messages.”

In some embodiments, if computer system 1600 does not have access to text messages and/or conversation transcripts, computer system 1600 does not display suggestions upon request from user 1606. In some embodiments, if computer system 1600 does not have access to text messages and/or conversation transcripts, computer system 1600 provides suggestions based on viewing history or preconfigured preferences. Computer system 1600 intelligently stores information relating to media that user 1606 has historically watched/listened to/used and uses that information to provide relative media suggestions. In some embodiments, user 1606 preconfigures data into computer system 1600 concerning media preferences of user 1606, such as types of music and movies that they like and do not like.

Note that, although computer system 1600 suggests car movies based on the conversation between user 1606 and Jane, computer system 1600 does not provide a basis for suggesting suggestion 1618, “The Comedy Show Season 2 Episode 3.” In some embodiments, computer system 1600 suggests suggestion 1618 based on a conversation other than the conversation illustrated in FIG. 16C (e.g., between user 1606 and someone other than Jane or based on user 1606 mentioning “The Comedy Show”) or based on Episode 3 of Season 2 being the next unwatched episode on an account of user 1606. In some embodiments, computer system 1600 suggests suggestion 1618 based on a conversation between user 1606 and computer system 1600 in which user 1606 tells computer system 1600 that they like comedy.

FIG. 17 is a flow diagram illustrating a process for providing suggested content using a computer system in accordance with some embodiments. Process 1700 is performed at a computer system (e.g., 100, 200, and/or 1600). Some operations in process 1700 are, optionally, combined, the orders of some operations are, optionally, changed, and some operations are, optionally, omitted.

As described below, process 1700 provides an intuitive way for providing suggested content. The process reduces the cognitive burden on a user for providing suggested content, thereby creating a more efficient human-machine interface. For battery operated computing devices, enabling a user to be provided a suggestion of content faster and more efficiently conserves power and increases the time between battery charges.

In some embodiments, process 1700 is performed at a computer system (e.g., 100, 200, and/or 1600) that is in communication with one or more input devices (e.g., 140 and/or 200-14) (e.g., a camera, a depth sensor, and/or a microphone) and one or more output devices (e.g., 140 and/or 200-16) (e.g., a speaker, a haptic output device, a display screen, a projector, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device.

The computer system detects (1702) an indication (e.g., 1605A) (e.g., an input, a request, a communication, a command, and/or a set of one or more criteria is satisfied) that a suggestion of content (e.g., media content) is to be provided (e.g., as described above with respect to FIG. 16B).

In response to detecting the indication that the suggestion of content is to be provided, the computer system outputs (1704), via the one or more output devices, a suggestion of first content (e.g., 1614, 1616, and/or 1618) (e.g., as described above with respect to FIG. 16B).

In conjunction with (e.g., after and/or while) outputting the suggestion of first content (e.g., 1614, 1616, and/or 1618), the computer system detects (1706), via the one or more input devices, input (e.g., 1605B) (e.g., a tap input and/or a non-tap input (e.g., a verbal input, an audible request, an audible command, an audible statement, a swipe input, a hold-and-drag input, a gaze input, an air gesture, and/or a mouse click)) corresponding to (e.g., is directed to, is selection of, is pointed in a direction of (e.g., a direction of a representation of), includes reference to, mentions, names, identifies, and/or is configured to be associated with) the suggestion of first content (e.g., a request to provide context (e.g., reason, logic, and/or explanation) for the suggestion) (e.g., as described above with respect to FIG. 16B).

In response to detecting the input (e.g., 1605B) corresponding to the suggestion of first content, the computer system outputs (1708), via the one or more output devices, an indication (e.g., 1622, 1624, and/or 1626) (e.g., visual content, audio content, tactile feedback, and/or haptic feedback) of (e.g., explanation and/or details related to) a context (e.g., rationale, reasons, and/or logic) for the suggestion of first content, wherein the indication of the context corresponds to (e.g., is an indication of a context identified in, described in, referenced in, derived from, and/or determined using) a set of one or more communications (e.g., 1622 and/or 1624) exchanged (e.g., as described above with respect to FIG. 16C) (e.g., in a messaging application, over telephone, over Voice over IP, chat applications, and/or video communication) between a first user account (e.g., telephone number, email mail, device, screen name, and/or user profile) and a second user account (e.g., telephone number, e-mail, screen name, and/or user profile) different from the first user account (e.g., as described above with respect to FIG. 16C). In some embodiments, the set of one or more communications is (and/or includes) a conversation history. In some embodiments, the communications of the set of one or more communications can include text messages, instant messages, voice communications, video communications, and/or e-mails. Outputting the indication of the context for the suggestion of first content enables a user to obtain additional information with respect to internal determinations made by the computer system, thereby providing improved feedback and/or performing an operation when a set of conditions has been met without requiring further user input. The indication of the context corresponding to the set of one or more communications exchanged between the first user account and the second user account allows the computer system to output content relevant to a user and/or corresponding to a previous interaction that the user has had, thereby providing improved feedback and/or performing an operation when a set of conditions has been met without requiring further user input.

In some embodiments, outputting the indication of the context for the suggestion of first content includes outputting, via the one or more output devices, an identification (e.g., 1626) (e.g., explanation and/or details related to) of a manner of relevance (e.g., logic used and/or a reason) for the suggestion of first content (e.g., as described above with respect to FIG. 16C). In some embodiments, the indication of the context for the suggestion of first content is and/or includes the identification of the manner of relevance for the suggestion of first content for the suggestion of first content. In some embodiments, the manner of relevance is determined by using data obtained from applications, social media, and/or communications to provide suggestions. Outputting the identification of the manner of relevance for the suggestion of first content enables the computer system to provide a reason for the suggestion of first content and/or enables a user to obtain additional information with respect to internal determinations made by the computer system, thereby providing improved feedback to the user and/or performing an operation when a set of conditions has been met without requiring further user input.

In some embodiments, outputting the indication of the context for the suggestion of first content includes outputting an indication (e.g., 1626) (e.g., a visual indication (e.g., one or more graphics, images, texts, animation, and/or visual effects), an audio indication (e.g., speech output identifying a name of a user and/or user account), a sound out (e.g., ring tone and/or song) and/or haptic output) of the second user account (e.g., Jane as described with respect to FIG. 16C) (e.g., as described above with respect to FIG. 16C). In some embodiments, the second user account suggested the first content (e.g., to the first user account in a conversation (e.g., the set of one or more communications)). In some embodiments, the indication of the second user account includes an indication that the second user account suggested the first content (e.g., to the first user and/or a group of users). Outputting the indication of the second user account enables the computer system to provide a source from which the suggestion of first content was derived from, thereby providing improved feedback to the user and/or reducing the number of inputs needed to perform an operation.

In some embodiments, outputting the indication of the context for the suggestion of first content includes outputting, via the one or more output devices, an indication of a portion (e.g., 1622 and/or 1624) of (e.g., details of, summary of, section of, part of, and/or all of) (e.g., a set of one or more messages) the set of one or more communications (e.g., 1622 and/or 1624) exchanged between the first user account and the second user account (e.g., as described above with respect to FIG. 16C). In some embodiments, the portion of the set of one or more communications includes one or more (e.g., all or less than all) communications in the set of one or more communications. In some embodiments, the indication of the portion of the set of one or more communications includes a reproduction, copy, screenshot, summary, paraphrasing, and/or verbatim representation of the portion of the set of one or more communications (e.g., includes a subset of messages in a plurality of messages that makes up a set of one or more communications). In some embodiments, the indication includes and/or is the set of one or more communications. Outputting the indication of the portion of the set of one or more communications exchanged between the first user account and the second user account enables the computer system to provide the communication from which the suggestion of first content was derived from, thereby providing improved feedback to the user and/or reducing the number of inputs needed to perform an operation.

In some embodiments, outputting the indication of the portion of the set of one or more communications exchanged between the first user account and the second user account includes outputting, via the one or more output devices, a reproduction (e.g., 1622 and/or 1624) (e.g., one or more representations of the communications in the portion of the set of one or more communications) of the portion of the set of one or more communications exchanged between the first user account and the second user account (e.g., as described above with respect to FIG. 16C). In some embodiments, the indication includes and/or is the reproduction. Outputting the indication of the portion of the set of one or more communications exchanged between the first user account and the second user account enables the computer system to provide specific parts of a communication from which the suggestion of first content was derived from, thereby providing improved feedback to the user and/or reducing the number of inputs needed to perform an operation.

In some embodiments, the computer system (e.g., 1600) is in communication with a first display component (e.g., a display screen, a projector, and/or a touch-sensitive display). In some embodiments, outputting the indication of the portion of the set of one or more communications exchanged between the first user account and the second user account includes displaying, via the first display component, the indication of the portion of the set of one or more communications exchanged between the first user account and the second user account in (e.g., concurrently surrounded by, with, and/or within) a user interface (e.g., 1620) of a first application (e.g., application of user interface object 1604) (e.g., a media application (e.g., for browsing and/or playing back media), an agent (e.g., a virtual personal assistant), a file explorer application, and/or an application that provides and/or displays the suggested of the first context) that was not used to exchange (e.g., send and/or receive) the set of one or more communications (e.g., as described above with respect to FIGS. 16A-16C). In some embodiments, a messaging application (e.g., for text messaging, instant messaging, email, audio messaging, and/or video messaging) (e.g., on the computer system and/or on a different computer system) was used (e.g., by the first user and/or the second user) to exchange (e.g., send and/or receive) the set of one or more communications. Displaying the indication of the portion of the set of one or more communications exchanged between the first user account and the second user account in a user interface of a first application that was not used to exchange the set of one or more communications enables the computer system to reduce the amount of context switching (e.g., displaying user interfaces for different applications) when users are interacting with the computer system and/or provide information regarding the reason for the suggestion of first content through an application that controls playback of the suggested content, thereby providing improved feedback to the user and/or reducing the number of inputs needed to perform an operation.

In some embodiments, the computer system (e.g., 1600) is in communication with a second display component (e.g., a display screen, a projector, and/or a touch-sensitive display) (e.g., same as the first display component or different from the first display component). In some embodiments, outputting the indication of the context for the suggestion of first content includes displaying, via the second display component, the indication of the context for the suggestion of first content (e.g., displaying message 1622, message 1624, and/or 1626) (e.g., as described above with respect to FIG. 16C). Displaying the indication of the context for the suggestion of first content enables the computer system to provide a visual suggestion for content based on communications involving different users, including, in some embodiments, communications involving the computer system and/or a user account associated with the computer system, thereby providing improved visual feedback to the user and/or reducing the number of inputs needed to perform an operation.

In some embodiments, the computer system (e.g., 1600) is in communication with a first audio generation device (e.g., 140 and/or 200-14) (e.g., smart speaker, home theater system, soundbar, headphone, earphone, earbud, speaker, television speaker, augmented reality headset speaker, audio jack, optical audio output, Bluetooth audio output, and/or HDMI audio output). In some embodiments, outputting the indication of the context for the suggestion of first content includes outputting, via the first audio generation device, the indication (e.g., 1626) of the context for the suggestion of first content (e.g., as described above with respect to FIG. 16C). In some embodiments, the indication of the context for the suggestion of first context is output via the first audio generation device (e.g., as audio) and, in some embodiments concurrently, via the second display component (e.g., as visual content). Outputting, via the first audio generation device, the indication of the context for the suggestion of first content enables the computer system to provide audio suggestions for content based on communications involving different users, including, in some embodiments, communications involving the computer system and/or a user account associated with the computer system, thereby providing improved feedback to the user and/or reducing the number of inputs needed to perform an operation.

In some embodiments, the computer system (e.g., in conjunction with outputting the suggestion of first content and/or in conjunction with outputting the indication of the context for the suggestion of first content) detects, via the one or more input devices, an input (e.g., a tap input and/or a non-tap input (e.g., a verbal input, an audible request, an audible command, an audible statement, a swipe input, a hold-and-drag input, a gaze input, an air gesture, and/or a mouse click)) corresponding to (e.g., representing, interpreted as, is directed to an option to cause, and/or is a selection of an option to cause) a request to play back (e.g., stream, render, and/or play) the first content (e.g., content represented by 1614, 1616, and/or 1618). In some embodiments, the computer system detects the input corresponding to a request to play back content corresponding to the suggestion of first content in conjunction with (e.g., after and/or while) outputting, via the one or more output devices, the suggestion of first content. In some embodiments, in response to detecting the input corresponding to the request to play back the first content, the computer system initiates (e.g., beginning, causing, and/or starting), via the one or more output devices, playback of the first content (e.g., as described above with respect to FIGS. 16B-16C) (e.g., in conjunction with outputting the suggestion of first content and/or in conjunction with outputting the indication of the context for the suggestion of first content). Initiating playback of the first content in response to detecting the input corresponding to the request to play back the first content enables the computer system to provide access to the content that was suggested, thereby providing improved feedback to the user and/or reducing the number of inputs needed to perform an operation.

In some embodiments, the input corresponding to the request to play back the first content is detected before the indication of the context for the suggestion of first content is output (e.g., as described above with respect to FIGS. 16B-16C). In some embodiments, the indication of the context for the suggestion of the first content is output in conjunction with (e.g., after and/or during) playback of the first content corresponding to the suggestion. In some embodiments, the context for the suggestion of the first content is output while the playback of the content corresponding to the suggestion of the first content is output. In some embodiments, the context for the suggestion of the first content is output after the playback of the content corresponding to the suggestion of the first content is output. Having the input corresponding to the request to play back the first content be detected before the indication of the context for the suggestion of first content is output enables the computer system to allow a user to quickly access content without having to view the reason for the suggestion, thereby providing improved feedback to the user and/or reducing the number of inputs needed to perform an operation.

In some embodiments, the input corresponding to the request to play back the first content is detected after (e.g., while and/or during output of) the indication of the context for the suggestion of first content is output (e.g., as described above with respect to FIGS. 16B-16C). In some embodiments, the indication of the context for the suggestion of the first content is output before playback of the content corresponding to the suggestion of the first content is output. In some embodiments, the indication of the context for the suggestion of the first content is output when playback of a second content is output. In some embodiments, the indication of the context for the suggestion of the first is output when no playback of content is output. Having the input corresponding to the request to play back the first content be detected after the indication of the context for the suggestion of first content is outputted enables the computer system to allow a user to quickly access content while providing a reason for a suggestion, thereby providing improved feedback to the user and/or reducing the number of inputs needed to perform an operation.

In some embodiments, the input corresponding to (e.g., is directed to and/or is a selection of) the suggestion of first content includes an explicit request (e.g., 1605B) to provide the context (e.g., rationale, relevance, reason, and/or logic) for the suggestion of first content (e.g., as described above with respect to FIG. 16B). In some embodiments, in response to the input corresponding to the suggestion of first content, the computer system provides a reason for the context for the suggestion of first context. In some embodiments, the indication of the context for the suggestion of the first content includes an indication of an origin of the suggestion such as the portions of relevant communications, social profiles, and/or usage history (and/or purchase history) of applications (e.g., music player, video players, and websites). Having the input corresponding to the suggestion of first content include an explicit request to provide the context for the suggestion of first content enables the computer system to respond to requests from users to provide information regarding underlying decisions performed by the computer system, thereby providing improved feedback to the user and/or reducing the number of inputs needed to perform an operation.

In some embodiments, detecting the indication that the suggestion of content is to be provided includes detecting, via the one or more input devices, an input (e.g., 1605A) (e.g., a verbal input (e.g., a verbal utterance, a sound, an audible request, an audible command, and/or an audible statement) and/or a non-verbal input (e.g., a swipe input, a hold-and-drag input, a gaze input, an air gesture, and/or a mouse click)) corresponding to (e.g., is directed to and/or is a selection of) a request for the suggestion of content (e.g., as described above with respect to FIG. 16A). In some embodiments, the input is processed (e.g., using speech processing and/or semantic understanding) to determine the indication that the suggestion of content is to be provided. In some embodiments, the input is from a user and/or user interacting with the computer system. Detecting the indication that the suggestion of content is to be provided includes detecting an input corresponding to a request for the suggestion of content enables the computer system to respond to requests by users with suggestions of content without requiring the users to explicitly name such suggestions, thereby providing improved feedback to the user and/or reducing the number of inputs needed to perform an operation.

In some embodiments, the input includes (and/or is) a verbal input (e.g., 1605A) (e.g., as described above with respect to FIG. 16A) (e.g., a verbal command, a verbal request, and/or a verbal statement) (e.g., detected via one or more microphones in communication with the computer system). Having the input include a verbal input enables the computer system to provide a reason for the suggest of content when verbally requested by user, thereby providing improved feedback to the user and/or reducing the number of inputs needed to perform an operation.

In some embodiments, the input includes (and/or is) an air gesture (e.g., as described above with respect to FIG. 16A) (e.g., a hand input to pick up, a hand input to press, an air tap, an air swipe, a clench, and/or hold air input). In some embodiments, the air gesture is detected via one or more cameras (and/or other sensors) in communication with the computer system. Having the input include an air gesture enables the computer system to provide a reason for the suggestion of content when requested by user via an air gesture, thereby providing improved feedback to the user and/or reducing the number of inputs needed to perform an operation.

In some embodiments, the input includes (and/or is) a physical input (e.g., as described above with respect to FIG. 16A) (e.g., detected via one or more physical input devices (e.g., keyboard, mouse, touch screen, touchpad, and/or rotatable mechanism) in communication with the computer system). Having the input include a physical input enables the computer system to provide a reason for the suggestion of content when requested by user via a physical input mechanism, thereby providing improved feedback to the user and/or reducing the number of inputs needed to perform an operation.

In some embodiments, the suggestion (e.g., 1614) of first content is a first suggestion of first content. In some embodiments, in response to detecting the indication that the suggestion of content is to be provided, the computer system outputs (e.g., simultaneously to, concurrently with, and/or after outputting the first content) a second suggestion (e.g., 1616 and/or 1618) of second content different from the first suggestion of first content (e.g., as described above with respect to FIG. 16B) (e.g., the second content is different from the first content). Outputting a second suggestion of second content in response to detecting the indication that the suggestion of content is to be provided enables the computer system to provide multiple suggestions of content in response to, in some embodiments, a single request, thereby providing improved feedback to the user and/or reducing the number of inputs needed to perform an operation.

In some embodiments, the second suggestion of second content corresponds to (e.g., is mentioned in, referenced in, identified in, and/or obtained from) a second set of one or more communications (e.g., different from the set of one or more communications) exchanged between the first user account and a third user account different from the first user account and the second user account (e.g., as described above with respect to FIG. 16C). Having the second suggestion of second content correspond to a second set of one or more communications exchanged between the first user account and a third user account enables the computer system to provide suggestion from a variety of different communications and/or user accounts, thereby providing improved feedback to the user and/or reducing the number of inputs needed to perform an operation.

In some embodiments, the second suggestion of second content (and/or another suggestion of content different from the first suggestion of first content and the second suggestion of second content) corresponds to (e.g., is mentioned in, referenced in, identified in, and/or obtained from) a third set of one or more communications exchanged with the computer system (e.g., 1600) (e.g., as described above with respect to FIG. 16C) (e.g., between the first user account and the computer system and/or one or more applications (e.g., operating system, third party applications, digital assistant, and/or system avatar) of the computer system). In some embodiments, data obtained from the first user account to determine the second suggestion of second content is obtained from an application accessed by the computer system. Having the second suggestion of the second content correspond to a third set of one or more communications exchanged with the computer system enables the computer system to provide suggestions from a variety of different sources, thereby providing improved feedback to the user and/or reducing the number of inputs needed to perform an operation.

In some embodiments, while outputting the second suggestion of second content and in response to detecting the input corresponding to the first suggestion of first content, the computer system ceases outputting, via the one or more output devices, the second suggestion of second content (e.g., ceases displaying suggestion 1616 in response to detecting input 1605B) (e.g., as described above with respect to FIGS. 16B-16C). Ceasing outputting the second suggestion of second content in response to detecting the input corresponding to the first suggestion of first content enables the computer system to stop providing other suggestions when directed to a particular suggestion, thereby providing improved feedback to the user and/or reducing the number of inputs needed to perform an operation.

In some embodiments, the computer system is in communication with a third display component (e.g., 140 and/or 200-14) (e.g., a display screen, a projector, and/or a touch-sensitive display). In some embodiments, the computer system detects, via the one or more input devices, a second input (e.g., the same or different from the input corresponding to the suggestion of first content) (e.g., the same or a different type of input as the input corresponding to the suggestion of first content) corresponding to (e.g., is directed to and/or is a selection of) selection of the suggestion of first content (e.g., as described above with respect to FIG. 16B). In some embodiments, the computer system detects the input corresponding to the selection of the suggestion of first content while (and/or after) outputting the suggestion of first content. In some embodiments, in response to detecting the second input corresponding to selection of the suggestion of first content, the computer system displays, via the third display component, a user interface corresponding to (e.g., for, of, including, presenting, representing, associated with, and/or that includes information regarding) the first content (e.g., as described above with respect to FIGS. 16B-16C). In some embodiments, displaying, via the third display component, the user interface corresponding to the first content includes ceasing display of another user interface. In some embodiments, displaying, via the third display component, the user interface corresponding to the first content includes concurrently displaying the user interface corresponding to the first content and another user interface. In some embodiments, the user interface corresponds to an application associated with and/or that hosts the first content. In some embodiments, the application is different from an application providing the suggestion of first content. Displaying a user interface corresponding to the first content in response to detecting the second input corresponding to selection of the suggestion of first content enables the computer system to provide a user interface to present play back of the suggested content, thereby providing improved feedback to the user and/or reducing the number of inputs needed to perform an operation.

In some embodiments, the set of one or more communications exchanged between the first user account and the second user account includes one or more text communications (e.g., as described above with respect to FIG. 16C) (e.g., text messages (e.g., short message service (SMS), multimedia messaging service (MMS), and/or other cellular-based messages), instant messages, internet-based messages of an internet-based messaging service, and/or e-mails). Having the set of one or more communications exchanged between the first user account and the second user account include one or more text communications enables the computer system to provide a suggestion from a variety of communications sources, thereby providing improved feedback to the user and/or reducing the number of inputs needed to perform an operation.

In some embodiments, the set of one or more communications exchanged between the first user account and the second user account includes one or more audio communications (e.g., as described above with respect to FIG. 16C) (e.g., a transcription of an audio call and/or a prerecorded audio communication (e.g., voicemail)). Having the set of one or more communications exchanged between the first user account and the second user account include one or more audio communications enables the computer system to provide a suggestion from a variety of communications sources, thereby providing improved feedback to the user and/or reducing the number of inputs needed to perform an operation.

In some embodiments, the set of one or more communications exchanged between the first user account and the second user account includes one or more video communications (e.g., as described above with respect to FIG. 16C) (e.g., a transcription of a video call and/or a prerecorded video communication). Having the set of one or more communications exchanged between the first user account and the second user account include one or more video communications enables the computer system to provide a suggestion from a variety of communications sources, thereby providing improved feedback to the user and/or reducing the number of inputs needed to perform an operation.

In some embodiments, the set of one or more communications exchanged between the first user account and the second user account includes data (e.g., files, to do lists, documents, pictures, and/or voice messages) received via one or more peer-to-peer communications (e.g., as described above with respect to FIG. 16C) (and/or the first user account and the second user account communicate directly with each other without a central server or intermediary) (e.g., transfer of data from one device to another). Having the set of one or more communications exchanged between the first user account and the second user account include data received via one or more peer-to-peer communications enables the computer system to provide a suggestion from a variety of communications sources, thereby providing improved feedback to the user and/or reducing the number of inputs needed to perform an operation.

In some embodiments, while outputting the indication of the context for the suggestion of first content, the computer system outputs, via the one or more output devices, an avatar (e.g., 1604) (e.g., of an application) (e.g., an application agent and/or a system agent) with a set of features (e.g., visual features and/or audio features) corresponding to the indication of the context for the suggestion of first content (e.g., as described above with respect to FIGS. 16B-16C) (e.g., the avatar appears to be speaking (e.g., visually by mouth movement and/or audibly by voice timbre)). In some embodiments, the avatar is output in conjunction with (e.g., before, while, and/or after) outputting the indication of the context for the suggestion of first content. In some embodiments, the avatar is output with the set of features corresponding to other content (e.g., different from the indication of the context for the suggestion of first content) in conjunction with outputting, via the one or more output devices, the other content (e.g., with not outputting the indication of the context for the suggestion of first content). Outputting an avatar having a set of features corresponding to the indication of the context for the suggestion of first content enables the computer system to provide the suggestion of content via the avatar to increase user engagement and/or provide multiple channels of communication of such information, thereby providing improved feedback to the user and/or reducing the number of inputs needed to perform an operation.

Note that details of the processes described above with respect to process 1700 (e.g., FIG. 17) are also applicable in an analogous manner to the processes described below/above. For example, process 1800 optionally includes one or more of the characteristics of the various processes described above with reference to process 1700. For example, the suggestion of first content of process 1700 can be the first suggestion of process 1800. For brevity, these details are not repeated below.

FIG. 18 is a flow diagram illustrating a process for providing suggested content based on communications exchanged between users using a computer system in accordance with some embodiments. Process 1800 is performed at a computer system (e.g., 100, 200, and/or 1600). Some operations in process 1800 are, optionally, combined, the orders of some operations are, optionally, changed, and some operations are, optionally, omitted.

As described below, process 1800 provides an intuitive way for providing suggested content based on communications exchanged between users. The process reduces the cognitive burden on a user for providing suggested content based on communications exchanged between users, thereby creating a more efficient human-machine interface. For battery operated computing devices, enabling a user to be provided suggested content based on communications exchanged between users faster and more efficiently conserves power and increases the time between battery charges.

In some embodiments, process 1800 is performed at a computer system (e.g., 100, 200, and/or 1600) that is in communication with one or more input devices (e.g., 140 and/or 200-14) (e.g., a camera, a depth sensor, and/or a microphone) and one or more output devices (e.g., 140 and/or 200-16) (e.g., a speaker, a haptic output device, a display screen, a projector, and/or a touch-sensitive display). In some embodiments, the computer system is a watch, a phone, a tablet, a fitness tracking device, a processor, a head-mounted display (HMD) device, a communal device, a media device, a speaker, a television, and/or a personal computing device.

The computer system detects (1802) input (e.g., 1605A) (e.g., a tap input and/or a non-tap input (e.g., a verbal input, an audible request, an audible command, an audible statement, a swipe input, a hold-and-drag input, a gaze input, an air gesture, and/or a mouse click)), via the one or more input devices, corresponding to (e.g., is directed to and/or is a selection of) a request, from a first user (e.g., 1606), to provide a suggestion (e.g., a recommendation) of media content (e.g., as described above with respect to FIG. 16A).

In response to (1804) detecting the input corresponding to the request (e.g., 1605A), from the first user, to provide the suggestion of media content, in accordance with a determination that a set of one or more communications (e.g., 1622 and/or 1624) (e.g., as described with respect to process 1700) exchanged between the first user and a second user satisfy a set of one or more criteria with respect to first media content (e.g., includes a reference to, identifies, and/or includes the first media content), the computer system outputs (1806), via the one or more output devices, a first suggestion (e.g., 1614, 1616, and/or 1618) (e.g., as described with respect to process 1700) (e.g., of media content) (e.g., “The Car Movie” as described above with respect to FIG. 16B). In some embodiments, the first suggestion corresponds to the first media content.

In response to (1804) detecting the input (e.g., 1605A) corresponding to the request, from the first user (e.g., 1606), to provide the suggestion of media content, in accordance with a determination that the set of one or more communications (e.g., 1622 and/or 1624) (e.g., as described with respect to process 1700) exchanged between the first user and the second user satisfy the set of one or more criteria with respect to second media content (e.g., includes a reference to, identifies, and/or includes the second media content), the computer system outputs (1808), via the one or more output devices, a second suggestion (e.g., 1614, 1616, and/or 1618) (e.g., as described with respect to process 1700) (e.g., of media content) different from the first suggestion, wherein the second media content is different from the first media content (e.g., “The Car Movie 2” as described above with respect to FIG. 16B). In some embodiments, the second suggestion corresponds to the second media content (e.g., and not the first media content).

In response to (1804) detecting the input (e.g., 1605A) corresponding to the request, from the first user (e.g., 1606), to provide the suggestion of media content, in accordance with a determination that the set of one or more communications (e.g., 1622 and/or 1624) (e.g., as described with respect to process 1700) exchanged between the first user and the second user does not satisfy the set of one or more criteria with respect to media content (e.g., does not include reference, identify, and/or include: any media content, the first media content, and/or the second media content) (and/or in accordance with a determination that a set of one or more communications exchanged between the first user and another user, different from the first user and the second user, satisfy the set of one or more criteria with respect to a third media content), the computer system outputs (1810), via the one or more output devices, a third suggestion (e.g., as described with respect to process 1700) (e.g., of media content) different from the first suggestion and the second suggestion (e.g., as described above with respect to FIG. 16B). In some embodiments, the third suggestion corresponds to the third media content (e.g., and not the first media content and/or the second media content). Outputting a first suggestion, a second suggestion, or a third suggestion based on prescribed conditions being met enables the computer system to provide relevant suggestions, thereby performing an operation when a set of conditions has been met without requiring further user input and/or providing improved feedback to the user.

In some embodiments, in response to detecting the input corresponding to the request from the first user to provide the suggestion of media content and in accordance with a determination that a communication corresponding to the first user and media content is not available (e.g., no communications exchanged between the first user and any user are available) (e.g., has not occurred, the set of one or more communications exchanged between the first user and the second user do not meet certain requirements, and/or no data exists of communication exchanged between the first user and another user), the computer system forgoes outputting, via the one or more output devices, a suggestion (e.g., 1614, 1616, and/or 1618) of media content (e.g., as described above with respect to FIG. 16B) (e.g., no suggestion is provided at all). Forgoing outputting a suggestion in accordance with a determination that a communication corresponding to the first user and media data is not available enables the computer system to determine whether enough information is accessible to provide relevant suggestion, thereby performing an operation when a set of conditions has been met without requiring further user input and/or providing improved feedback to the user.

In some embodiments, in response to detecting the input corresponding to the request from the first user to provide the suggestion of media content and in accordance with a determination that a communication corresponding to the first user and media content is not available, the computer system outputs, via the one or more output devices, a fifth suggestion (e.g., 1618) (e.g., of media content) based on data other than a communication (e.g., any communication) exchanged between users (e.g., as described above with respect to FIGS. 16A-16B) (and/or any communications exchanged with respect to the first user) (and/or a communication history with respect to the first user). In some embodiments, the data includes user preferences, user profiles, user usage history, and/or data obtained through applications. In some embodiments, the first suggestion, the second suggestion, the third suggestion, the fourth suggestion, and/or the fifth suggestion is based on preferences (e.g., per user, per conversation, and/or global for the first user). In some embodiments, the first suggestion, the second suggestion, the third suggestion, the fourth suggestion, and/or the fifth suggestion is based on usage history of applications (e.g., video player, music player, and/or web browser). Outputting a fifth suggestion based on data other than a communication exchanged between users in accordance with a determination that a communication corresponding to the first user and media content is not available enables the computer system to provide relevant suggestions for content based on variety of data that is accessible, thereby performing an operation when a set of conditions has been met without requiring further user input and/or providing improved feedback to the user.

In some embodiments, the first suggestion includes a first indication (e.g., 1614 includes title of movie “The Car Movie”) of media content (e.g., as described above with respect to FIG. 16B) (e.g., TV show(s), game(s), website(s) movie(s), video(s), song(s), and/or books) (e.g., the first media content). In some embodiments, the second suggestion includes a second indication of media content (e.g., the second media content). In some embodiments, the second indication is different from the first indication. In some embodiments, the third suggestion includes a third indication of media content (e.g., the third media content). In some embodiments, the third indication is different from the first indication and/or the second indication. Having the first suggestion include a first indication of media content enables the computer system to provide suggestions for relevant media content, thereby performing an operation when a set of conditions has been met without requiring further user input and/or providing improved feedback to the user.

In some embodiments, the first suggestion and the second suggestion are concurrently output (e.g., 1614, 1616, and/or 1618 are concurrently displayed) in response to detecting the input corresponding to the request, from the first user, to provide the suggestion of media content (e.g., as described above with respect to FIG. 16B). Having the first suggestion and the second suggestion be concurrently output in response to detecting the input corresponding to the request, from the first user, to provide the suggestion of media content enables the computer system to present multiple suggestions of content at the same time for a user to pick between, thereby performing an operation when a set of conditions has been met without requiring further user input and/or providing improved feedback to the user.

In some embodiments, the set of one or more criteria includes a criterion that is satisfied with respect to the first media content when a communication corresponds to (e.g., relates to, identifies, and/or makes explicit and/or implicit reference to) the first media content (e.g., 1614) (e.g., 1624 mentions “The Car Movie” series) (e.g., as described above with respect to FIGS. 16A-16B). Having the set of one or more criteria include a criterion that is satisfied when a communication corresponds to the first media content enables the computer system to provide relevant suggestions of content based on mentions within communications, thereby performing an operation when a set of conditions has been met without requiring further user input and/or providing improved visual feedback to the user.

In some embodiments, the set of one or more criteria includes a criterion that is satisfied with respect to the second media content when a communication corresponds to (e.g., relate to, identify, and/or make explicit and/or implicit reference to) the second media content (e.g., 1616) (e.g., 1624 mentions “The Car Movie” series) (e.g., as described above with respect to FIGS. 16A-16B). In some embodiments, a single communication corresponds to the first media content and the second media content, causing the set of one or more criteria to be satisfied with respect to the first media content and the second content (e.g., and/or the first suggestion and the second suggestion to be concurrently output). In some embodiments, the computer system selects one or more suggestions to be output in accordance with a determination that multiple media content satisfy the set of one or more criteria (e.g., based on criteria other than that media content satisfies the set of one or more criteria, such as frequency that media content satisfies the set of one or more criteria and/or popularity of media content). Having the set of one or more criteria includes a criterion that is satisfied when a communication corresponds to the second media content enables the computer system to provide relevant suggestions of content based on mentions within communications, thereby performing an operation when a set of conditions has been met without requiring further user input and/or providing improved feedback to the user.

In some embodiments, outputting the first suggestion includes outputting, via the one or more output devices, a first indication (e.g., graphic, vibration, text, and/or audio) of the second user (e.g., name adjacent to 1622). In some embodiments, outputting the second suggestion includes outputting a second indication (e.g., the same and/or different from the first indication of the second user) of the second user (e.g., name adjacent to 1624) (e.g., as described above with respect to FIG. 16B). In some embodiments, the indication is displayed (e.g., graphical and/or textual) and/or audio output (e.g., speech output via a speaker). Outputting suggestions including indications of the second user enables the computer system to provide information about the origin of the suggested content, thereby performing an operation when a set of conditions has been met without requiring further user input and/or providing improved feedback to the user.

In some embodiments, outputting the first suggestion includes outputting, via the one or more output devices, a third indication (e.g., graphic, text, and/or audio) (e.g., of a portion of the set of one or more communications) of the set of one or more communications. In some embodiments, outputting the second suggestion includes outputting, via the one or more output devices, a fourth indication (e.g., graphic, text, and/or audio) (e.g., of a portion of the set of one or more communications) (e.g., the same or different from the third indication) (e.g., different part of conversation than the third indication) of the set of one or more communications (e.g., as described above with respect to FIG. 16B). Outputting suggestions including indications of the set of one or more communications enables the computer system to provide information about the source of the suggested content, thereby performing an operation when a set of conditions has been met without requiring further user input and/or providing improved feedback to the user.

In some embodiments, the one or more output devices includes a first audio generation component. In some embodiments, outputting the first suggestion includes providing, via the first audio generation component (e.g., smart speaker, home theater system, soundbar, headphone, earphone, earbud, speaker, television speaker, augmented reality headset speaker, audio jack, optical audio output, Bluetooth audio output, HDMI audio output, and/or audio sensor), a first verbal output (e.g., 1610) corresponding to (e.g., reciting, relating to, making explicit and/or implicit reference to) the first suggestion (e.g., as described above with respect to FIG. 16B). In some embodiments, outputting the second suggestion includes providing, via the first audio generation component, a second verbal output (e.g., 1610) (e.g., different from the first verbal output) corresponding to (e.g., reciting, relating to, making explicit and/or implicit reference to) the second suggestion (e.g., as described above with respect to FIG. 16B). Outputting suggestions including providing verbal output corresponding to the suggestions enables the computer system to alert users of suggested content using audio, thereby performing an operation when a set of conditions has been met without requiring further user input and/or providing improved feedback to the user.

In some embodiments, the one or more output devices includes a first display component (e.g., a display screen, a projector, and/or a touch-sensitive display). In some embodiments, outputting the first suggestion includes displaying, via the first display component, an indication (e.g., 1614, 1616, and/or 1618) (e.g., graphic, animation, and/or video) of the first suggestion (e.g., as described above with respect to FIG. 16B). In some embodiments, outputting the second suggestion includes displaying, via the first display component, an indication (e.g., 1614, 1616, and/or 1618) (e.g., graphic, animation, and/or video) of the second suggestion (e.g., as described above with respect to FIG. 16B) (e.g., same as or different from the indication of the first suggestion). Outputting suggestions including displaying indications of the suggestions enables the computer system to alert users of suggested contented through a visual indication, thereby performing an operation when a set of conditions has been met without requiring further user input and/or providing improved visual feedback to the user.

In some embodiments, in conjunction with outputting the first suggestion, the computer system detects, via the one or more input devices, an input (e.g., a verbal input (e.g., a verbal utterance, a sound, an audible request, an audible command, and/or an audible statement) and/or a non-verbal input (e.g., a swipe input, a hold-and-drag input, a gaze input, an air gesture, and/or a mouse click)) corresponding to (e.g., is directed to and/or is a selection of) the first suggestion. In some embodiments, in response to detecting the input corresponding to the first suggestion, the computer system performs an operation (e.g., play, fast forward, and/or add to playlist) corresponding to (e.g., using, related to, and/or based on) the first suggestion (e.g., as described above with respect to FIGS. 16A-16B). In some embodiments, in conjunction with outputting the second suggestion, the computer system detects, via the one or more input devices, an input (e.g., a verbal input (e.g., a verbal utterance, a sound, an audible request, an audible command, and/or an audible statement) and/or a non-verbal input (e.g., a swipe input, a hold-and-drag input, a gaze input, an air gesture, and/or a mouse click)) corresponding to (e.g., is directed to and/or is a selection of) the second suggestion. In some embodiments, in response to detecting the input corresponding to the second suggestion, the computer system performs an operation (e.g., play, fast forward, and/or add to playlist) corresponding to (e.g., using, related to, and/or based on) the second suggestion. Performing the first operation corresponding to the first suggestion in response to detecting the input corresponding to the first suggestion enables the computer system to allow a user to access and control suggested content, thereby performing an operation when a set of conditions has been met without requiring further user input and/or providing improved feedback to the user.

In some embodiments, the operation corresponding to the first suggestion includes initiating playback of the first media content (e.g., as described above with respect to FIG. 16B). Having the operation corresponding to the first suggestion include initiating playback of the first media content enables the computer system to start playing the suggested content based on input, thereby performing an operation when a set of conditions has been met without requiring further user input and/or providing improved feedback to the user.

In some embodiments, the operation corresponding to the first suggestion includes causing the first media content to be saved (e.g., as described above with respect to FIG. 16B) (e.g., by the computer system and/or one or more other computer systems) (e.g., adding to playlist and/or queuing the first media content for later playback). Having the operation corresponding to the first suggestion include causing the first media content to be saved enables the computer system to save the suggested content so it can be accessed later, thereby performing an operation when a set of conditions has been met without requiring further user input and/or providing improved feedback to the user.

In some embodiments, the input corresponding to the request to provide the suggestion of media content is (and/or includes) a verbal input (e.g., 1605B) (e.g., as described above with respect to FIG. 16A) (e.g., a verbal command, a verbal request, and/or a verbal statement) (e.g., detected via one or more microphones in communication with the computer system). Having the input corresponding to the request to provide the suggestion of media content be a verbal input enables the computer system to respond to verbal requests for suggestion of content, thereby providing additional control options without cluttering the user interface with additional displayed control and performing an operation when a set of conditions has been met without requiring further user input.

In some embodiments, the input corresponding to the request to provide the suggestion of media content is (and/or includes) a gesture (e.g., as described above with respect to FIG. 16B) (e.g., a hand input to pick up, a hand input to press, an air tap, an air swipe, a clench, hold air input, a contact input that forms one or more gestures) (e.g., an air gesture). In some embodiments, the gesture is detected via one or more cameras, touch-sensitive surfaces, and/or other input devices in communication with the computer system. Having the input corresponding to the request to provide the suggestion of media content be a gesture enables the computer system to respond to gestures that correspond to requests for suggestions of content, thereby providing additional control options without cluttering the user interface with additional displayed control and/or performing an operation when a set of conditions has been met without requiring further user input.

Note that details of the processes described above with respect to process 1800 (e.g., FIG. 18) are also applicable in an analogous manner to the processes described below/above. For example, process 1700 optionally includes one or more of the characteristics of the various processes described above with reference to process 1800. For example, the input of process 1800 can be the indication of process 1700. For brevity, these details are not repeated below.

The description above, has been described with reference to specific examples for the purpose of explanation. Such specific examples can be in the form of textual description above and/or in the accompanying drawings. However, such examples should not be interpreted as being exhaustive or limiting to the disclosure (e.g., limiting to the explicit manners described herein). Many modifications and variations are possible in view of the above teachings by one of ordinary skill in the art without departing from the scope of the present disclosure.

Aspects of the technology described above can include gathering and/or using data from various sources. Such data can include demographic data, telephone numbers, email addresses, location and/or location-related data, home addresses, work addresses, and/or any other identifying information. In some scenarios, such data can include personal information that is usable to uniquely identify a specific person. Such data can be used to improve interactions that a device has with its environment (e.g., interactions with users). The use of such data can require one or more entities handling such data. These entities can be involved in collecting, processing, disclosing, transferring, storing, or other functions that support the technologies described herein. The present disclosure expects that (e.g., does not preclude) that all use of such data complies with well-established privacy policies and/or privacy practices by such entities. As a general matter, such policies and practices should meet or exceed generally recognized industry standards and comply with all applicable data privacy and security-related governmental requirements. In particular, for example, entities should receive informed consent from users to collect and/or use such data, and such collection and/or use should only be for legitimate and reasonable uses. Further, such data should not be shared, disclosed, sold, and/or provided for uses other than legitimate and/or reasonable uses. Various scenarios can arise in which such data is not available, such as when a user selects not to share such data. For example, the user can withhold consent for collection and/or use of such data (e.g., “opt out” of sharing such data and/or not explicitly “opt in” during a registration process). The user can also employ the use of any of various hardware and/or software components that prevent collection and/or use of such data. While the use of such data can benefit a user by improving the operation of the device, the present disclosure contemplates that embodiments of the present technology can be used without such data. For example, operations of the device can use other data (e.g., instead of and/or in place of such data). Other techniques include making inferences based on other data or a minimal amount of such data. The use of such data can be utilized for the benefit of users of the device. For example, such data can be used to improve interactions that the device engages in with the user. Other benefits from the use for such data are also possible and within the scope of the present disclosure.

What is claimed is:

1. A method, comprising:
at a computer system that is in communication with one or more input devices and one or more output devices:
while outputting, via the one or more output devices, first content, detecting, via the one or more input devices, a first input corresponding to a first portion of the first content; and
while continuing outputting the first content, in response to detecting the first input, and in accordance with a determination that the first input corresponds to first media content referenced in the first portion of the first content, performing an operation corresponding to the first media content, wherein the first media content is different from the first content.

2. The method of claim 1, wherein continuing outputting the first content includes maintaining at least one aspect of outputting the first content.

3. The method of claim 1, wherein continuing outputting the first content includes changing, via the one or more output devices, an aspect of outputting the first content.

4. The method of claim 1, wherein the one or more output devices includes a first display component, and wherein performing the operation corresponding to the first media content includes outputting, via the first display component, a visual confirmation of the operation.

5. The method of claim 4, wherein the visual confirmation includes a representation of the first media content.

6. The method of claim 1, wherein the one or more output devices includes a set of one or more audio generation components, and wherein outputting the first content includes outputting, via the set of one or more audio generation components, audio output.

7. The method of claim 6, wherein the one or more output devices includes a second display component, and wherein outputting the first content includes displaying, via the display component, visual content.

8. The method of claim 1, wherein performing the operation corresponding to the first media content includes saving the first media content to a set of media content.

9. The method of claim 1, wherein performing the operation corresponding to the first media content includes downloading the first media content.

10. The method of claim 1, wherein the operation is a first operation, the method further comprising:
while continuing outputting the first content, in response to detecting the first input, and in accordance with a determination that the first input corresponds to a second media content referenced in the first portion of the first content, performing a second operation corresponding to the second media content, wherein the second media content is different from the first content and the first media content.

11. The method of claim 1, wherein the second operation is different from the first operation.

12. The method of claim 1, wherein the operation is a third operation, wherein the one or more output devices includes a third display component, the method further comprising:
while continuing outputting the first content, in response to detecting the first input, and in accordance with a determination that the first input corresponds to the first media content and a third media content referenced in the first portion of the first content:
performing a fourth operation corresponding the first media content; and
performing a fifth operation corresponding to the third media content, wherein the third media content is different from the first content and the first media content; and
in conjunction with performing the fourth operation, displaying, via the third display component, an indication of the fourth operation; and
in conjunction with performing the fifth operation, displaying, via the third display component, an indication of the fifth operation.

13. The method of claim 1, further comprising:
while continuing outputting the first content, in response to detecting the first input, and in accordance with a determination that the first input does not correspond to the first media content, forgoing performing the operation corresponding to the first media content.

14. The method of claim 1, further comprising:
while outputting the first content, detecting, via the one or more input devices, a second input different from the first input; and
in response to detecting the second input:
in accordance with a determination that the second input corresponds to a first type of input, ceasing output of the first content; and
in accordance with a determination that the second input corresponds to a second type of input different from the first type of input, forgoing ceasing output of the first content.

15. The method of claim 1, wherein the one or more output devices includes a fourth display component, the method further comprising:
in conjunction with detecting the first input, displaying, via the fourth display component, the first portion of the first content.

16. The method of claim 1, wherein the one or more output devices includes an audio generation component, the method further comprising:
in conjunction with detecting the first input, outputting, via the audio generation component, the first portion of the first content.

17. The method of claim 1, wherein the first media content is a first type of content than the first content.

18. The method of claim 1, wherein the first content is audio content.

19. The method of claim 1, wherein the first media content is visual content.

20. The method of claim 1, wherein the first input is verbal input.

21. The method of claim 1, wherein the first input is a gesture.

22. A non-transitory computer-readable storage medium storing one or more programs configured to be executed by one or more processors of a computer system that is in communication with one or more input devices and one or more output devices, the one or more programs including instructions for:
while outputting, via the one or more output devices, first content, detecting, via the one or more input devices, a first input corresponding to a first portion of the first content; and
while continuing outputting the first content, in response to detecting the first input, and in accordance with a determination that the first input corresponds to first media content referenced in the first portion of the first content, performing an operation corresponding to the first media content, wherein the first media content is different from the first content.

23. A computer system that is in communication with one or more input devices and one or more output devices, comprising:
one or more processors; and
memory storing one or more programs configured to be executed by the one or more processors, the one or more programs including instructions for:
while outputting, via the one or more output devices, first content, detecting, via the one or more input devices, a first input corresponding to a first portion of the first content; and
while continuing outputting the first content, in response to detecting the first input, and in accordance with a determination that the first input corresponds to first media content referenced in the first portion of the first content, performing an operation corresponding to the first media content, wherein the first media content is different from the first content.
